(19) United States
(12) Patent Application Publication
(10) Pub. No.: US 2026/0293927 A1
(43) Pub. Date: Oct. 1, 2026

(54) SUNFLOWER OLEOSOME- AND PROTEIN-CONTAINING COMPOSITIONS FOR USE IN NUTRITIONAL FORMULATIONS

(71) Applicant: BOTANECO INC., Calgary (CA)

(72) Inventors: Analucia MATA, Calgary (CA); Burcu GULDIKEN, Calgary (CA); Jason HARGREAVES, Calgary (CA)

(21) Appl. No.: 19/479,600

(22) PCT Filed: Apr. 29, 2024
(86) PCT No.: PCT/CA2024/050578

§ 371 Date: Oct. 28, 2025

Related U.S. Application Data
(60) Provisional application No. 63/499,137, filed on Apr. 28, 2023.
(60) Provisional application No. 63/622,474, filed on Jan. 18, 2024.

(51) Int. Cl. A23D 9/04; A23D 9/007; A23J 1/14; A23J 3/14

(52) U.S. Cl. CPC A23D 9/04; A23D 9/007; A23J 1/14; A23J 3/14

(57) ABSTRACT

Disclosed are oleosome preparations and protein preparations from sunflower plant material. The oleosome preparations are low protein preparations containing no more than 3% (w/w) protein on dry basis (low-protein oleosome preparations), high protein preparations containing at least 4% (w/w) protein on dry basis (high-protein oleosome preparations), or oleosome preparations having from about 2% (w/w) to about 5% (w/w) on dry basis, and having other advantageous properties in respect of dry weight, lipid to protein ratio content, and/or particle size. The oleosome preparations from sunflower plants are suitable for use as ingredients in nutritional formulations. There are also disclosed methods for preparing the sunflower oleosome preparations and protein preparations.

### CROSS-REFERENCE TO RELATED APPLICATIONS

This application claims priority to U.S. Patent Application Ser. No. 63/499,137, filed on Apr. 28, 2023, and U.S. Patent Application Ser. No. 63/622,474, filed on Jan. 18, 2024, each of which is incorporated herein by reference in its entirety.

### FIELD OF THE DISCLOSURE

The present disclosure generally relates to sunflower plant oil- and protein-containing preparations. More specifically, this disclosure pertains to sunflower oleosome preparations and sunflower protein concentrates, and methods for their manufacture.

### BACKGROUND

Plant materials are known to be excellent sources of edible oils and proteins. For example, edible oils and proteins are commonly produced by pressing under high pressures, seeds harvested from agricultural crops such as Brassica spp., corn, soybeans, peanuts, sunflower, safflower, hemp, flax, legumes, and cotton, among others.

Plant materials with a high oil content (e.g., 35% or more) are typically ultra-processed with techniques that have evolved to optimize plant oil yield. In general, these processing techniques involve combinations of mechanical pressing and organic solvent (e.g., hexane) extraction of selected plant material. However due to the harsh processing conditions employed, the vesicles in which plant oil is naturally contained, are destroyed. These vesicles are commonly known in the art as “oleosomes” or “oil bodies” and are located within the natural plant cells constituting the selected source plant material. In broad terms, oleosomes can be thought of as vesicles containing plant oil in a naturally pre-emulsified form. The emulsifying properties are imparted to the oleosomes by proteins and phospholipids which are generally arranged so that each oleosome contains a droplet of oil encapsulated by a shell of phospholipids and proteins.

Alternative minimal processing techniques have been developed to recover oil containing fractions from plant materials in which the integrity of the oleosomes is retained. These processing techniques typically avoid the use of harsh organic extractants, and instead involve the use of water-based (aqueous) extractants. Thus, in this respect, aqueous extraction techniques allow recovery of plant oil in the form of an oleosome fraction from plant materials.

Recovered oleosome fractions may be used as ingredients in the formulation of selected oil containing food products. In this respect, the natural pre-emulsified form in which the plant oil is recovered provides desirable flexibility in the formulation of nutritional products. For example, in food formulation processes in which oleosomes are used as an ingredient, the use of chemical emulsifiers may be avoided.

However, the known oleosome preparations remain suboptimal. For example, flavor, smell, and color are negatively impacted by known processing techniques and conditions for the recovery of oleosome fractions. Thus, the range of nutritional products in which oleosome preparations can be formulated is limited, since the oleosome preparations can impart an off-taste, off-smell, or off-color to the finished nutritional products. Furthermore, the water content of known oleosome preparations is undesirably high. In this respect, food formulators prefer oil containing ingredients having a low water content, so that the water content in final nutritional products can be controlled across a wide range during formulation processes.

Furthermore, dietary plant protein fractions are also commonly recovered from plant materials using harsh processing techniques and conditions, such as extraction techniques using organic solvents and/or high temperatures. These commonly used techniques and conditions can result in denaturation and/or aggregation of native plant proteins. In this respect, aggregation and/or denaturation of proteins can negatively impact protein quality, including digestibility.

Thus, it is clear that while plant materials represent a valuable source of edible oils, which may be recovered in the form of oleosome preparations, the quality of oleosome preparations obtained from these plant materials known to the art is suboptimal. Similarly, the quality of known plant protein fractions is also suboptimal.

### SUMMARY

In one aspect, in accordance with the teachings herein, the embodiments of the present disclosure generally relate to oleosome preparations produced from selected sunflower plant materials. According to one aspect, the selected sunflower plant materials may be sunflower seeds.

According to another aspect, the oleosome preparations may be low-protein oleosome preparations.

According to another aspect, the oleosome preparations may be high-protein oleosome preparations.

One embodiment disclosed herein relates to a sunflower oleosome preparation having a protein concentration of from about 2% (w/w) to about 5% (w/w) on a dry basis (db) and having a dry weight of from about 40% (w/w) to about 70% (w/w), a lipid to protein ratio of from about 10 to about 50 on a dry basis (db), and containing particles having a mean particle size D[4,3] of from about 2 μm to about 10 μm. In an embodiment, the sunflower oleosome preparation described herein is a pasteurized low-protein oleosome preparation. In an embodiment, the sunflower oleosome preparation described herein further comprises a preservative agent.

In an embodiment, the sunflower oleosome preparation described herein has a dry weight from 60% (w/w) to about 70% (w/w).

In an embodiment, the sunflower oleosome preparation described herein has a lipid to protein ratio of from about 15 to about 40 on a dry basis (db).

In an embodiment, the sunflower oleosome preparation described herein has a mean particle size D[4,3] from about 2 μm to about 5 μm.

In an embodiment, the sunflower oleosome preparation described herein has a mean particle size D[4,3] from about 2 μm to about 5 μm, and the preparation has a pH of from about 2.5 to about 3.5.

In an embodiment, the sunflower oleosome preparation described herein is a pasteurized low-protein oleosome preparation.

In an embodiment, the sunflower oleosome preparation described herein further comprises a preservative agent.

One embodiment disclosed herein relates to a low-protein sunflower oleosome preparation having a protein concentration of less than about 3% (w/w) on a dry basis (db), a dry weight of from about 20% (w/w) to about 80% (w/w), a lipid to protein ratio in excess of about 30 on a dry basis (db), and containing particles having a mean particle size D[4,3] of about 3 μm to about 20 μm.

In an embodiment, the low-protein sunflower oleosome preparation described herein has a dry weight from about 30% (w/w) to about 80% (w/w), and the mean particle size D[4,3] is from about 3 μm to about 10 μm.

In an embodiment, the low-protein sunflower oleosome preparation described herein has a dry weight is from about 65% (w/w) to about 75% (w/w), a lipid to protein ratio from about 30 to about 90 on a dry basis (db), and a mean particle size D[4,3] from about 3 μm to about 9 μm.

In an embodiment, the low-protein sunflower oleosome preparation described herein has a dry weight from about 20% (w/w) to about 60% (w/w), a mean particle size D[4,3] from about 3 μm to about 20 μm, and the preparation has a pH of about 2.5 to about 3.5. In one aspect, this embodiment may have a dry weight from about 50% (w/w) to about 60% (w/w), a lipid to protein ratio of about 50 on a dry basis (db), and a mean particle size D[4,3] from about 10 μm to about 15 μm.

In an embodiment, the low-protein sunflower oleosome preparation described herein has a dry weight from about 50% (w/w) to about 70% (w/w), a lipid to protein ratio from about 30 to 60 on a dry basis (db), and a mean particle size D[4,3] from about 3.0 μm to about 8 μm, wherein the preparation is substantially free of at least one of (i) an endocarp protein; and (ii) an endocarp phenolic. In one aspect, this embodiment has a dry weight from about 65% (w/w) to about 70% (w/w), a lipid to protein ratio from about 35 to about 45 on a dry basis (db), and a mean particle size D[4,3] from about 3.0 μm to about 5.5 μm. In an embodiment, the endocarp phenolic is a polyphenolic selected from a phenolic acid, a flavonoid, a tannin, a saponin, lignan, lignin, a terpene, an alkaloid, and an oxalate. In an embodiment, the phenolic acid is chlorogenic acid, ferulic acid, caffeic acid, 3-O-caffeoylquinic acid, 4-O-caffeoylquinic acid, 5-O-caffeoylquinic acid, 5-O-p-coumaroylquinic acid, 5-O-feruloyquinic acid, Dicaffeoylquinic acid, a caffeoylquinic acid, caffeic acid derivative, a coumaric acid derivative, a ferulic acid derivative, 3,4-Di-o-caffeoylquinic acid, 3,5-Di-o-caffeoylquinic acid, or 4,5-Di-o-caffeoylquinic acid. In an embodiment, the flavonoid is kaempferol, apigenin, dihydroflavonol, genistein, genistin, daidzein, daidzin, biochanin A, formononetin, luteolin, or quercetin. In an embodiment, the endocarp protein is helianthin or albumin.

In an embodiment, the low-protein sunflower oleosome preparation described herein has a dry weight of from about 30% (w/w) to about 80% (w/w), and the CIELAB color value of the oleosome preparation is a*>0. In one aspect of this embodiment, the dry weight is from about 70% (w/w) to about 75% (w/w), the lipid to protein ratio is from about 70 to about 80 on a dry basis (db), and the mean particle size D[4,3] is about 3.5 μm to about 15 μm.

In an embodiment, the low-protein sunflower oleosome preparation described herein comprises a phenolics content of from about 0.1 to about 0.4 milligram gallic acid equivalent per gram (mg GAE/gram) dry weight of sample.

In an embodiment, the low-protein sunflower oleosome preparation described herein is a pasteurized low-protein oleosome preparation.

In an embodiment, the low-protein sunflower oleosome preparation described herein further comprises a preservative agent.

In an embodiment, the low-protein sunflower oleosome preparation described herein has a protein concentration between about 1% (w/w) and about 3% (w/w) on a dry basis (db).

One embodiment disclosed herein relates to a high-protein sunflower oleosome preparation having a protein concentration of at least about 4% (w/w) on a dry basis (db), a dry weight of from about 50% (w/w) to about 70% (w/w), a lipid to protein ratio of from about 10 to about 30 on a dry basis (db), and containing particles having a mean particle size D[4,3] of about 2.5 μm to about 10 μm.

In an embodiment, the high-protein sunflower oleosome preparation described herein has a dry weight of from about 60% (w/w) to about 70% (w/w).

In an embodiment, the high-protein sunflower oleosome preparation described herein has a lipid to protein ratio from about 10 to about 25 on a dry basis (db), and a mean particle size D[4,3] from about 2.5 μm to about 5 μm.

In an embodiment, the high-protein sunflower oleosome preparation described herein has a lipid to protein ratio from about 10 to about 20 on a dry basis (db).

In an embodiment, the high-protein sunflower oleosome preparation described herein has a protein concentration between about 4% (w/w) and about 5% (w/w) on a dry basis (db), and a mean particle size D[4,3] from about 2.5 μm to about 4 μm. In one aspect, this embodiment has a lipid to protein ratio from about 15 to about 20 on a dry basis (db).

In an embodiment, the high-protein sunflower oleosome preparation described herein has a protein concentration of at least about 7% (w/w) on a dry basis (db), and a mean particle size D[4,3] from about 4 μm to about 5 μm. In one aspect, this embodiment has a lipid to protein ratio from about 10 to about 12.5 on a dry basis (db).

In an embodiment, the high-protein sunflower oleosome preparation described herein has a phenolics content of from about 0.1 mg to about 0.4 mg GAE/gram dry weight of sample.

In an embodiment, the high-protein sunflower oleosome preparation described herein is a pasteurized high-protein oleosome preparation.

In an embodiment, the high-protein sunflower oleosome preparation described herein further comprises a preservative agent.

One embodiment disclosed herein relates to a method of making a low-protein sunflower oleosome preparation comprising the steps of: (i) providing whole dehulled seeds from a sunflower plant; (ii) comminuting the dehulled sunflower seeds in an aqueous solution to obtain a comminuted seed mixture comprising comminuted seed particles having mean particle sizes D[4,3] in a range of about 5 μm to about 200 μm; (iii) adjusting the pH of the comminuted seed mixture to a pH of from about pH 5 to about pH 6 to obtain a pH adjusted comminuted seed mixture; (iv) separating the pH adjusted comminuted seed mixture into a solid phase and a liquid phase; (v) adjusting the pH of the liquid phase to a pH of from about pH 8 to about 8.5 to obtain a pH adjusted liquid phase; (vi) separating the pH adjusted liquid phase into an oleosome containing light liquid phase and a protein containing heavy liquid phase; (vii) washing the oleosome containing light liquid phase in a first washing solution and obtaining washed oleosomes; and (viii) further washing the washed oleosomes in a second washing solution to obtain a double-washed low-protein sunflower oleosome preparation containing less than about 3% (w/w) on a dry basis (db), a dry weight of from about 20% (w/w) to about 80% (w/w), a lipid to protein ratio in excess of about 30 on a dry basis (db), and containing particles having a mean particle size D[4,3] of about 3 μm to about 20 μm.

In an embodiment, the methods herein of making a low-protein sunflower oleosome preparation comprises using ascorbic acid, and, additionally optionally phosphoric acid, in step (iii) to adjust the pH to the pH of from about pH 5 to about pH 6, and thereby provide the double-washed low-protein sunflower oleosome preparation with a CIELAB color value of a*>0.

In an embodiment, the methods herein of making a low-protein sunflower oleosome preparation further comprises, following step (viii), a step of pasteurizing the double-washed low protein sunflower oleosome preparation to obtain a pasteurized double-washed low-protein sunflower oleosome preparation containing no more than about 3% (w/w) protein on a dry basis (db) and having a dry weight of from about 30% (w/w) to about 80% (w/w), a lipid to protein ratio in excess of about 30 on a dry basis (db), and a mean particle size D[4,3] of about 3 μm to about 20 μm.

In an embodiment of the methods herein of making a low-protein sunflower oleosome preparation, the mean particle size D[4,3] is about 3 μm to about 10 μm.

In an embodiment, the methods herein of making a low-protein sunflower oleosome preparation further comprises, following step (viii): (ix) diluting the double-washed low-protein sunflower oleosome preparation with sufficient reverse osmosis water to obtain a diluted oleosome preparation having a dry weight of about 50%; and (x) reducing the pH of the diluted oleosome preparation from between about 8 to about 8.5 to between about 2.5 and about 3.5 to obtain a low-pH low-protein sunflower oleosome preparation. In one aspect, this embodiment further comprises, following step (x), a step of pasteurizing the low-pH protein sunflower oleosome preparation to obtain a pasteurized low-pH low-protein sunflower oleosome preparation.

In an embodiment of the methods herein of making a low-protein sunflower oleosome preparation, the dehulled seeds are washed in reverse osmosis water at a temperature of no more than about 60° C., prior to comminution of the dehulled sunflower seeds, to thereby obtain a low-protein sunflower oleosome preparation containing no more than about 3% (w/w) protein on a dry basis (db), and having a dry weight of from about 50% (w/w) to about 70% (w/w), a lipid to protein ratio of from about 30 to about 60 on a dry basis (db), and containing particles having a mean particle size D[4,3] of about 3 μm to about 8 μm, wherein the preparation is substantially free of at least one of (i) an endocarp protein; and (ii) an endocarp phenolic.

One embodiment disclosed herein relates to a method of making a high-protein sunflower oleosome preparation, comprising the steps of: (i) providing whole dehulled seeds from a sunflower plant; (ii) comminuting the dehulled sunflower seeds in an aqueous solution to obtain a comminuted seed mixture comprising comminuted seed particles having mean particle sizes D[4,3] in a range of about 5 μm to about 200 μm; (iii) adjusting the pH of the comminuted seed mixture to from about pH 4.5 to about pH 5.0 to obtain a pH adjusted comminuted seed mixture; (iv) separating the pH adjusted comminuted seed mixture into a solid phase and a liquid phase; (v) adjusting the pH of the liquid phase to about pH 7, and obtain a pH adjusted liquid phase; (vi) separating the pH adjusted liquid phase into an oleosome containing light liquid phase and a protein containing heavy liquid phase; (vii) washing the oleosome containing light liquid phase in a first washing solution and obtaining washed oleosomes; and (viii) further washing the washed oleosomes in a second washing solution to obtain a double-washed high-protein sunflower oleosome preparation having a protein content of at least 4% (w/w) on a dry basis (db) and having a dry weight of from about 40% (w/w) to about 70% (w/w), a lipid to protein ratio of from about 10 to about 30 on a dry basis (db), and containing particles having a mean particle size D[4,3] of about 3 μm to about 10 μm.

In an embodiment, the methods herein of making a high-protein sunflower oleosome preparation further comprise, following step (viii), a step of pasteurizing the double-washed high-protein sunflower oleosome preparation to obtain a pasteurized double-washed high-protein sunflower oleosome preparation.

In an embodiment of the methods herein of making a high-protein sunflower oleosome preparation, the dehulled seeds are washed in reverse osmosis water that has a temperature of no more than about 60° C.

One embodiment disclosed herein relates to a method of making a sunflower protein concentrate and an oleosome containing light liquid phase, comprising the steps of: (i) providing whole dehulled seeds from a sunflower plant; (ii) comminuting the dehulled sunflower seeds in an aqueous solution to obtain a comminuted seed mixture comprising comminuted seed particles having mean particle sizes D[4,3] in a range of about 5 μm to about 200 μm; (iii) adjusting the pH of the comminuted seed mixture to from about pH 5 to about pH 6 to obtain a pH adjusted comminuted seed mixture; (iv) separating the pH adjusted comminuted seed mixture into a solid phase and a liquid phase; (v) adjusting the pH of the liquid phase to about pH 8 to obtain a pH adjusted liquid phase; (vi) separating the pH adjusted liquid phase to obtain an oleosome containing light liquid phase and a protein containing heavy liquid phase; (vii) separating the protein containing heavy liquid phase to obtain a cream phase and a heavy phase; (viii) adjusting the pH of the heavy phase to about pH 4.5 to obtain a pH adjusted heavy phase; (ix) separating the pH adjusted heavy phase to obtain an aqueous phase and a protein precipitate; (x) diluting the protein precipitate to obtain a protein slurry; (xi) adjusting the pH of the protein slurry to about 7 to obtain a pH-adjusted protein slurry, wherein the protein slurry comprises from about 49% (w/w) to about 90% (w/w) protein, from about 1% (w/w) to about 32% (w/w) oil, and from about 0% (w/w) to about 8% (w/w) ash; and (xii) drying the pH adjusted protein slurry to obtain a sunflower protein concentrate having a moisture content of about 10% or less.

In an embodiment of the methods herein of making a sunflower protein concentrate and an oleosome containing light liquid phase, step (xii) comprises spray drying the protein slurry to obtain a spray-dried sunflower protein concentrate.

One embodiment disclosed herein relates to a method of making a sunflower oleosome preparation and a sunflower protein concentrate, comprising the steps of: (i) providing whole dehulled seeds from a sunflower plant; (ii) comminuting the dehulled sunflower seeds in an aqueous solution to obtain a comminuted seed mixture comprising comminuted seed particles having mean particle sizes D[4,3] in a range of about 5 μm to about 200 μm; (iii) adjusting the pH of the comminuted seed mixture to from about pH 7 to about pH 7.5 to obtain a pH adjusted comminuted seed mixture; (iv) separating the pH adjusted comminuted seed mixture into a solid phase and a liquid phase; (v) detecting the pH of the liquid phase and adjusting the pH of the liquid phase to from about pH 7 to about 7.5 if the detected pH is less than about 7 or more than about 7.5, and obtain a pH adjusted liquid; (vi) separating the pH adjusted liquid phase into an oleosome containing light liquid phase and a protein containing heavy liquid phase; (vii) washing the oleosome containing light liquid phase in a first washing solution and obtaining washed oleosomes; (viii) further washing the washed oleosomes in a second washing solution to obtain a double-washed sunflower oleosome preparation having a protein content of from about 2% (w/w) to about 5% (w/w) on a dry basis (db) and having a dry weight of from about 40% (w/w) to about 70% (w/w), a lipid to protein ratio of from about 10 to about 50 on a dry basis (db), and containing particles having a mean particle size D[4,3] of about 2 μm to about 10 μm; (ix) separating the protein containing heavy liquid phase obtained in step (vi) to obtain a cream phase and a heavy phase; (x) adjusting the pH of the heavy phase to about pH 4 to 5 to obtain a pH adjusted heavy phase; (xi) separating the pH adjusted heavy phase to obtain an aqueous phase and a protein precipitate; (xii) diluting the protein precipitate to obtain a protein slurry; (xiii) adjusting the pH of the protein slurry to about 7 to obtain a pH-adjusted protein slurry comprising from about 49% (w/w) to about 90% (w/w) protein, from about 1% (w/w) to about 32% (w/w) oil, and from about 0% (w/w) to about 8% (w/w) ash; and (xiv) drying the pH adjusted protein slurry to obtain a sunflower protein concentrate containing greater than 80% (w/w) protein; from about 1% (w/w) to about 20% (w/w) oil; from about 0% (w/w) to about 8% (w/w) ash, and having a moisture content of about 10% (w/w) or less.

In an embodiment, the methods herein of making a sunflower oleosome preparation and a sunflower protein concentrate further comprise a step of pasteurizing the double-washed sunflower oleosome preparation to obtain a pasteurized double-washed high-protein sunflower oleosome preparation.

In an embodiment, the methods herein of making a sunflower oleosome preparation and a sunflower protein concentrate further comprise a step of adjusting the pH of the double-washed sunflower oleosome preparation or the pasteurized double-washed sunflower oleosome preparation to obtain a low-pH sunflower oleosome preparation.

In an embodiment of the methods herein of making a sunflower oleosome preparation and a sunflower protein concentrate, the low-pH sunflower oleosome preparation has a pH of from about 2.5 to about 3.5 and the mean particle size D[4,3] is from of about 2 μm to about 5 μm.

In an embodiment of the methods herein of making a sunflower oleosome preparation and a sunflower protein concentrate, in step (ii) the aqueous solution is sodium hexametaphosphate.

In an embodiment of the methods herein of making a sunflower oleosome preparation and a sunflower protein concentrate, one or more of steps (ix) to (xiv) are performed simultaneously with one or more of steps (vii) to (x).

In an embodiment of the methods herein of making a sunflower oleosome preparation and a sunflower protein concentrate, the performance of steps (ix) to (xiv) is initiated following the completion of steps (vii) to (x).

In an embodiment of the methods herein of making a sunflower oleosome preparation and a sunflower protein concentrate, the performance of steps (ix) to (xiv) is completed prior to the initiation of steps (vii) to (x).

One embodiment disclosed herein relates to a method of preparing a nutritional formulation, the method comprising: (i) providing a sunflower oleosome preparation as described herein; (ii) providing at least one formulary ingredient suitable for inclusion in a nutritional formulation; and (iii) blending together the sunflower oleosome preparation with the at least one formulary ingredient to form a nutritional formulation comprising the low-protein sunflower oleosome preparation or the high-protein sunflower oleosome preparation.

In an embodiment of the methods herein of preparing a nutritional formulation, the formulary ingredient is a natural ingredient.

In an embodiment of the methods herein of preparing a nutritional formulation the formulary ingredient is a sunflower protein concentrate as prepared by the methods as described herein.

In an embodiment of the methods herein of preparing a nutritional formulation, the nutritional formulation is selected from a plant protein-based milk, a cheese, a plant protein-based alternative meat product, a yoghurt, an egg replacement product, a salad dressing, a baking product, an ice-cream, and a frozen desert.

In an embodiment of the methods herein of preparing a nutritional formulation the nutritional formulation is prepared by extrusion using a food forming extruder or a shear cell technique, and (i) the sunflower oleosome preparation is blended with the at least one formulary ingredient to form a blended feedstock, and the blended feedstock is thereafter conveyed into a feedstock receptacle of the food forming extruder, or (ii) the sunflower oleosome preparation and the at least one formulary ingredient are provided as separate feedstocks and more or less simultaneously conveyed into a feedstock receptacle of the food forming extruder. In one aspect of this embodiment, the nutritional formulation is a plant protein-based alternative meat product prepared by extrusion. In another aspect of this embodiment, the nutritional formulation is a plant protein-based alternative meat product prepared by the shear cell technique.

One embodiment disclosed herein relates to a nutritional formulation comprising the any one or more of the sunflower oleosome preparations as described herein, and a formulary ingredient suitable for inclusion in a nutritional formulation.

One embodiment disclosed herein relates to the use of any one or more of the sunflower oleosome preparations as described herein, as an ingredient for preparing a nutritional formulation.

One embodiment disclosed herein relates to a method of preparing a coated oleosome preparation, the method comprising: (i) providing the sunflower oleosome preparation as described herein; (ii) providing a phospholipid or a polysaccharide; and (iii) treating the sunflower oleosome preparation to obtain a coated oleosome preparation wherein the exterior surface of the oleosome is substantially coated with the phospholipid or the polysaccharide to obtain the coated oleosome preparation.

In an embodiment of the methods herein of preparing a coated oleosome preparation the phospholipid is a lecithin.

In an embodiment of the methods herein of preparing a coated oleosome preparation the polysaccharide is a gum.

In an embodiment of the methods herein of preparing a coated oleosome preparation the gum is xanthan gum or gellan gum.

Other features and advantages of the present disclosure will become apparent from the following detailed description. It should be understood, however, that the detailed description, while indicating preferred implementations of the present disclosure, is given by way of illustration only, since various changes and modifications within the spirit and scope of the disclosure will become apparent to those of skill in the art from the detailed description.

### BRIEF DESCRIPTION OF THE DRAWINGS

These and other features of the disclosure will become more apparent in the following detailed description in which reference is made to the appended drawings. The figures are provided herein for a better understanding of the example embodiments and to show more clearly how the various example embodiments may be carried into effect. The figures are not intended to limit the scope of the present disclosure.

FIGS. 1A and 1B together are a schematic block diagram illustrating an example process 100 according to an embodiment of the present disclosure for making an exemplary low-protein sunflower oleosome preparation of the present disclosure.

FIGS. 2A, 2B, and 2C together are a schematic block diagram illustrating another example process 200 according to another embodiment of the present disclosure for making an exemplary low-protein sunflower oleosome preparation of the present disclosure.

FIGS. 3A and 3B together are a schematic block diagram illustrating another example process 300 according to another embodiment of the present disclosure for making an exemplary low-protein sunflower oleosome preparation of the present disclosure.

FIGS. 4A and 4B together a schematic block diagram illustrating another example process 400 according to another embodiment of the present disclosure for making an exemplary high-protein sunflower oleosome preparation of the present disclosure.

FIGS. 5A, 5B, and 5C together are a schematic block diagram illustrating an example process 500 according to an embodiment of the present disclosure for making an exemplary sunflower protein concentrate and an exemplary oleosome containing liquid phase of the present disclosure.

FIGS. 6A, 6B, 6C, 6D, and 6E together are a schematic block diagram illustrating an example process 600 according to an embodiment of the present disclosure for making an exemplary sunflower protein concentrate and an exemplary sunflower oleosome preparation of the present disclosure.

FIG. 7 shows certain confocal laser scanning microscopy (CLSM) images of (a) a 10% low-protein oleosome (LPO) preparation before coating and (b) a 10% LPO coated with 0.2% lecithin. The preparations were stained with Nile Blue. The scale bar shows 5 μm.

FIG. 8 shows certain graphs obtained in the performance of certain experiments evaluating the coating of oleosomes with gums, wherein each graph shows the change in 4-potential as a function of pH. The oleosome preparations evaluated are (a) a 10% low-protein oleosome (LPO); (b) a 10% LPO coated with 0.1% gellan gum; and (c) a 10% LPO coated with 0.1% xanthan gum.

FIG. 9 shows the tensile strength curve of HMMA pancakes (across the flow samples).

### DETAILED DESCRIPTION

As used herein and in the claims, the singular forms, such as “a”, “an” and “the” include the plural reference and vice versa unless the context clearly indicates otherwise. Throughout this specification, unless otherwise indicated, “comprise,” “comprises” and “comprising” are used inclusively rather than exclusively, so that a stated integer or group of integers may include one or more other non-stated integers or groups of integers. The term “or” is inclusive unless modified, for example, by “either”. The term “and/or” is intended to represent an inclusive or. That is “X and/or Y” is intended to mean X or Y or both, for example. As a further example, X, Y and/or Z is intended to mean X or Y or Z or any combination thereof.

When ranges are used herein for physical properties such as molecular weights, chemical properties, chemical formulae, and the like, all combinations and sub-combinations of ranges and specific embodiments therein are intended to be included. Other than in the operating examples or where otherwise indicated, all numbers expressing quantities of ingredients or reaction conditions used herein should be understood as modified in all instances by the term “about.” The term “about” when referring to a number or a numerical range means that the number or numerical range referred to is an approximation within experimental variability (or within statistical experimental error), and thus the number or numerical range may vary between 1% and 15% of the stated number or numerical range, as will be readily recognized by the context. Furthermore, any range of values described herein is intended to specifically include the limiting values of the range, and any intermediate value or sub-range within the given range, and all such intermediate values and sub-ranges are individually and specifically disclosed (e.g., a range of 1 to 5 includes 1, 5, and all values therebetween). Similarly, other terms of degree such as “substantially” and “approximately” as used herein mean a reasonable amount of deviation of the modified term such that the end result is not significantly changed. These terms of degree should be construed as including a deviation of the modified term if this deviation would not negate the meaning of the term it modifies.

Unless otherwise defined, scientific and technical terms used in connection with the formulations described herein shall have the meanings that are commonly understood by those of ordinary skill in the art. The terminology used herein is for the purpose of describing particular embodiments only and is not intended to limit the scope of the present disclosure, which is defined solely by the claims.

All publications, patents, and patent applications referred herein are herein incorporated by reference in their entirety to the same extent as if each individual publication, patent, or patent application was specifically indicated to be incorporated by reference in its entirety.

The term “endocarp”, as used herein, refers to the differentiated tissue adjacent to the seed tissue, in for example, sunflower. The endocarp tissue may contain proteins and phenolics, including polyphenolics such as phenolic acids, flavonoids, tannins, saponins, lignan, lignin, terpenes, alkaloids, and oxalates, for example. Proteins and phenolics contained in the endocarp may be referred to herein as endocarp proteins and endocarp phenolics. It is noted that endocarp proteins and endocarp phenolics may or may not be endocarp-specific. Thus, some endocarp proteins and endocarp phenolics may be uniquely present in endocarp tissue, while others may additionally be present in other plant or seed tissues. By the phrase “substantially free of endocarp phenolics” or “substantially free of endocarp protein”, as used in conjunction with a preparation or composition of the present disclosure, it is meant that the preparation or composition is substantially free of such amounts of the phenolic or protein that are naturally present in the endocarp, and contains, for example, less than 10% (w/w) on dry basis (db), less than 5% (w/w) on db, or less than 1% (w/w) on db of endocarp protein or endocarp phenolic. In an embodiment, by “substantially free” it is meant that the sunflower oleosome preparation of the present disclosure, for example prepared by the methods disclosed herein, has less than 5% (w/w) on db, less than 4.5% (w/w) on db, less than 4% (w/w) on db, less than 3.5% (w/w) on db, less than 3% (w/w) on db, less than 2.5% (w/w) on db, less than 2% (w/w) on db, less than 1.5% (w/w) on db, less than 1% (w/w) on db, less than 0.5% (w/w) on db, or even less of at least one endocarp protein or endocarp phenolic. Optionally, additionally, the preparation may also be substantially free of such amounts of the same phenolic or protein that are naturally present in non-endocarp seed tissue, and contain, for example, less than 10% (w/w), less than 5% (w/w), or less than 1% (w/w) of the same phenolic or protein that are naturally present in non-endocarp seed tissue.

The term “sunflower”, as used herein, refers to a plant belonging to the species Helianthus annuus, and further includes all species, subspecies, cultivars, varieties, hybrids, and genotypes.

The term “comminuting” as used herein, refers to a process for deconstructing plant material into particles having sizes in a range from about 5 μm to about 200 μm and therebetween. Examples of comminuting processes include wet milling, grinding, homogenization, and the like. Suitable comminuting equipment includes a seed mill, a colloid mill, a hammer mill, a blade mill, a roller mill, and the like.

The phrase “formulating the oleosome preparation to form a nutritional product” as used herein, refers to mixing or blending an oleosome preparation, produced by the methods disclosed herein, with at least one other ingredient suitable for inclusion in a nutritional product.

“Particle size” refers to the dimensions of particles present in particle containing preparation and can be expressed in micrometers (μm) to represent the diameter of a spherical, or approximately spherical, particle. In particular, particle size, as used herein, refers to the De Brouckere mean diameter, which takes into consideration that particle containing preparations generally contain particles distributed within a range of particle sizes. In this respect, the De Brouckere mean diameter is understood to be the mean of a particle size distribution weighted by the volume. The De Brouckere mean diameter is denoted herein as “D[4,3]”, as is common in the art. The De Brouckere mean diameter may be assayed, for example, by laser diffraction, or acoustic spectroscopy, or using other particle size assaying techniques known to those of skill in the art. By way of example, a preparation may be described herein as a preparation containing particles having a mean particle size D[4,3] of about 3 μm. It will be understood that such preparation contains particles having a De Brouckere mean diameter of about 3 μm. By way of a further example, a preparation may be described herein as a preparation containing particles having a mean particle size D[4,3] ranging from about 3 μm to about 8 μm. It will be understood that such preparation contains particles that have a De Brouckere mean diameter somewhere in a range of about 3 μm to about 8 μm.

The term “milligram gallic acid equivalent per gram dry weight of sample”, also abbreviated herein as “mg GAE/gram dry weight of sample”, refers to a unit of measurement to quantify the phenolic content of a sample known to contain or suspected to contain phenolic compounds. The phenolic content of a sample may be determined by spectrophotometrically assaying the sample, for example, by assaying absorbance at 750 nm, using assaying techniques known to the art, for example, the methodology of Velioglu, Y., Mazza, G., Gao, L., and Oomah, B. D. (1998): Antioxidant activity and total phenolics in selected fruits, vegetables, and grain products. Journal of agricultural and food chemistry, 46(10), 4113-4117. By way of example, a preparation described herein may be described as having a phenolics content of 0.22 mg GAE/gram dry weight of sample. It will be understood that such preparation has a phenolics content of 0.22 milligram gallic acid equivalents per gram dry weight of sample. Furthermore, in order identify a specific phenolic acid present in a sample, assaying techniques known in the art may be used, such as for example the methodology of Pedrosa, M. M., Muzquiz, M., García-Vallejo, C., Burbano, C., Cuadrado, C., Ayet, G., & Robredo, L. M. (2000): Determination of caffeic and chlorogenic acids and their derivatives in different sunflower seeds. Journal of the Science of Food and Agriculture, 80(4), 459-464. By way of example, a preparation described herein may be described as having a chlorogenic acid content of 0.22 mg/gram wet weight of sample.

In overview, it has surprisingly been realized that sunflower oleosome compositions, including those having either a low protein or a high protein content, and having a surprising oil/protein content, dry weight, and particle size may be isolated and prepared in accordance with the methods disclosed herein. Furthermore, the oleosome preparations may have a low water content. The sunflower oleosome preparations surprisingly exhibit desirable color, smell, and flavor profiles.

The sunflower oleosome preparations of the present disclosure are useful for the preparation of nutritional formulations including, for example, nutritional formulations suitable for human consumption, among others. Furthermore, the residual presence of plant oils in the present sunflower protein compositions may be beneficial as energy sources in nutritional formulations. The presence of plant oils in the present sunflower protein concentrates may obviate the need for the addition of extraneous oil into nutritional feed formulations. The desirable color, smell, and flavor profiles of the sunflower oleosome preparations, allow for the formulation of a wide range of nutritional products. Furthermore, the low water content of the oleosome formulations allows for formulation flexibility, thus nutritional products having a wide range of water contents may be formulated, i.e., the oleosomes may be used to formulate substantially solid nutritional products as well as liquid nutritional products.

Accordingly, at least one embodiment of the present disclosure pertains to a low-protein sunflower oleosome preparation containing less than about 3% (w/w) protein on a dry basis (db), a dry weight of from about 20% (w/w) to about 80% (w/w), a lipid to protein ratio in excess of about 30 on a dry basis (db), and containing particles having a mean particle size D[4,3] of about 3 μm to about 20 μm. Advantageously, in an embodiment, this low-protein sunflower oleosome preparation is capable of being prepared in the same method as used to prepare a sunflower protein concentrate, in accordance with the present disclosure.

In an embodiment, the low-protein sunflower oleosome preparation comprises less than about 3% (w/w) protein on a dry basis (db), more particularly between about 0.5% (w/w) and about 3% (w/w) protein on a dry basis (db). In an embodiment, the low-protein sunflower oleosome preparation comprises between about 1% (w/w) and about 3% (w/w) protein on a dry basis (db). In an embodiment, the low-protein sunflower oleosome preparation comprises about 1% (w/w), about 1.25% (w/w), about 1.5% (w/w), about 1.75% (w/w), about 2% (w/w), about 2.25% (w/w), about 2.5% (w/w), about 2.75% (w/w), or about 3% (w/w) protein on a dry basis (db). In any such embodiment having any of these described protein concentrations, the low-protein sunflower oleosome preparation may comprise a dry weight of from about 20% (w/w) to about 80% (w/w), more particularly from about 30% (w/w) to about 80% (w/w), more particularly from about 65% (w/w) to about 75% (w/w), and more particularly still from about 65% (w/w) to about 70% (w/w) or from about 70% (w/w) to about 75% (w/w). Alternatively, in any such embodiment having any of these described protein concentrations, the low-protein sunflower oleosome preparation may comprise a dry weight of from about 20% (w/w) to about 70% (w/w), more particularly from about 50% (w/w) to about 70% (w/w), and more particularly still from about 50% (w/w) to about 60% (w/w). In any such embodiment, the low-protein sunflower oleosome preparation may comprise a dry weight of about 20% (w/w), about 25% (w/w), about 30% (w/w), about 35% (w/w), about 40% (w/w), about 45% (w/w), about 50% (w/w), about 55% (w/w), about 60% (w/w), about 65% (w/w), about 70% (w/w), about 75% (w/w), or about 80% (w/w). In any such embodiment having any of these described protein concentrations and any of these described dry weights, including any combination thereof, the low-protein sunflower oleosome preparation may have a lipid to protein ratio in excess of 30 on a dry basis (db), more particularly from about 30 to about 90, more particularly from about 30 to about 60, and more particularly still from about 35 to about 45 on a dry basis (db). In any such embodiment having any of these described protein concentrations and any of these described dry weights, including any combination thereof, the low-protein sunflower oleosome preparation may have a lipid to protein ratio from about 70 to about 80 on a dry basis (db). In any such embodiment having any of these described protein concentrations and any of these described dry weights, including any combination thereof, the low-protein sunflower oleosome preparation may have a lipid to protein ratio of about 30, about 35, about 40, about 45, about 50, about 55, about 60, about 65, about 70, about 75, about 80, about 85, or about 90 on a dry basis (db). In any such embodiment having any of these described protein concentrations, any of these described dry weights, and any of these described lipid to protein ratios, including any combination thereof, the low-protein sunflower oleosome preparation may have a mean particle size D[4,3] from about 3 μm to about 20 μm, more particularly from about 3 μm to about 10 μm, more particularly from about 3 μm to about 9 μm, more particularly from about 3 μm to about 8 μm, and more particularly still from about 3 μm to about 5.5 μm. In any such embodiment having any of these described protein concentrations, any of these described dry weights, any of these described lipid to protein ratios, including any combination thereof, the low-protein sunflower oleosome preparation may have a mean particle size D[4,3] from about 10 μm to about 15 μm. In any such embodiment having any of these described protein concentrations, any of these described dry weights, any of these described lipid to protein ratios, including any combination thereof, the low-protein sunflower oleosome preparation may have a mean particle size D[4,3] of about 3.0 μm, of about 3.5 μm, of about 4.0 μm, of about 4.5 μm, of about 5.0 μm, of about 5.5 μm, of about 6.0 μm, of about 6.5 μm, of about 7.0 μm, of about 7.5 μm, of about 8.0 μm, of about 8.5 μm, of about 9.0 μm, of about 9.5 μm, of about 10.0 μm, of about 10.5 μm, of about 11.0 μm, of about 11.5 μm, of about 12.0 μm, of about 12.5 μm, of about 13.0 μm, of about 13.5 μm, of about 14.0 μm, of about 14.5 μm, of about 15.0 μm, of about 15.5 μm, of about 16.0 μm, of about 16.5 μm, of about 17.0 μm, of about 17.5 μm, of about 18 μm, of about 18.5 μm, of about 19.0 μm, of about 19.5 μm, or of about 20.0 μm.

Accordingly, at least one embodiment of the present disclosure pertains to a low-protein sunflower oleosome preparation containing less than 3% (w/w) protein, and having a dry weight of from about 30% (w/w) to about 80% (w/w), a lipid to protein ratio in excess of about 30 on a dry basis (db), and containing particles having a mean particle size D[4,3] of about 3 μm to about 10 μm.

Accordingly, at least one embodiment of the present disclosure pertains to a low-protein sunflower oleosome preparation containing less than 3% (w/w) protein, and having a dry weight of from about 65% (w/w) to about 75% (w/w), a lipid to protein ratio from about 30 to about 90 on a dry basis (db), and containing particles having a mean particle size D[4,3] of about 3 μm to about 9 μm.

Accordingly, at least one embodiment of the present disclosure pertains to a low-protein sunflower oleosome preparation containing less than 3% (w/w) protein, and having a dry weight of from about 20% (w/w) to about 60% (w/w), a lipid to protein ratio in excess of 30 on a dry basis (db), and containing particles having a mean particle size D[4,3] of about 3 μm to about 20 μm. In an embodiment, the preparation has a pH of from about 2.5 to about 3.5.

Accordingly, at least one embodiment of the present disclosure pertains to a low-protein sunflower oleosome preparation containing less than 3% (w/w) protein, and having a dry weight of from about 50% (w/w) to about 60% (w/w), a lipid to protein ratio of about 50 on a dry basis (db), and containing particles having a mean particle size D[4,3] of from about 10 μm to about 15 μm.

Accordingly, at least one embodiment of the present disclosure pertains to a low-protein sunflower oleosome preparation containing less than 3% (w/w) protein, and having a dry weight of from about 50% (w/w) to about 70% (w/w), a lipid to protein ratio of from about 30 to about 60 on a dry basis (db), and containing particles having a mean particle size D[4,3] of from about 3 μm to about 8 μm. In an embodiment, the preparation is substantially free of at least one of (i) an endocarp protein; and (ii) an endocarp phenolic.

Accordingly, at least one embodiment of the present disclosure pertains to a low-protein sunflower oleosome preparation containing less than 3% (w/w) protein, and having a dry weight of from about 65% (w/w) to about 70% (w/w), a lipid to protein ratio of from about 35 to about 45 on a dry basis (db), and containing particles having a mean particle size D[4,3] of from about 3 μm to about 5.5 μm.

Accordingly, at least one embodiment of the present disclosure pertains to a low-protein sunflower oleosome preparation containing less than 3% (w/w) protein, and having a dry weight of from about 30% (w/w) to about 80% (w/w), a lipid to protein ratio in excess of 30 on a dry basis (db), containing particles having a mean particle size D[4,3] of from about 3 μm to about 20 μm, and wherein the CIELAB color value of the oleosome preparation is a*>0.

Accordingly, at least one embodiment of the present disclosure pertains to a low-protein sunflower oleosome preparation containing less than 3% (w/w) protein, and having a dry weight of from about 70% (w/w) to about 75% (w/w), a lipid to protein ratio of from about 70 to about 80 on a dry basis (db), and containing particles having a mean particle size D[4,3] of from about 3.5 μm to about 15 μm.

In any of the embodiments of the low-protein sunflower oleosome preparation described herein, the preparation may (i) comprise a phenolics content of from about 0.1 to about 0.4 milligram gallic acid equivalent per gram (mg GAE/gram) dry weight of sample, (ii) be a pasteurized low-protein oleosome preparation, (iii) further comprise a preservative agent, (iv) have a protein concentration is between about 1% (w/w) and about 3% (w/w) on a dry basis (db), (v) have a pH, or be adjusted to have a pH, of from about 2.5 to about 3.5, or (vi) comprise any combination thereof.

Furthermore, at least one embodiment of the present disclosure pertains to a high-protein sunflower oleosome preparation containing more than 4% (w/w) protein on a dry basis (db), and having a dry weight of from about 40% (w/w) to about 70% (w/w), a lipid to protein ratio of from about 10 to about 30 on a dry basis (db), and containing particles having a mean particle size D[4,3] of about 2.5 μm to about 10 μm. Advantageously, in an embodiment, this high-protein sunflower oleosome preparation is capable of being prepared in the same method as used to prepare a sunflower protein concentrate, in accordance with the present disclosure.

In an embodiment, the high-protein sunflower oleosome preparation comprises at least about 3% (w/w) protein on a dry basis (db), more particularly at least about 7% (w/w) protein on a dry basis (db). In an embodiment, the high-protein sunflower oleosome preparation comprises between about 4% (w/w) and about 10% (w/w) protein on a dry basis (db), and more particularly between about 4% (w/w) and about 5% (w/w) protein on a dry basis (db). In an embodiment, the high-protein sunflower oleosome preparation comprises about 4% (w/w), about 4.5% (w/w), about 5% (w/w), about 5.5% (w/w), about 6% (w/w), about 6.5% (w/w), about 7% (w/w), about 7.5% (w/w), about 8% (w/w), about 8.5% (w/w), about 9% (w/w), about 9.5% (w/w), or about 10% (w/w) protein on a dry basis (db). In any such embodiment having any of these described protein concentrations, the high-protein sunflower oleosome preparation may comprise a dry weight of from about 40% (w/w) to about 70% (w/w), more particularly from about 50% (w/w) to about 70% (w/w), and more particularly still from about 60% (w/w) to about 70% (w/w). In any such embodiment, the high-protein sunflower oleosome preparation may comprise a dry weight of about 40% (w/w), about 45% (w/w), about 50% (w/w), about 55% (w/w), about 60% (w/w), about 65% (w/w), or about 70% (w/w). In any such embodiment having any of these described protein concentrations and any of these described dry weights, including any combination thereof, the high-protein sunflower oleosome preparation may have a lipid to protein ratio of from about 10 to about 30 on a dry basis, more particularly from about 10 to about 25, more particularly from about 10 to about 20, and more particularly still from about 15 to about 20 or from about 10 to about 12.5 on a dry basis (db). In any such embodiment having any of these described protein concentrations and any of these described dry weights, including any combination thereof, the high-protein sunflower oleosome preparation may have a lipid to protein ratio of about 10, about 15, about 20, about 25, or about 30 on a dry basis (db). In any such embodiment having any of these described protein concentrations, any of these described dry weights, and any of these described lipid to protein ratios, including any combination thereof, the high-protein sunflower oleosome preparation may have a mean particle size D[4,3] from about 2.5 μm to about 10 μm, more particularly from about 3 μm to about 5 μm, and more particularly still from about 2.5 μm to about 4 μm. Alternatively, in any such embodiment having any of these described protein concentrations, any of these described dry weights, and any of these described lipid to protein ratios, including any combination thereof, the high-protein sunflower oleosome preparation may have a mean particle size D[4,3] from about 4 μm to about 5 μm. In any such embodiment having any of these described protein concentrations, any of these described dry weights, any of these described lipid to protein ratios, including any combination thereof, the high-protein sunflower oleosome preparation may have a mean particle size D[4,3] of about 2.5 μm, about 3.0 μm, of about 3.5 μm, of about 4.0 μm, of about 4.5 μm, of about 5.0 μm, of about 5.5 μm, of about 6.0 μm, of about 6.5 μm, of about 7.0 μm, of about 7.5 μm, of about 8.0 μm, of about 8.5 μm, of about 9.0 μm, of about 9.5 μm, or of about 10.0 μm.

Accordingly, at least one embodiment of the present disclosure pertains to a high-protein sunflower oleosome preparation containing more than 4% (w/w) protein on a dry basis (db), and having a dry weight of from about 50% (w/w) to about 70% (w/w), a lipid to protein ratio of from about 10 to about 30 on a dry basis (db), and containing particles having a mean particle size D[4,3] of about 2.5 μm to about 10 μm.

Accordingly, at least one embodiment of the present disclosure pertains to a high-protein sunflower oleosome preparation containing more than 4% (w/w) protein on a dry basis (db), and having a dry weight of from about 60% (w/w) to about 70% (w/w), a lipid to protein ratio of from about 10 to about 30 on a dry basis (db), and containing particles having a mean particle size D[4,3] of about 2.5 μm to about 10 μm.

Accordingly, at least one embodiment of the present disclosure pertains to a high-protein sunflower oleosome preparation containing more than 4% (w/w) protein on a dry basis (db), and having a dry weight of from about 50% (w/w) to about 70% (w/w), a lipid to protein ratio of from about 10 to about 25 on a dry basis (db), and containing particles having a mean particle size D[4,3] of about 2.5 μm to about 5 μm. In an embodiment, the dry weight is from about 60% (w/w) to about 70% (w/w).

Accordingly, at least one embodiment of the present disclosure pertains to a high-protein sunflower oleosome preparation containing more than 4% (w/w) protein on a dry basis (db), and having a dry weight of from about 50% (w/w) to about 70% (w/w), a lipid to protein ratio of from about 10 to about 20 on a dry basis (db), and containing particles having a mean particle size D[4,3] of about 2.5 μm to about 10 μm. In an embodiment, the dry weight is from about 60% (w/w) to about 70% (w/w). In an embodiment, a lipid to protein ratio is from about 10 to about 25 on a dry basis (db), and the mean particle size D[4,3] is from about 2.5 μm to about 5 μm

Accordingly, at least one embodiment of the present disclosure pertains to a high-protein sunflower oleosome preparation containing between about 4% (w/w) to about 5% (w/w) protein on a dry basis (db), and having a dry weight of from about 50% (w/w) to about 70% (w/w), a lipid to protein ratio of from about 10 to about 30 on a dry basis (db), and containing particles having a mean particle size D[4,3] of about 2.5 μm to about 4 μm. In an embodiment, the dry weight is from about 60% (w/w) to about 70% (w/w). In an embodiment, a lipid to protein ratio is from about 10 to about 25 on a dry basis (db). In an embodiment, a lipid to protein ratio is from about 10 to about 20 on a dry basis (db). In an embodiment, a lipid to protein ratio is from about 15 to about 20 on a dry basis (db).

Accordingly, at least one embodiment of the present disclosure pertains to a high-protein sunflower oleosome preparation containing at least about 7% (w/w) protein on a dry basis (db), and having a dry weight of from about 50% (w/w) to about 70% (w/w), a lipid to protein ratio of from about 10 to about 30 on a dry basis (db), and containing particles having a mean particle size D[4,3] of about 2.5 μm to about 5 μm. In an embodiment, the dry weight is from about 60% (w/w) to about 70% (w/w). In an embodiment, a lipid to protein ratio is from about 10 to about 25 on a dry basis (db). In an embodiment, a lipid to protein ratio is from about 10 to about 20 on a dry basis (db). In an embodiment, a lipid to protein ratio is from about 15 to about 20 on a dry basis (db). In an embodiment, a lipid to protein ratio is from about 10 to about 12.5 on a dry basis (db).

In any of the embodiments of the high-protein sunflower oleosome preparation described herein, the preparation may (i) comprise a phenolics content of from about 0.1 to about 0.4 milligram gallic acid equivalent per gram (mg GAE/gram) dry weight of sample, (ii) be a pasteurized high-protein oleosome preparation, (iii) further comprise a preservative agent, (iv) have a pH, or be adjusted to have a pH, of from about 2.5 to about 3.5, or (v) comprise any combination thereof.

Furthermore, at least one embodiment of the present disclosure pertains to a sunflower oleosome preparation having a protein concentration of from about 2% (w/w) to about 5% (w/w) on a dry basis (db) and having a dry weight of from about 40% (w/w) to about 70% (w/w), a lipid to protein ratio of from about 10 to about 50 on a dry basis (db), and containing particles having a mean particle size D[4,3] of from about 2 μm to about 10 μm. Advantageously, in an embodiment, this sunflower oleosome preparation is capable of being prepared in the same method as used to prepare a sunflower protein concentrate, in accordance with the present disclosure.

In an embodiment, the sunflower oleosome preparation comprises from about 2% (w/w) to about 5% (w/w) protein on a dry basis (db), more particularly from about 2.5 (w/w) to about 4.5 (w/w). In an embodiment, the sunflower oleosome preparation comprises about 2% (w/w), about 2.25% (w/w), about 2.5% (w/w), about 2.75% (w/w), about 3% (w/w), about 3.25% (w/w), about 3.5% (w/w), about 3.75% (w/w), about 4% (w/w), about 4.25% (w/w), about 4.5% (w/w), about 4.75% (w/w), or about 5% (w/w) protein on a dry basis (db). In any such embodiment having any of these described protein concentrations, the sunflower oleosome preparation may comprise a dry weight of from about 40% (w/w) to about 70% (w/w), more particularly from about 50% (w/w) to about 70% (w/w), and more particularly still from about 60% (w/w) to about 70% (w/w). In any such embodiment, the sunflower oleosome preparation may comprise a dry weight of about 40% (w/w), about 45% (w/w), about 50% (w/w), about 55% (w/w), about 60% (w/w), about 65% (w/w), or about 70% (w/w). In any such embodiment having any of these described protein concentrations and any of these described dry weights, including any combination thereof, the sunflower oleosome preparation may have a lipid to protein ratio of from about 10 to about 50 on a dry basis (db), more particularly from about 15 to about 40 on a dry basis (db). In any such embodiment having any of these described protein concentrations and any of these described dry weights, including any combination thereof, the sunflower oleosome preparation may have a lipid to protein ratio of about 10, about 15, about 20, about 25, or about 30 on a dry basis (db). In any such embodiment having any of these described protein concentrations, any of these described dry weights, and any of these described lipid to protein ratios, including any combination thereof, the sunflower oleosome preparation may have a mean particle size D[4,3] from about 2 μm to about 10 μm, more particularly from about 2 μm to about 5 μm. In any such embodiment having any of these described protein concentrations, any of these described dry weights, any of these described lipid to protein ratios, including any combination thereof, the sunflower oleosome preparation may have a mean particle size D[4,3] of about 2.0 μm, about 2.5 μm, about 3.0 μm, of about 3.5 μm, of about 4.0 μm, of about 4.5 μm, of about 5.0 μm, of about 5.5 μm, of about 6.0 μm, of about 6.5 μm, of about 7.0 μm, of about 7.5 μm, of about 8.0 μm, of about 8.5 μm, of about 9.0 μm, of about 9.5 μm, or of about 10.0 μm.

Accordingly, at least one embodiment of the present disclosure pertains to a sunflower oleosome preparation containing from about 2% (w/w) to about 5% (w/w) protein on a dry basis (db), and having a dry weight of from about 60% (w/w) to about 70% (w/w), a lipid to protein ratio of from about 10 to about 50 on a dry basis (db), and containing particles having a mean particle size D[4,3] of from about 2 μm to about 10 μm.

Accordingly, at least one embodiment of the present disclosure pertains to a sunflower oleosome preparation containing from about 2% (w/w) to about 5% (w/w) protein on a dry basis (db), and having a dry weight of from about 40% (w/w) to about 70% (w/w), a lipid to protein ratio of from about 15 to about 40 on a dry basis (db), and containing particles having a mean particle size D[4,3] of from about 2 μm to about 10 μm. In an embodiment, the dry weight is from 60% (w/w) to about 70% (w/w).

Accordingly, at least one embodiment of the present disclosure pertains to a sunflower oleosome preparation containing from about 2% (w/w) to about 5% (w/w) protein on a dry basis (db), and having a dry weight of from about 40% (w/w) to about 70% (w/w), a lipid to protein ratio of from about 10 to about 50 on a dry basis (db), and containing particles having a mean particle size D[4,3] of from about 2 μm to about 5 μm. In an embodiment, the dry weight is from 60% (w/w) to about 70% (w/w). In an embodiment, the lipid to protein ratio is from about 15 to about 40 on a dry basis (db).

Accordingly, at least one embodiment of the present disclosure pertains to a sunflower oleosome preparation containing from about 2% (w/w) to about 5% (w/w) protein on a dry basis (db), and having a dry weight of from about 40% (w/w) to about 70% (w/w), a lipid to protein ratio of from about 10 to about 50 on a dry basis (db), containing particles having a mean particle size D[4,3] of from about 2 μm to about 10 μm, and having a pH of from about 2.5 to about 3.5. In an embodiment, the dry weight is from 60% (w/w) to about 70% (w/w). In an embodiment, the lipid to protein ratio is from about 15 to about 40 on a dry basis (db). In an embodiment, the mean particle size D[4,3] is from about 2 μm to about 5 μm.

In any of the embodiments of the sunflower oleosome preparation described herein, the preparation may (i) comprise a phenolics content of from about 0.1 to about 0.4 milligram gallic acid equivalent per gram (mg GAE/gram) dry weight of sample, (ii) be a pasteurized high-protein oleosome preparation, (iii) further comprise a preservative agent, (iv) have a pH, or be adjusted to have a pH, of from about 2.5 to about 3.5, or (v) comprise any combination thereof.

The sunflower oleosome preparations disclosed herein may be prepared from parts of sunflower plants, notably seeds, i.e., plants belonging to the plant species Helianthus annuus, wherein the seeds are produced and harvested by agricultural practices or by horticultural practices. Also suitable are sunflower subspecies, varieties, cultivars, genotypes, or hybrids.

Accordingly, another embodiment according to the present disclosure pertains to methods and processes for producing the disclosed sunflower oleosome preparations, wherein the methods and processes generally comprise selecting a sunflower plant part, notably sunflower plant seeds, and the steps of deconstructing whole sunflower seeds with a selected process. The process involves dehulling the seeds and comminuting the dehulled seeds to produce a comminuted seed particle mixture, separating the comminuted seed mixture into an oleosome and protein containing liquid phase and a solid phase, and further separating the liquid phase into a heavy high-protein fraction and a light liquid oleosome containing fraction, then further processing the light liquid fraction to produce therefrom washed sunflower oleosome preparations. The extraction methods disclosed herein avoid the use of organic solvents and high temperatures i.e., temperatures greater than 60° C.

Various suitable techniques and methods for processing seed materials from sunflower plant material to produce therefrom the present oleosome preparations are disclosed in the following sections. Described herein are example processes 100, 200, 300, 400, 500, and 600, wherein sunflower seeds are selected and used as the starting plant materials for preparing sunflower oleosome preparations and protein concentrates in accordance with some embodiments of the present disclosure. Notably, example processes 100, 200, 300, and 400 yield sunflower oleosome preparations, while example processes 500 and 600 yield a sunflower protein concentrate and either an oleosome containing fraction (process 500) or an oleosome preparation (process 600). Notably, the oleosome containing fraction of process 500 may be used to prepare an oleosome preparation as described herein by employing the methods disclosed herein.

In particular, example processes 100, 200, 300, and 400 are example processes for preparing sunflower oleosome preparations, with example process 100 yielding an oleosome preparation with a low protein content, and example process 400 yielding an oleosome preparation with a high protein content. Similar to example process 100, example processes 200 and 300 each yield oleosome preparations having a low protein content, and a high dry weight. The oleosome preparation of example process 200 yields an acidified oleosome preparation, allowing for improved storage and handling characteristics. The oleosome preparation of example process 300 is an oleosome preparation with improved flavor characteristics, due to the substantial absence therein of at least one of (i) an endocarp protein; and (ii) an endocarp phenolic.

As noted, example processes 500 and 600 yield a sunflower protein concentrate and an oleosome containing fraction. Process 600 yields a sunflower protein concentrate and an oleosome preparation with a protein content of from about 2% (w/w) to about 5% (w/w) protein on a dry basis (db).

In an embodiment, there is provided a method of making a low-protein sunflower oleosome preparation comprising the steps of: (i) providing whole dehulled seeds from a sunflower plant; (ii) comminuting the dehulled sunflower seeds in an aqueous solution to obtain a comminuted seed mixture comprising comminuted seed particles having mean particle sizes D[4,3] in a range of about 5 μm to about 200 μm; (iii) adjusting the pH of the comminuted seed mixture to a pH of from about pH 5 to about pH 6 to obtain a pH adjusted comminuted seed mixture; (iv) separating the pH adjusted comminuted seed mixture into a solid phase and a liquid phase; (v) adjusting the pH of the liquid phase to a pH of from about pH 8 to about 8.5 to obtain a pH adjusted liquid phase; (vi) separating the pH adjusted liquid phase into an oleosome containing light liquid phase and a protein containing heavy liquid phase; (vii) washing the oleosome containing light liquid phase in a first washing solution and obtaining washed oleosomes; and (viii) further washing the washed oleosomes in a second washing solution to obtain a double-washed low-protein sunflower oleosome preparation containing less than about 3% (w/w) on a dry basis (db), a dry weight of from about 20% (w/w) to about 80% (w/w), a lipid to protein ratio in excess of about 30 on a dry basis (db), and containing particles having a mean particle size D[4,3] of about 3 μm to about 20 μm.

Optionally, the method further comprises following step (viii), a step of pasteurizing the double-washed low protein sunflower oleosome preparation to obtain a pasteurized double-washed low-protein sunflower oleosome preparation containing no more than about 3% (w/w) protein on a dry basis (db) and having a dry weight of from about 30% (w/w) to about 80% (w/w), a lipid to protein ratio in excess of about 30 on a dry basis (db), and a mean particle size D[4,3] of about 3 μm to about 20 μm.

Alternatively, and optionally, the method further comprises, following step (viii): (ix) diluting the double-washed low-protein sunflower oleosome preparation with sufficient reverse osmosis water to obtain a diluted oleosome preparation having a dry weight of about 50%; and (x) reducing the pH of the diluted oleosome preparation from between about 8 to about 8.5 to between about 2.5 and about 3.5 to obtain a low-pH low-protein sunflower oleosome preparation. In one aspect, this embodiment further comprises, following step (x), a step of pasteurizing the low-pH protein sunflower oleosome preparation to obtain a pasteurized low-pH low-protein sunflower oleosome preparation.

In another embodiment, there is provided a method of making a high-protein sunflower oleosome preparation, comprising the steps of: (i) providing whole dehulled seeds from a sunflower plant; (ii) comminuting the dehulled sunflower seeds in an aqueous solution to obtain a comminuted seed mixture comprising comminuted seed particles having mean particle sizes D[4,3] in a range of about 5 μm to about 200 μm; (iii) adjusting the pH of the comminuted seed mixture to from about pH 4.5 to about pH 5.0 to obtain a pH adjusted comminuted seed mixture; (iv) separating the pH adjusted comminuted seed mixture into a solid phase and a liquid phase; (v) adjusting the pH of the liquid phase to about pH 7, and obtain a pH adjusted liquid phase; (vi) separating the pH adjusted liquid phase into an oleosome containing light liquid phase and a protein containing heavy liquid phase; (vii) washing the oleosome containing light liquid phase in a first washing solution and obtaining washed oleosomes; and (viii) further washing the washed oleosomes in a second washing solution to obtain a double-washed high-protein sunflower oleosome preparation having a protein content of at least 4% (w/w) on a dry basis (db) and having a dry weight of from about 40% (w/w) to about 70% (w/w), a lipid to protein ratio of from about 10 to about 30 on a dry basis (db), and containing particles having a mean particle size D[4,3] of about 3 μm to about 10 μm.

Optionally, the method further comprises following step (viii), a step of pasteurizing the double-washed high-protein sunflower oleosome preparation to obtain a pasteurized double-washed high-protein sunflower oleosome preparation.

In another embodiment, there is provided a method of making both a sunflower protein concentrate and an oleosome containing light liquid phase, comprising the steps of: (i) providing whole dehulled seeds from a sunflower plant; (ii) comminuting the dehulled sunflower seeds in an aqueous solution to obtain a comminuted seed mixture comprising comminuted seed particles having mean particle sizes D[4,3] in a range of about 5 μm to about 200 μm; (iii) adjusting the pH of the comminuted seed mixture to from about pH 5 to about pH 6 to obtain a pH adjusted comminuted seed mixture; (iv) separating the pH adjusted comminuted seed mixture into a solid phase and a liquid phase; (v) adjusting the pH of the liquid phase to about pH 8 to obtain a pH adjusted liquid phase; (vi) separating the pH adjusted liquid phase to obtain an oleosome containing light liquid phase and a protein containing heavy liquid phase; (vii) separating the protein containing heavy liquid phase to obtain a cream phase and a heavy phase; (viii) adjusting the pH of the heavy phase to about pH 4.5 to obtain a pH adjusted heavy phase; (ix) separating the pH adjusted heavy phase to obtain an aqueous phase and a protein precipitate; (x) diluting the protein precipitate to obtain a protein slurry; (xi) adjusting the pH of the protein slurry to about 7 to obtain a pH-adjusted protein slurry, wherein the protein slurry comprises from about 49% (w/w) to about 90% (w/w) protein, from about 1% (w/w) to about 32% (w/w) oil, and from about 0% (w/w) to about 8% (w/w) ash; and (xii) drying the pH adjusted protein slurry to obtain a sunflower protein concentrate having a moisture content of about 10% or less.

In another embodiment, there is provided a method of making both a sunflower oleosome preparation and a sunflower protein concentrate, comprising the steps of: (i) providing whole dehulled seeds from a sunflower plant; (ii) comminuting the dehulled sunflower seeds in an aqueous solution to obtain a comminuted seed mixture comprising comminuted seed particles having mean particle sizes D[4,3] in a range of about 5 μm to about 200 μm; (iii) adjusting the pH of the comminuted seed mixture to from about pH 7 to about pH 7.5 to obtain a pH adjusted comminuted seed mixture; (iv) separating the pH adjusted comminuted seed mixture into a solid phase and a liquid phase; (v) detecting the pH of the liquid phase and adjusting the pH of the liquid phase to from about pH 7 to about 7.5 if the detected pH is less than about 7 or more than about 7.5, and obtain a pH adjusted liquid; (vi) separating the pH adjusted liquid phase into an oleosome containing light liquid phase and a protein containing heavy liquid phase; (vii) washing the oleosome containing light liquid phase in a first washing solution and obtaining washed oleosomes; (viii) further washing the washed oleosomes in a second washing solution to obtain a double-washed sunflower oleosome preparation having a protein content of from about 2% (w/w) to about 5% (w/w) on a dry basis (db) and having a dry weight of from about 40% (w/w) to about 70% (w/w), a lipid to protein ratio of from about 10 to about 50 on a dry basis (db), and containing particles having a mean particle size D[4,3] of about 2 μm to about 10 μm; (ix) separating the protein containing heavy liquid phase obtained in step (vi) to obtain a cream phase and a heavy phase; (x) adjusting the pH of the heavy phase to about pH 4 to 5 to obtain a pH adjusted heavy phase; (xi) separating the pH adjusted heavy phase to obtain an aqueous phase and a protein precipitate; (xii) diluting the protein precipitate to obtain a protein slurry; (xiii) adjusting the pH of the protein slurry to about 7 to obtain a pH-adjusted protein slurry comprising from about 49% (w/w) to about 90% (w/w) protein, from about 1% (w/w) to about 32% (w/w) oil, and from about 0% (w/w) to about 8% (w/w) ash; and (xiv) drying the pH adjusted protein slurry to obtain a sunflower protein concentrate containing greater than 80% (w/w) protein; from about 1% (W/W) to about 20% (w/w) oil; from about 0% (w/w) to about 8% (w/w) ash, and having a moisture content of about 10% (w/w) or less.

Optionally, the methods herein of making both a sunflower oleosome preparation and a sunflower protein concentrate further comprise a step of pasteurizing the double-washed sunflower oleosome preparation to obtain a pasteurized double-washed high-protein sunflower oleosome preparation.

Additionally, and optionally, the methods herein of making both a sunflower oleosome preparation and a sunflower protein concentrate further comprise a step of adjusting the pH of the double-washed sunflower oleosome preparation or the pasteurized double-washed sunflower oleosome preparation to obtain a low-pH sunflower oleosome preparation. In an embodiment, the low-pH sunflower oleosome preparation has a pH of from about 2.5 to about 3.5 and the mean particle size D[4,3] is from of about 2 μm to about 5 μm.

In an embodiment of the methods herein of making a sunflower oleosome preparation and a sunflower protein concentrate, in step (ii) the aqueous solution is sodium hexametaphosphate.

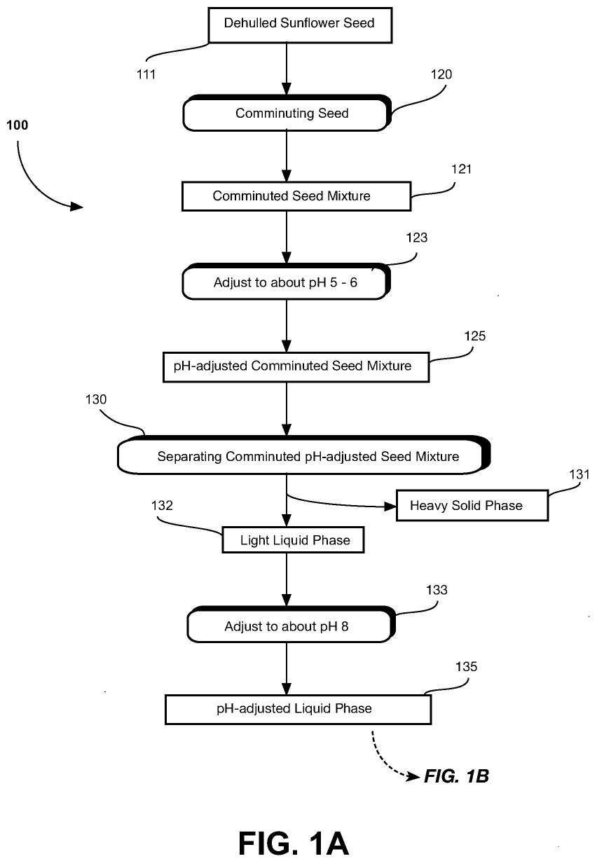

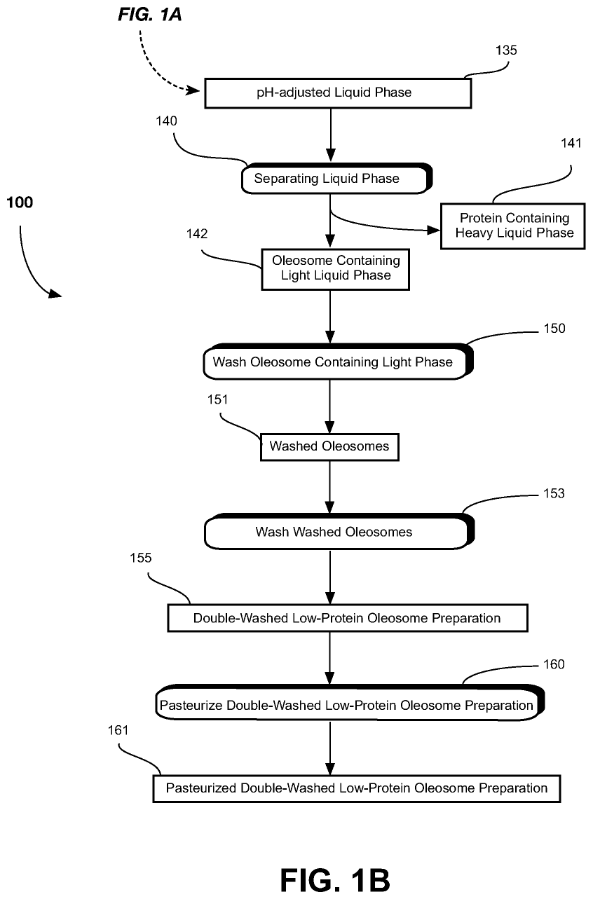

Referring now to FIGS. 1A-1B, example process 100 starts with providing a quantity of sunflower seeds, notably dehulled sunflower seeds 111. Sunflower seeds may be obtained, for example, by agriculturally producing and harvesting seed, and/or by purchasing of sunflower seed from a commercial seed supplier, and subsequently dehulled. Dehulling results in removal of the typically white colored, or black colored, or black and white colored seed hull which may also be referred to as the shell, and allows one to obtain dehulled sunflower seeds 111, also referred to in the art as kernels. Dehulling equipment for sunflower seed is known to those of skill in the art. Prior to dehulling the sunflower seeds may optionally be screened and cleaned, if necessary or so desired, to remove extraneous materials such as debris or non-intact seed material. Furthermore, prior to or after dehulling, the sunflower seeds may also optionally be washed or surface-sterilized using for example, a chemical agent such as bleach or heating, including infrared heating to reduce contaminating biological agents such as bacteria or fungi that may be present on the seed surface. Furthermore, sunflower seeds, preferably dehulled sunflower seeds 111, may be soaked in water or in an aqueous solution.

Continuing to refer to FIGS. 1A-1B, example process 100 further comprises comminuting step 120 wherein dehulled sunflower seeds 111 are comminuted whereby is produced a comminuted mixture of seed particles 121, preferably having mean particle sizes D[4,3] in a range of between about 5 μm and about 200 μm. Comminuting step 120 generally reduces the seed volume as well as the particle size of the comminuted seed. Step 120 may be carried out by conveying of dehulled sunflower seeds 111 into comminuting equipment such as a seed mill, a colloid mill, a hammer mill, a blade mill, a roller mill, and the like. In other embodiments, a homogenizer such as a high-shear homogenizer or a high-pressure homogenizer, may be used to comminute dehulled sunflower seed 111. In yet other embodiments, a sequential combination of a mill and a homogenizer or other such equipment may be used to comminute the seed 111.

It should be further noted that the selection of the specific comminuting equipment and the operating conditions of the equipment may depend on the size of the selected of sunflower seed 111. However, regardless of the comminuting equipment that is selected, upon completion of step 120, the comminuted seed particle mixture 121 will have mean particle sizes D[4,3] in a range of from about 5 μm to about 200 μm or from about 5 μm to about 100 μm, or mean particle sizes D[4,3] in a range of about 10 μm, about 25 μm, about 50 μm, about 100 μm, about 125 μm, about 150 μm, about 175 μm, about 200 μm, and therebetween. Preferably, the comminution equipment and conditions are selected so that the comminuted sunflower seed particles are homogenously sized, i.e., the particles can have tightly-centered mean particle size D[4,3], e.g., at least 90% of the particles can have a size not exceeding ±20% of the particle size, or not exceeding ±10% of the particle size, or not exceeding ±5% of the mean particle size. Furthermore, it should be noted that high temperatures i.e., temperatures in excess of 60° C. are avoided in the performance of comminuting step 120. Thus, comminuting step 120 may be conducted at ambient temperatures although it is understood that during operation of mechanical comminution equipment, the temperature of the seed mixture may increase above ambient temperatures.

Comminuting step 120 may be carried out with the dehulled sunflower seed 111 suspended in an aqueous solution. Examples of suitable aqueous solutions include water and dilute solutions comprising, for example, a sodium salt solution, such as NaCl or Na₂SO₄ or sodium hexametaphosphate, for example. The aqueous solution may be added to the sunflower seed 111 prior to conveyance into the comminuting equipment, or alternatively, while the sunflower seed 111 is being discharged from a seed bin or other seed storage containers into the comminuting equipment. As hereinbefore noted, the use of organic solvents during performance of the comminuting step 120 is avoided.

Continuing to refer to FIGS. 1A-11B, example process 100 may further comprise a separation step 130 during which the comminuted seed particle mixture is separated into a solid phase 131 and a liquid phase 132. Thus, separation step 130 yields two seed fractions. The separation step 130 may be carried out by changing the pH 123 of comminuted seed particle mixture 121 to a pH of from about 5 to about 6 and obtain pH-adjusted comminuted seed mixture 125 and conveying the pH-adjusted comminuted seed particle mixture 125 into equipment suitable for separating the pH-adjusted comminuted seed particle mixture 125, for example, equipment capable in separating fractions based on density differentials, or filtering equipment. In one embodiment, the pH adjustment 123 may be achieved using ascorbic acid or a mixture of ascorbic acid and phosphoric acid (H₃PO₄). Suitable separation equipment includes for example, a centrifuge such as a two-phase decanter operated at modest gravitational forces to separate a light liquid phase 132 and a heavy solid phase 131 containing seed particle solids. The liquid phase 132 recovered after separation therefrom of the heavy solid phase 131, contains the majority of the seed oil, and the separated solid phase 131 contains solid seed particulate material including for example, seed hull fiber.

The recovered solid phase 131 may have a moisture content of from about 65% to about 75%, and a dry-basis composition of from about 33% (w/w) to about 50% (w/w) plant oil, from about 27% (w/w) to about 35% (w/w) protein, from about 1.0% (w/w) to about 2.5% (w/w) ash, and from about 25% (w/w) to about 35% (w/w) carbohydrate. Thus, for example, recovered solid phase 131 may have a moisture content of 70.5%, and a dry-basis composition of 41.6% (w/w) plant oil, 27.6% (w/w) protein, 2.2% (w/w) ash, and 27.8% (w/w) carbohydrate, or, for example, recovered solid phase 131 may have a moisture content of 68.3%, and a dry-basis composition of 34.0% (w/w) plant oil, 30.0% (w/w) protein, 2.0% (w/w) ash, and 33.9% (w/w) carbohydrate.

Continuing to refer to FIGS. 1A-1B, example process 100 may further comprise step 140 during which liquid phase 132 is separated into a light liquid phase 142 containing sunflower oleosomes and a heavy protein containing liquid phase 141. Step 140 may be achieved by changing the pH 133 of the liquid phase from about pH 5-6 to about pH 8 and conveying the pH-adjusted liquid phase 135 into separation equipment capable of further separating the pH-adjusted liquid phase 135 based on density differential, for example, a centrifuge. The recovered oleosome containing light liquid phase 142 may have a moisture content of from about 75% to about 85%, and a dry-basis composition of from about 79% (w/w) to about 86% (w/w) plant oil, from about 9% (w/w) to about 13% (w/w) protein, from about 1.0% (w/w) to about 2.5% (w/w) ash, and from about 0% (w/w) to about 8% (w/w) carbohydrate.

Continuing to refer to FIGS. 1A-1B, example process 100 may further comprise step 150 comprising washing the oleosomes to yield washed oleosomes 151. This may be achieved by suspending the light liquid phase 142 in a suitable aqueous solution and conveying the resulting liquid phase into separation equipment capable of further separating the liquid phase based on density differential, for example, a centrifuge. The recovered washed oleosome phase 151 may have a moisture content of from about 45% to about 75%, and a dry-basis composition of from about 85% (w/w) to about 98% (w/w) plant oil, from about 4% (w/w) to about 9% (w/w) protein, from about 0.3% (w/w) to about 0.8% (w/w) ash, and from about 0% (w/w) to about 10% (w/w) carbohydrate.

Continuing to refer to FIGS. 1A-1B, example process 100 may further comprise step 153 comprising washing the washed oleosomes 151 to yield double-washed low-protein oleosome preparation 155. This may be achieved by suspending the washed oleosome phase 151 in a suitable aqueous solution and conveying the resulting liquid phase into separation equipment capable of further separating the liquid phase based on density differential, for example, a centrifuge. Double-washed low-protein oleosome preparation 155 may optionally be pasteurized 160 to obtain pasteurized double-washed low-protein oleosome preparation 161. The recovered pasteurized double-washed low-protein oleosome preparation 161 may (i) contain less than 3% (w/w) or about 3% (w/w), less than 2.5% (w/w) or about 2.5% (w/w), less than 2% (w/w), or about 2% (w/w), or from 1% (w/w) or about 1% (w/w) to 3% (w/w) or about 3% (w/w) protein on a dry basis (db); (ii) have a dry weight of from 30% (w/w) or about 30% (w/w) to 80% (w/w) or about 80% (w/w), or from 65% (w/w) or about 65% (w/w) to 75% (w/w) or about 75% (w/w), or from 67.8% (w/w) or about 67.8% (w/w) to 75.6% (w/w) or about 75.6% (w/w); (iii) a lipid to protein ratio in excess of 30 or about 30, or a lipid to protein ratio from 30 or about 30 to 90 or about 90, or a lipid to protein ratio from 30.5 or about 30.5 to 86.2 or about 86.2 on a dry basis (db); and (iv) containing particles having a mean particle size D[4,3] of 3 μm or about 3 μm (e.g., 3.2 μm, 3.1 μm, 2.9 μm, 2.8 μm) to 10 μm or about 10 μm, or of 2.8 μm or about 2.8 μm to 9.8 μm or about 9.8 μm, or of 3 μm or about 3 μm (e.g., 3.2 μm, 3.1 μm, 2.9 μm, 2.8 μm) to 9 μm or about 9 μm, or of 2.8 μm or about 2.8 μm to 8.8 μm or about 8.8 μm.

In embodiments wherein the pH adjustment 123 is achieved using ascorbic acid, the recovered pasteurized double-washed low-protein oleosome preparation 161 may (i) contain less than 3% (w/w) or about 3% (w/w), less than 2.5% (w/w) or about 2.5% (w/w), less than 2% (w/w), or about 2% (w/w), or from 1% (w/w) or about 1% (w/w) to 3% (w/w) or about 3% (w/w) protein on a dry basis (db); (ii) have a dry weight of from 30% (w/w) or about 30% (w/w) to 80% (w/w) or about 80% (w/w), or from 70% (w/w) or about 70% (w/w) to 75% (w/w) or about 75% (w/w), or from 71% (w/w) or about 71% (w/w) to 73 (w/w) or about 73% (w/w); (iii) a lipid to protein ratio in excess of 30 or about 30, or a lipid to protein ratio from 35 or about 35 to 45 or about 45, or a lipid to protein ratio from 36 or about 36 to 42 or about 42 on a dry basis (db); and (iv) containing particles having a mean particle size D[4,3] of 3 μm or about 3 μm to 20 μm or about 20 μm, or of 3.5 μm or about 3.5 μm to 20 μm or about 20 μm, or of 3.8 μm or about 3.8 μm to 14 μm or about 14 μm, wherein the CIELAB color value of the oleosome preparation a*>0.

Furthermore, the pasteurized double-washed low-protein oleosome preparation 161 may have a moisture content of from about 27% to about 37%, and a dry-basis composition of from about 90% (w/w) to about 98% (w/w) plant oil, from about 0% (w/w) to about 1.0% (w/w) ash, and from about 0% (w/w) to about 6% (w/w) carbohydrate. Furthermore, the pasteurized double-washed low-protein oleosome preparation 161 comprises a phenolics content of no more than about 0.4 mg GAE/gram dry weight of sample.

Turning next to another example process according to the present disclosure for preparing sunflower oleosomes, example process 200 yields an acidified oleosome preparation, having high dry weight and low phenolics content, and a low protein content.

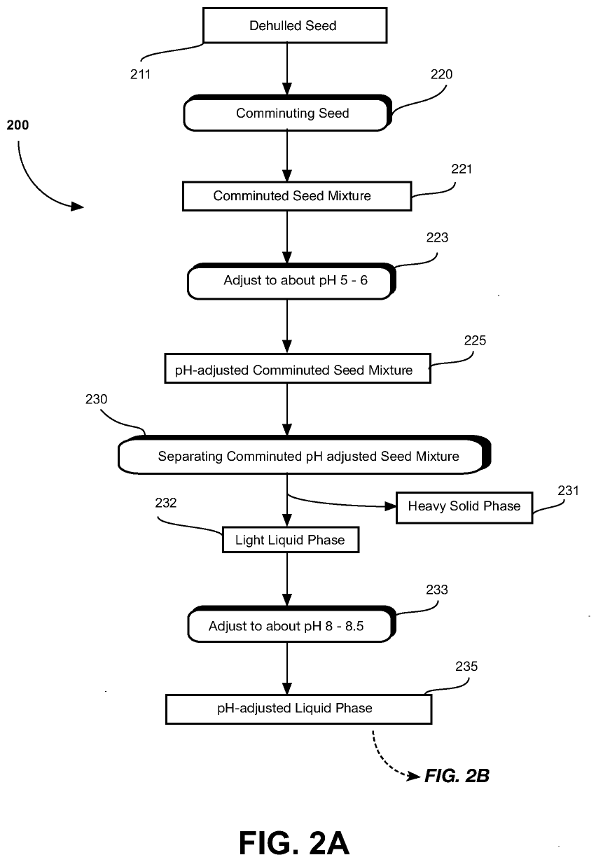

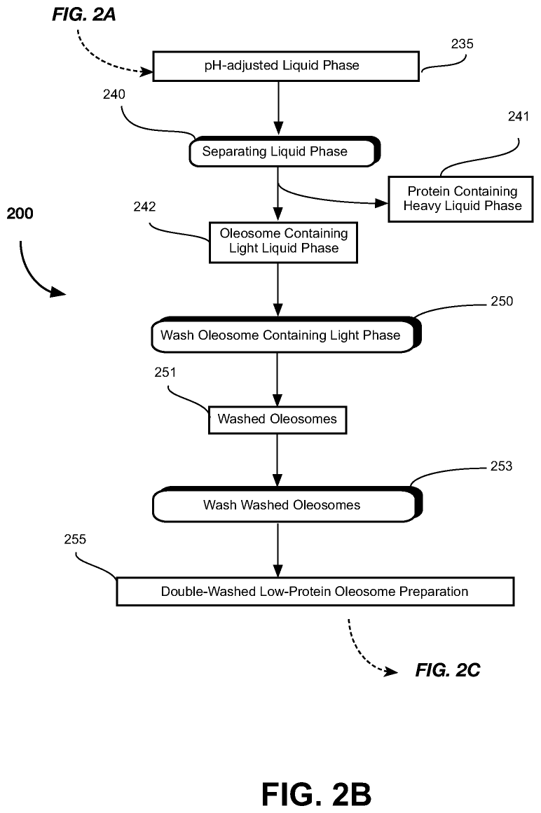

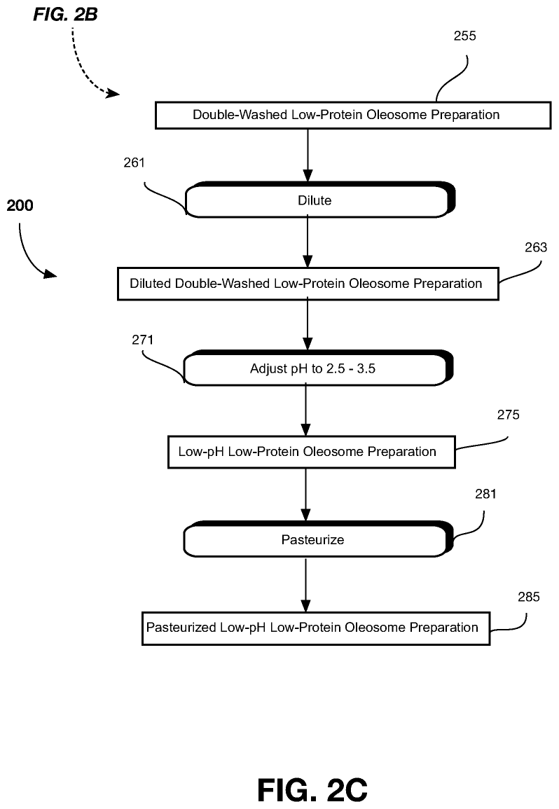

Referring to FIGS. 2A-2C, it is initially noted that example process 200, can be performed in the same manner as example process 100 (see: FIGS. 1A-1B), provided however that, in the performance of example process 200 upon obtaining double-washed low-protein oleosome preparation 255 (corresponding with 155 in example process 100), example process 200 involves the performance of additional steps, as hereinafter further discussed. Thus, for example, dehulled sunflower seed 111 in example process 100 corresponds with dehulled sunflower seed 211 in example process 200, and, for example, step 120 (comminuting the seed) in example process 100, corresponds with step 220 (comminuting the seed) in example process 200, and, for example, comminuted seed mixture 121 in example process 100 corresponds with comminuted seed mixture 221 in example process 200, and so forth.

Thus, continuing to refer to FIGS. 2A-2C, according to example process 200, double-washed low-protein oleosome preparation 255 may be prepared, and diluted 261, using water, for example reverse osmosis (RO) water, or another appropriate diluent, to for example 10%, 20%, 30%, 40%, 50%, 60%, 70%, or 75% dry weight, and obtain diluted double-washed low-protein oleosome preparation 263. The pH of diluted double-washed low-protein oleosome preparation 263 can subsequently be adjusted 271, and decreased to a range of about pH 2 to about pH 4, or a range of about pH 2.5 to about pH 3.5, by adding an acid, such as 85% H₃PO₄, for example, to diluted double-washed low-protein oleosome preparation 263, and thoroughly mixing the acid with diluted double-washed low-protein oleosome preparation 263 to thereby obtain low-pH low-protein oleosome preparation 275. Low-pH low-protein oleosome preparation 275 may further optionally be pasteurized 281, for example at 85° C., to yield pasteurized low-pH low-protein oleosome preparation 285. Pasteurized low-pH low-protein oleosome preparation 285 can (i) contain less than 3% (w/w) or about 3% (w/w), less than 2.5% (w/w) or about 2.5% (w/w), less than 2% (w/w), or about 2% (w/w), or from 1% (w/w) or about 1% (w/w) to 3% (w/w) or about 3% (w/w) protein on a dry basis (db); (ii) have a dry weight of from 20% (w/w) or about 20% (w/w) to 60% (w/w) or about 60% (w/w), or from 50% (w/w) or about 50% (w/w) to 60% (w/w) or about 60% (w/w) or from 52% (w/w) or about 52% (w/w) to 60% (w/w) or about 60% (w/w); (iii) a lipid to protein ratio in excess of 30 or about 30, or 50 or about 50 on a dry basis (db); and (iv) containing particles having a mean particle size D[4,3] of 3 μm or about 3 μm (e.g., 3.2 μm, 3.1 μm, 2.9 μm, 2.8 μm) to 20 μm or about 20 μm, or of 2.8 μm or about 2.8 μm to 20 μm or about 20 μm, or of 10 μm or about 10 μm to 15 μm or about 15 μm, or of 10 μm or about 10 μm to 14.4 μm or about 14.4 μm; and (v) having a pH of from 2.5 or about 2.5 to 3.5 or about 3.5.

Furthermore, the pasteurized low-pH low-protein oleosome preparation 285 may have an oil content of about 94.2% db, ash content of about 0.5% db, and a protein content of about 1% db. Furthermore, the pasteurized low-pH low-protein oleosome preparation 285 may comprise a phenolics content of no more than about 0.4 mg GAE/gram dry weight of sample.

It is noted that low-pH low-protein oleosome preparation 275 and pasteurized low-pH low-protein oleosome preparation 285 generally are stable and exhibit favorable shelf-life characteristics. Thus, pasteurized low-pH low-protein oleosome preparation 285 may be maintained at 25° C. or 40° C. for at least 7 days, at least 14 days, or at least 28 days without becoming microbially compromised.

Turning next to another example process according to the present disclosure for preparing sunflower oleosomes is example process 300 yielding an oleosome preparation with an improved flavor profile. The oleosome preparation is substantially free of at least one of (i) an endocarp protein, (ii) an endocarp fiber and (iii) an endocarp phenolic, and has a low protein content.

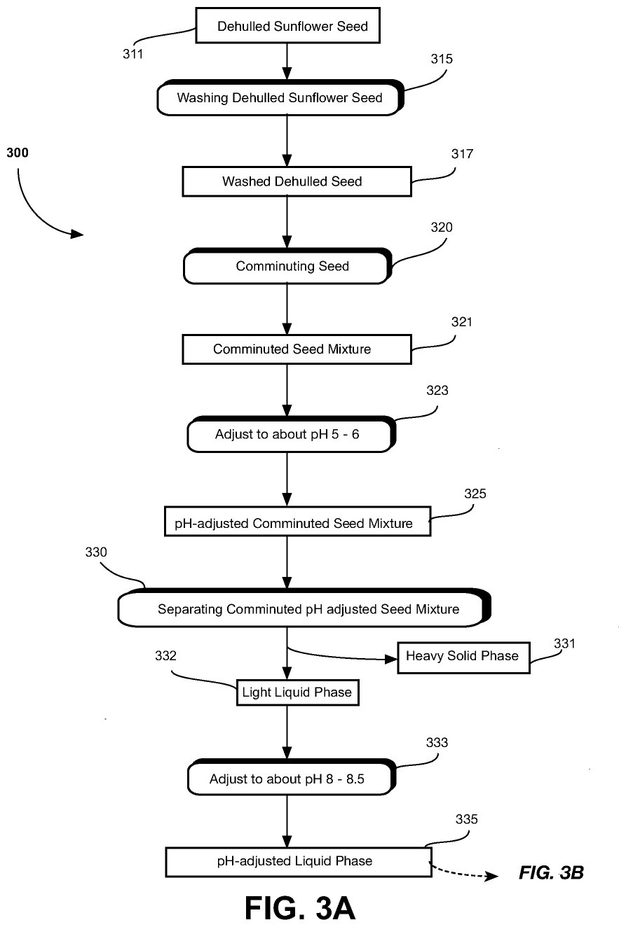

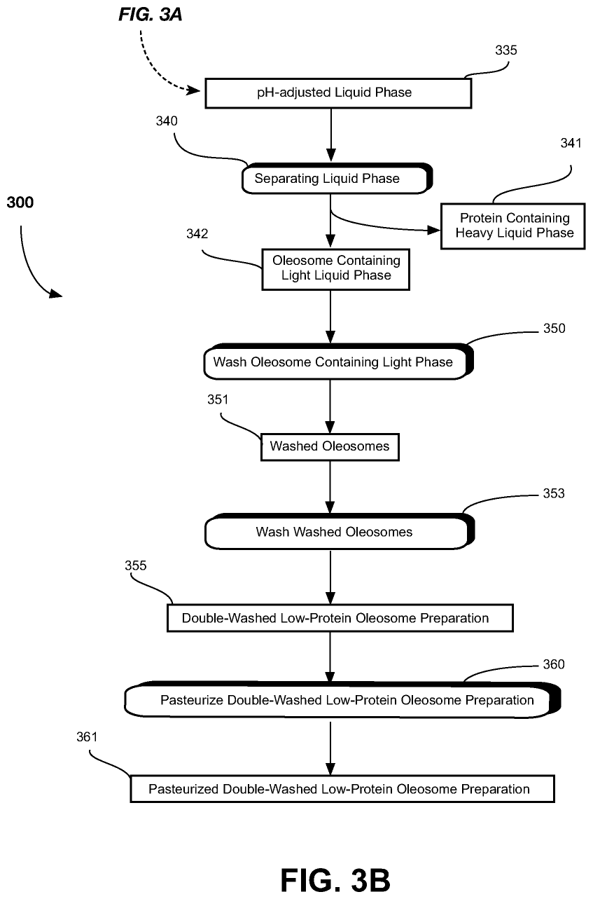

Referring to FIGS. 3A-3B, it is initially noted that example process 300, can be performed in the same manner as example process 100 (see: FIGS. 1A-1B), provided however that, in the performance of example process 300 upon providing dehulled sunflower seed 311 (corresponding with 111 in example process 100), example process 300 involves the performance of an additional intermediate step involving the washing of the dehulled sunflower seed, as hereinafter further discussed. Thus, for example, dehulled sunflower seed 111 in example process 100 corresponds with dehulled sunflower seed 311 in example process 300, and, for example, step 120 (comminuting the seed) in example process 100, corresponds with step 320 (comminuting the seed) in example process 300, and, for example, comminuted seed mixture 121 in example process 100 corresponds with comminuted seed mixture 321 in example process 300, and so forth.

Thus, continuing to refer to FIGS. 3A-3B, according to example process 300, initially dehulled sunflower seeds 311 are provided. Dehulled sunflower seeds 311 may have a neutral-detergent fiber content of about 8%, an acid-detergent fiber content of about 6%, a lignin content of about 4% and a chlorogenic acid content of about 0.15 mg/g. Thereafter, and prior to comminuting 320 the dehulled seed, the dehulled seed 311 is first washed 315 to obtain washed dehulled seed 317. Dehulled seed may be washed using water, including preferably RO water, by adding at least a volume of water equal to the volume of the dehulled seed 311 for example in mixing tank, and mixing the dehulled seed 311 for, example, for about 5 minutes to about 30 minutes. The water temperature may vary but is preferably at least about 20° C., 30° C., 40° C., 50° C., or 60° C. Subsequently excess water is removed by decantation or pumping and obtain washed dehulled seed 317. The washed dehulled seed 317 may have a neutral-detergent fiber content of about 7%, an acid-detergent fiber content of about 5%, a lignin content of about 3% and a chlorogenic acid content of about 0.10 mg/g. The washed dehulled seed 317 then may be comminuted 320, in the same manner as herein before described with respect to example process 100, and the remaining steps may be performed, again as herein described with respect to example process 100 to obtain double-washed low-protein oleosome preparation 355 (corresponding with double-washed low-protein oleosome preparation 155 of example process 100), which may optionally be pasteurized 360 to obtain pasteurized double-washed low-protein oleosome preparation 361 (corresponding with pasteurized double-washed low-protein oleosome preparation 161).

Pasteurized double-washed low-protein oleosome preparation 361 can (i) contain less than 3% (w/w) or about 3% (w/w), less than 2.5% (w/w) or about 2.5% (w/w), less than 2% (w/w), or about 2% (w/w), or from 1% (w/w) or about 1% (w/w) to 3% (w/w) or about 3% (w/w) protein on a dry basis (db); (ii) have a dry weight of from 50% (w/w) or about 50% (w/w) to 70% (w/w) or about 70% (w/w), or from 65% (w/w) or about 65% (w/w) to 70% (w/w) or about 70% (w/w), or from 67% (w/w) or about 67% (w/w) to 68% (w/w) or about 68% (w/w); (iii) a lipid to protein ratio in from 30 or about 30 to 60 or about 60, or a lipid to protein ratio of from 35 or about 35 to 45 or about 45, or a lipid to protein ratio of from 36 or about 36 to 42 or about 42 on a dry basis (db); and (iv) containing particles having a mean particle size D[4,3] of 3 μm or about 3 μm (e.g., 3.2 μm, 3.1 μm, 2.9 μm, 2.8 μm) to 8 μm or about 8 μm, or of 2.7 μm or about 2.7 μm to 8 μm or about 8 μm, or of 2.8 μm or about 2.8 μm to 8 μm or about 8 μm, or of 2.9 μm or about 2.9 μm to 8 μm or about 8 μm, or of 3 μm or about 3 μm (e.g., 3.2 μm, 3.1 μm, 2.9 μm, 2.8 μm) to 5.5 μm or about 5.5 μm, or of 3 μm or about 3 μm (e.g., 3.2 μm, 3.1 μm, 2.9 μm, 2.8 μm) to 5.2 μm or about 5.2 μm; and (v) substantially free of at least one of (i) an endocarp protein and (ii) an endocarp phenolic.

Endocarp phenolics that may be removed in the performance of process 300 can include, polyphenolics, including for example, a phenolic acid, a flavonoid, a tannin, a saponin, lignan, lignin, a terpene, an alkaloid, or an oxalate, for examples.

In this respect, phenolic acids that may be removed in the performance of process 300 include can include chlorogenic acid, ferulic acid, caffeic acid, 3-O-caffeoylquinic acid, 4-O-caffeoylquinic acid, 5-O-caffeoylquinic acid, 5-O-p-coumaroylquinic acid, 5-O-feruloyquinic acid, Dicaffeoylquinic acid, a caffeoylquinic acid, caffeic acid derivative, a coumaric acid derivative, a ferulic acid derivative, 3,4-Di-o-caffeoylquinic acid, 3,5-Di-o-caffeoylquinic acid, or 4,5-Di-o-caffeoylquinic acid, for example.

In this respect, flavonoids that may be removed in the performance of process 300 include can include kaempferol, apigenin, dihydroflavonol, genistein, genistin, daidzein, daidzin, biochanin A, formononetin, luteolin, or quercetin, for example.

Endocarp proteins that may be removed in the performance of process 300 can include, for example, helianthin and albumin.

Furthermore, low-protein oleosome preparation 361 may comprise a phenolics content of no more than about 0.4 mg GAE/gram dry weight of sample.

It is noted that pasteurized double-washed low-protein oleosome preparation 355 may be used to obtain a low pH oleosome preparation, in the same manner as double-washed low-protein oleosome preparation 255 may be used to obtain low pH oleosome preparation 275 (not shown in FIGS. 3A-3B).

Turning next to another example process according to the present disclosure for preparing sunflower oleosomes is example process 400 yielding an oleosome preparation with a high protein content.

Example process 400 starts with providing a quantity of sunflower seeds, notably dehulled sunflower seeds 411. Sunflower seeds may be obtained, for example, by agriculturally producing and harvesting seed, and/or by purchasing of sunflower seed from a commercial seed supplier, and subsequently dehulled. Dehulling results in removal of the typically white colored, or black colored, or black and white colored seed hull which may also be referred to as the shell, and allows one to obtain dehulled sunflower seeds 411, also referred to in the art as kernels. Dehulling equipment for sunflower seed is known to those of skill in the art. Prior to dehulling the sunflower seeds may optionally be screened and cleaned, if necessary or so desired, to remove extraneous materials such as debris or non-intact seed material. Furthermore, prior to dehulling, the sunflower seeds may also optionally be washed or surface-sterilized using for example, a chemical agent such as bleach, to reduce contaminating biological agents such as bacteria or fungi that may be present on the seed surface. Furthermore, sunflower seeds, preferably dehulled sunflower seeds 411, may be soaked in water or in an aqueous solution.

Example process 400 further comprises comminuting step 420 wherein dehulled sunflower seeds 411 are comminuted whereby is produced a comminuted mixture of seed particles 421, preferably having particle sizes in a range of between about 5 μm and about 200 μm. Comminuting step 420 generally reduces the seed volume as well as the particle size of the comminuted seed. Step 420 may be carried out by conveying of dehulled sunflower seeds 411 into comminuting equipment such as a seed mill, a colloid mill, a hammer mill, a blade mill, a roller mill, and the like. In other embodiments, a homogenizer such as a high-shear homogenizer or high-pressure homogenizer, may be used to comminute of dehulled sunflower seed 411. In yet other embodiments, a sequential combination of a mill and a homogenizer or other such equipment may be used to comminute the seed 411.

It should be further noted that the selection of the specific comminuting equipment and the operating conditions of the equipment may depend on the size of the selected of sunflower seed 411. However, regardless of the comminuting equipment that is selected, upon completion of step 420, the comminuted seed particle mixture 421 will have mean particle sizes D[4,3] in a range of from about 5 μm to about 200 μm or from about 5 μm to about 100 μm, or mean particle sizes in a range of about 10 μm, about 25 μm, about 50 μm, about 100 μm, about 125 μm, about 150 μm, about 175 μm, about 200 μm, and therebetween. Preferably, the comminution equipment and conditions are selected so that the comminuted sunflower seed particles are homogenously sized, i.e., the particles can have tightly-centered mean-particle size, e.g., at least 90% of the particles can have a size not exceeding ±20% of the particle size, or not exceeding ±10% of the particle size, or not exceeding ±5% of the mean particle size. Furthermore, it should be noted that high temperatures i.e., temperatures in excess of 60° C. are avoided in the performance of comminuting step 420. Thus, comminuting step 420 may be conducted at ambient temperatures although it is understood that during operation of mechanical comminution equipment, the temperature of the seed mixture may increase above ambient temperature.

Comminuting step 420 may be carried out with the dehulled sunflower seed 411 suspended in an aqueous solution. Examples of suitable aqueous solutions include water and dilute solutions comprising, for example, a sodium salt solution, such as NaCl, Na₂SO₄ or sodium hexametaphosphate, for example. The aqueous solution may be added to the sunflower seed 411 prior to conveyance into the comminuting equipment, or alternatively, while the sunflower seed 411 is being discharged from a seed bin or other seed storage containers into the comminuting equipment. As hereinbefore noted, the use of organic solvents during performance of the comminuting step 420 is avoided.

Example process 400 may further comprise a separation step 430 during which the comminuted seed particle mixture is separated into a solid phase 431 and a liquid phase 432. Thus, separation step 430 yields two seed fractions. The separation step 430 may be carried out by adjusting the pH 423 of the comminuted seed particle mixture 421 from about pH 6 to about pH 4.5 to 5 and conveying the pH-adjusted comminuted seed particle mixture 425 into equipment suitable for separating the pH-adjusted comminuted seed particle mixture 425 for example, equipment that permits fraction separation based on density differentials, or other filtering equipment. Suitable separation equipment includes for example, a centrifuge such as a two-phase decanter operated at modest gravitational forces to separate an oleosome containing light liquid phase 432 and a heavy solid phase 431 containing seed particle solids. The liquid phase 432 recovered after separation therefrom of the heavy solid phase 431, contains the majority of the seed oil, and the separated solid phase 431 contains solid seed particulate material including for example, seed hull particles.

The recovered solid phase 431 may have a moisture content of from about 67% to about 75%, and a dry-basis composition of from about 22% (w/w) to about 49% (w/w) plant oil, from about 30% (w/w) to about 38% (w/w) protein, from about 2.5% (w/w) to about 3.5% (w/w) ash, and from about 14% (w/w) to about 40% (w/w) carbohydrate. Thus, for example, recovered solid phase 431 may have a moisture content of 69.23%, and a dry-basis composition of 24.49% (w/w) plant oil, 35.56% (w/w) protein, 2.31% (w/w) ash, and 37.64% (w/w) carbohydrate, or, for example, recovered solid phase 431 may have a moisture content of 68.8%, and a dry-basis composition of 48.6% (w/w) plant oil, 30.3% (w/w) protein, 3.2% (w/w) ash, and 17.9% (w/w) carbohydrate.

Example process 400 may further comprise step 440 during which liquid phase 432 is separated into a light liquid phase 442 containing sunflower oleosomes and a heavy protein containing liquid phase 441. Step 440 may be achieved by adjusting the pH of the liquid phase 432 from about 4.5 to about 7.2 (step 433) and conveying the pH-adjusted liquid phase 435 into separation equipment capable of further separating the pH-adjusted liquid phase 435 based on density differential, for example, a centrifuge. The recovered light liquid phase 442 may have a moisture content of from about 78% to about 83%, and a dry-basis composition of from about 78% (w/w) to about 84% (w/w) plant oil, from about 11% (w/w) to about 16% (w/w) protein, from about 2% (w/w) to about 3% (w/w) ash, and from about 1% (w/w) to about 8% (w/w) carbohydrate.

Example process 400 may further comprise step 450 comprising washing the oleosomes to yield washed oleosomes 451. This may be achieved by suspending the oleosome containing light liquid phase 442 in a suitable aqueous solution and conveying the resulting liquid phase into separation equipment capable of further separating the liquid phase based on density differential, for example, a centrifuge. The recovered washed oleosome phase 451 may have a moisture content of from about 54% to about 65%, and a dry-basis composition of from about 88% (w/w) to about 92% (w/w) plant oil, from about 7% (w/w) to about 13% (w/w) protein, from about 0.5% (w/w) to about 0.8% (w/w) ash, and from about 0% (w/w) to about 3% (w/w) carbohydrate.

Example process 400 may further comprise step 455 comprising washing 453 washed oleosomes 451 to yield double-washed high-protein oleosome preparation 455. This may be achieved by suspending the washed oleosome phase 451 in a suitable aqueous solution and conveying the resulting liquid phase into separation equipment capable of further separating the liquid phase based on density differential, for example, a centrifuge. The recovered double-washed high-protein oleosome preparation may further optionally be pasteurized 460 to obtain pasteurized double-washed high-protein oleosome preparation 461. Pasteurized double-washed high-protein oleosome preparation 461 may (i) contain at least 4% (w/w), at least 5% (w/w), at least 6% (w/w), at least 7% (w/w), at least 8% (w/w), at least 9% (w/w), or at least 10% (w/w), or at least about 4% (w/w), at least about 5% (w/w), at least about 6% (w/w), at least about 7% (w/w), at least about 8% (w/w), at least about 9% (w/w), or at least about 10% (w/w), or from 4% (w/w) or about 4% (w/w) to 6% (w/w) or about 6% (w/w) protein, from 4% (w/w) or about 4% (w/w) to 8% (w/w) or about 8% (w/w) protein, or from 4% (w/w) or about 4% (w/w) to 10% (w/w) or about 10% (w/w) protein, on a dry basis (db); (ii) have a dry weight of from 40% (w/w) or about 40% (w/w) to 70% (w/w) or about 70% (w/w), or from 55% (w/w) or about 55% (w/w) to 70% (w/w) or about 70%, or from 59% (w/w) or about 59% (w/w) to 70% (w/w) or about 70%; (iii) a lipid to protein ratio of from 10 or about 10 to 30 or about 30, or from 10 to about 10 to 25 or about 25, or from 11.8 to about 11.8 to 23.6 or about 23.6 on a dry basis (db); and (iv) containing particles having a mean particle size D[4,3] of 2.5 μm or about 2.5 μm to 10 μm or about 10 μm, or of 2.8 μm or about 2.8 μm to 10 μm or about 10 μm, or of 3 μm or about 3 μm to 9 μm or about 9 μm, or of 3.5 μm or about 3.5 μm to 8.5 μm or about 8.5 μm.

Furthermore, pasteurized double washed high-protein oleosome preparation 461 may have a moisture content of from about 33% to about 41%, and a dry-basis composition of from about 89% (w/w) to about 95 (w/w) plant oil, from about 0% (w/w) to about 0.3% (w/w) ash, and from about 0% (w/w) to about 6% (w/w) carbohydrate. The double-washed high-protein sunflower oleosome preparation 461 may have a phenolics content of from about 0.1 mg to about 0.4 mg GAE/gram dry weight of sample.

Turning next to another example process according to the present disclosure for preparing a sunflower protein concentrate and an oleosome containing fraction is example process 500.

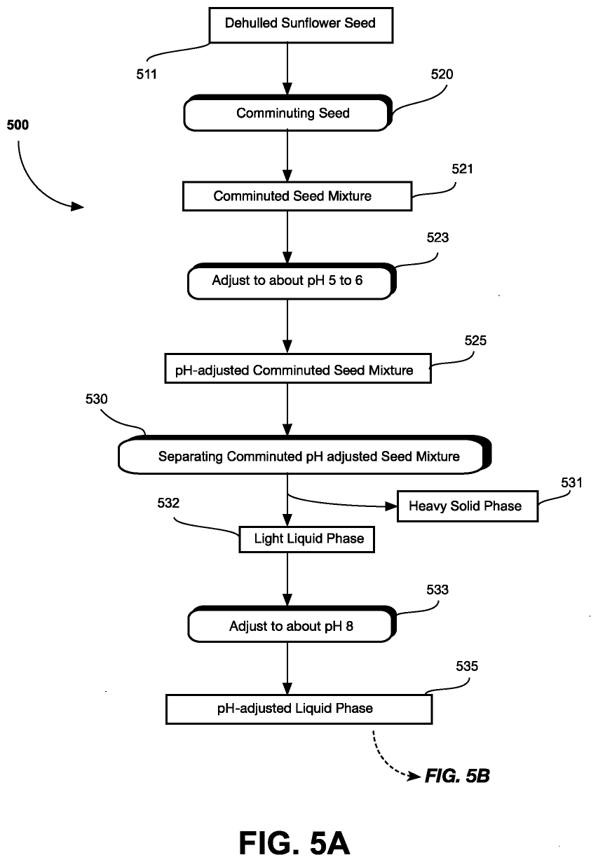

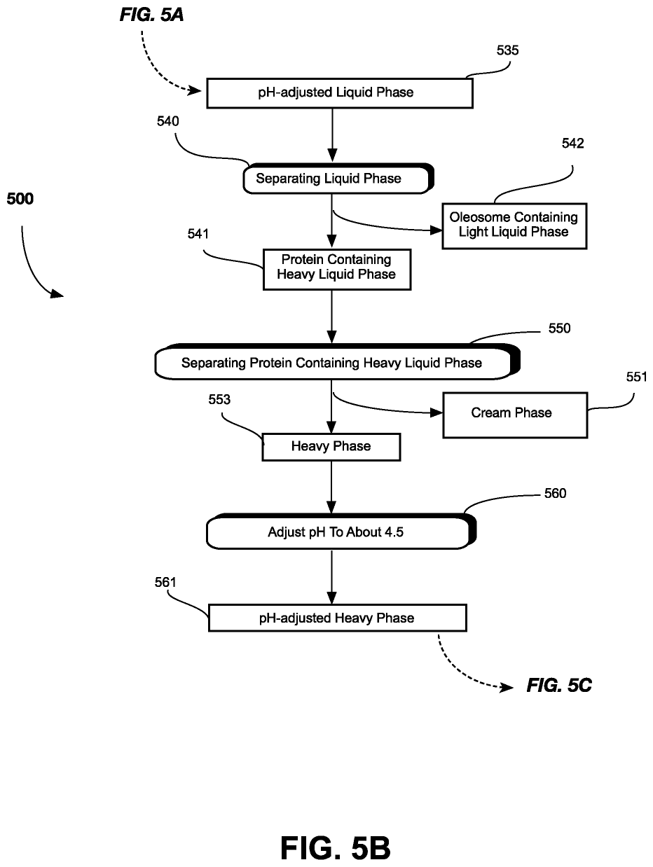

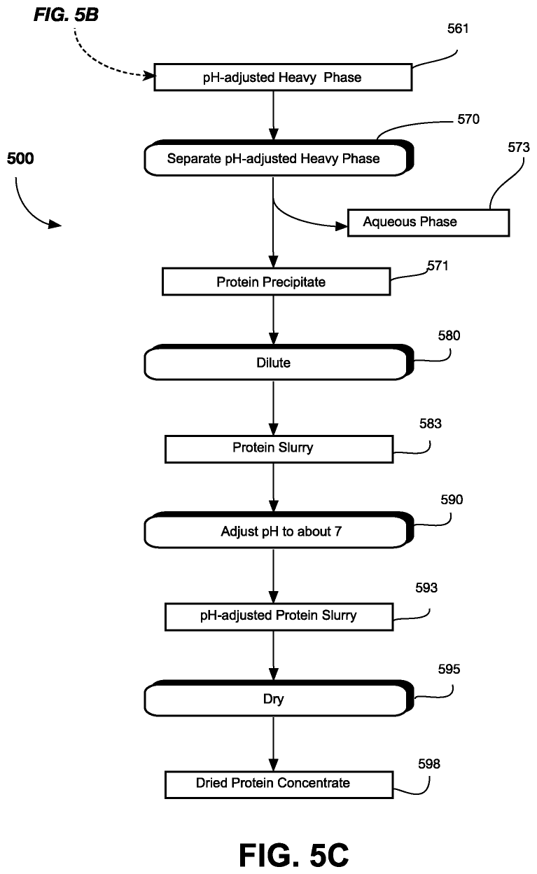

Referring to FIGS. 5A-5C, Example process 500 starts with providing a quantity of sunflower seeds, notably dehulled sunflower seeds 511. Sunflower seeds may be obtained, for example, by agriculturally producing and harvesting seed, and/or by purchasing of sunflower seed from a commercial seed supplier, and subsequently dehulled. Dehulling results in removal of the typically white colored, or black colored, or black and white colored seed hull which may also be referred to as the shell, and allows one to obtain dehulled sunflower seeds 511, also referred to in the art as kernels. Dehulling equipment for sunflower seed is known to those of skill in the art. Prior to dehulling the sunflower seeds may optionally be screened and cleaned, if necessary or so desired, to remove extraneous materials such as debris or non-intact seed material. Furthermore, prior to dehulling, the sunflower seeds may also optionally be washed or surface-sterilized using for example, a chemical agent such as bleach or heating including, infrared heating, to reduce contaminating biological agents such as bacteria or fungi that may be present on the seed hulls or on the seed surface. Furthermore, sunflower seeds, preferably dehulled sunflower seeds 511, may be soaked in water or in an aqueous solution.

Continuing to refer to FIGS. 5A-5C example process 500 further comprises comminuting step 520 wherein dehulled sunflower seeds 511 are comminuted whereby is produced a comminuted mixture of seed particles 521, preferably having mean particle sizes D[4,3] in a range of between about 5 μm and about 200 μm. Comminuting step 520 generally reduces the seed volume as well as the particle size of the comminuted seed. Step 520 may be carried out by conveying of dehulled sunflower seeds 511 into comminuting equipment such as a seed mill, a colloid mill, a hammer mill, a blade mill, a roller mill, and the like. In other embodiments, a homogenizer such as a high-pressure homogenizer, may be used to comminute of dehulled sunflower seed 511. In yet other embodiments, a sequential combination of a mill and a homogenizer or other such equipment may be used to comminute the seed 511.

It should be further noted that the selection of the specific comminuting equipment and the operating conditions of the equipment may depend on the size of the selected of sunflower seed 511. However, regardless of the comminuting equipment that is selected, upon completion of step 520, the comminuted seed particle mixture 521 will have mean particle sizes D[4,3] in a range of from about 5 μm to about 200 μm or from about 5 μm to about 100 μm, or mean particle sizes in a range of about 10 μm, about 25 μm, about 50 μm, about 100 μm, about 125 μm, about 150 μm, about 175 μm, about 200 μm, and therebetween. Preferably, the comminution equipment and conditions are selected so that the comminuted sunflower seed particles are homogenously sized, i.e., the particles can have tightly-centered mean particle size, e.g., at least 90% of the particles can have a size not exceeding ±20% of the particle size, or not exceeding ±10% of the particle size, or not exceeding ±5% of the mean particle size. Furthermore, it should be noted that high temperatures i.e., temperatures in excess of 60° C. are avoided in the performance of comminuting step 520. Thus, comminuting step 520 may be conducted at ambient temperatures although it is understood that during operation of mechanical comminution equipment, the temperature of the seed mixture may increase above the ambient temperatures.

Comminuting step 520 may be carried out with the dehulled sunflower seed 511 suspended in an aqueous solution. Examples of suitable aqueous solutions include water and dilute solutions comprising, for example, a sodium salt solution, such as NaCl, Na₂SO₄, or sodium hexametaphosphate, for example. The aqueous solution may be added to the sunflower seed 511 prior to conveyance into the comminuting equipment, or alternatively, while the sunflower seed 511 is being discharged from a seed bin or other seed storage containers into the comminuting equipment. As hereinbefore noted, the use of organic solvents during performance of the comminuting step 521 is avoided.

Continuing to refer to FIGS. 5A-5B, example process 500 may further comprise a separation step 530 during which the comminuted seed particle mixture is separated into a solid phase 531 and a liquid phase 532. Thus, separation step 530 yields two seed fractions. The separation step 530 may be carried out by changing the pH 523 of comminuted seed particle mixture 521 to a pH of from about 5 to about 6 and conveying the comminuted seed particle mixture 521 into equipment suitable for separating the comminuted seed particle mixture 521 based on density differentials. Suitable separation equipment includes for example, a centrifuge such as a two-phase decanter operated at modest gravitational forces to separate a light liquid phase 532 and a heavy solid phase 531 containing seed particle solids. The liquid phase 532 recovered after separation therefrom of the solid phase 531, contains the majority of the seed oil, and the separated solid phase 531 contains solid seed particulate material including for example, seed hull particles.

The recovered solid phase 531 may have a moisture content of from about 65% to about 75%, and a dry-basis composition of from about 33% (w/w) to about 50% (w/w) plant oil, from about 27% (w/w) to about 35% (w/w) protein, from about 1.0% (w/w) to about 2.5% (w/w) ash, and from about 25% (w/w) to about 35% (w/w) carbohydrate. Thus, for example, recovered solid phase 531 may have a moisture content of 70.5%, and a dry-basis composition of 41.6% (w/w) plant oil, 27.6% (w/w) protein, 2.2% (w/w) ash, and 27.8% (w/w) carbohydrate, or, for example, recovered solid phase 531 may have a moisture content of 68.3%, and a dry-basis composition of 34.0% (w/w) plant oil, 30.0% (w/w) protein, 2.0% (w/w) ash, and 33.9% (w/w) carbohydrate.

Continuing to refer to FIGS. 5A-5B, example process 500 may further comprise step 540 during which liquid phase 532 is separated into a light liquid phase 542 containing sunflower oleosomes and a heavy protein containing liquid phase 541. Step 540 may be achieved by changing the pH 533 of the liquid phase from about 5 to about 8 and conveying the pH adjusted liquid phase 535 into separation equipment capable of further separating the liquid phase 535 based on density differential, for example, a centrifuge. The recovered oleosome containing light liquid phase 542 may have a moisture content of from about 75% to about 85%, and a dry-basis composition of from about 79% (w/w) to about 86% (w/w) plant oil, from about 9% (w/w) to about 13% (w/w) protein, from about 1.0% (w/w) to about 2.5% (w/w) ash, and from about 0% (w/w) to about 8% (w/w) carbohydrate.

For clarity, recovered oleosome containing light liquid phase 542 corresponds with and is substantially the same as recovered oleosome containing light liquid phase 142 which can be obtained in the performance of process 100, and hence may be used in a similar manner as recovered oleosome containing light liquid phase 142. In this respect, it is noted that steps 111 to 142 in process 100 correspond with and are substantially the same as steps 511 to 542 in process 500.

Continuing to refer to FIGS. 5A-5B, example process 500 may further comprise step 550 comprising separating protein containing heavy phase 541 to obtain cream phase 551 and heavy phase 553, using for example a disc centrifuge. Cream phase 551 may have the following composition: 3% (w/w)-12% (w/w) oil, 0.5% (w/w)-4% (w/w) protein, 0.1% (w/w)-1% (w/w) ash, and 85% (w/w)-95% (w/w) moisture.

Continuing to refer to FIGS. 5A-5B, example process 500 may further comprise step 560 comprising adjusting the pH of remaining heavy phase 553 phase to pH 4.5 using an acid such as H₃PO₄, for example, to obtain pH adjusted heavy phase 561. The pH adjusted heavy phase 561 may then be further separated, for example by passing it through a clarifier centrifuge, such as, for example, a Westfalia, SA7-06 under a force of 11,800×g, to thereby separate 570 protein precipitate 571 from aqueous phase 573. The composition of corresponding protein precipitate 571 may be 4.3% (w/w) oil, 18.3% (w/w) protein, 0.9% (w/w) ash, and 73.1% (w/w) moisture. The corresponding aqueous phase 573 may have a composition of 1% (w/w)-12% (w/w) oil, 10% (w/w)-30% (w/w) protein, 0.2% (w/w)-2% (w/w) ash, and 60% (w/w)-80% (w/w) moisture.

Continuing to refer to FIGS. 5A-5C example process 500 may further comprise step 580 comprising diluting protein precipitate 571 with water, for example with 0.25 volume, 0.5 volume, 1 volume, or 2 volumes of RO water to obtain protein slurry 583. The pH of protein slurry 583 may then be adjusted 590 to a pH of approximately 7.0 using 50% NaOH to provide pH-adjusted protein slurry 593. Example process 500 further includes a step, comprising drying 595 pH-adjusted protein slurry 593 to provide dried protein concentrate 598. Dried protein concentrate 598 can have less than about 10% moisture, for example, about 10%, about 9%, about 8%, about 7%, about 6%, about 5%, about 4%, or about 3% moisture. Drying may be achieved using drying equipment such as, for example, a spray drier. Dried protein concentrate 598 may have the following composition on dry basis: about 49% (w/w) to about 90% (w/w) protein, from about 1% (w/w) to about 32% (w/w) oil, and from about 0% (w/w) to about 8% (w/w) ash. Dried protein concentrate 598 may have the following composition on dry basis: from about 50% (w/w) to about 80% (w/w) protein, from about 15% (w/w) to about 25% (w/w) oil, and from about 0% (w/w) to about 8% (w/w) ash, having a moisture content of less than about 10% (w/w). Dried protein concentrate 598 may have the following composition on dry basis: from about 65% (w/w) to about 80% (w/w) protein, from about 1% (w/w) to about 25% (w/w) oil, and from about 0% (w/w) to about 8% (w/w) ash, having a moisture content of less than about 10% (w/w). Dried protein concentrate 598 may have the following composition on dry basis: about 65% (w/w) protein, about 19% (w/w) oil, and about 5.5% (w/w) ash, having a moisture content of less than about 6% (w/w).

The phenolic content of spray dried protein concentrate 598 may be 0.6 mg GAE/gram dry weight of sample.

Turning next to another example process according to the present disclosure for preparing a sunflower protein concentrate and an oleosome containing fraction is example process 600. It is noted that the oleosome fraction obtained in the performance of process 600 is a sunflower oleosome preparation having from about 2% (w/w) to about 5% (w/w) protein on a dry basis (db).

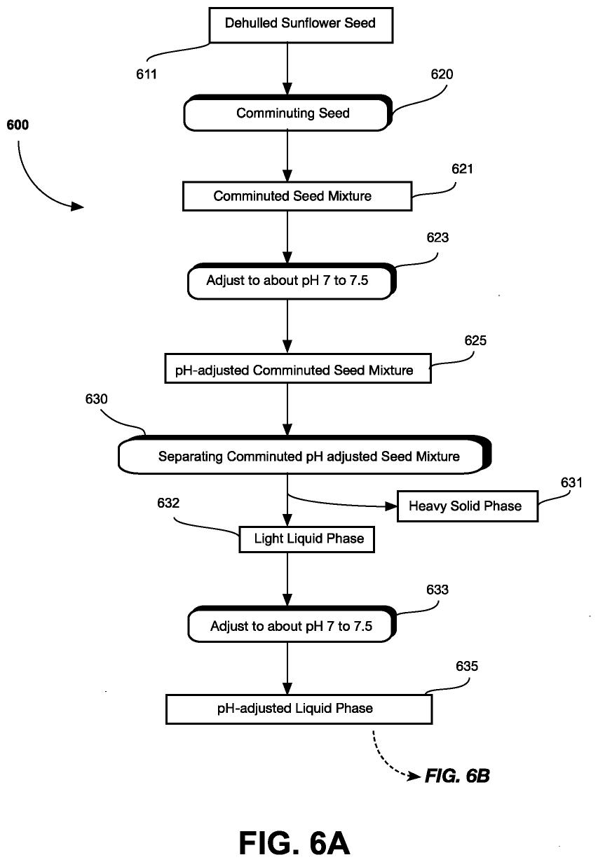

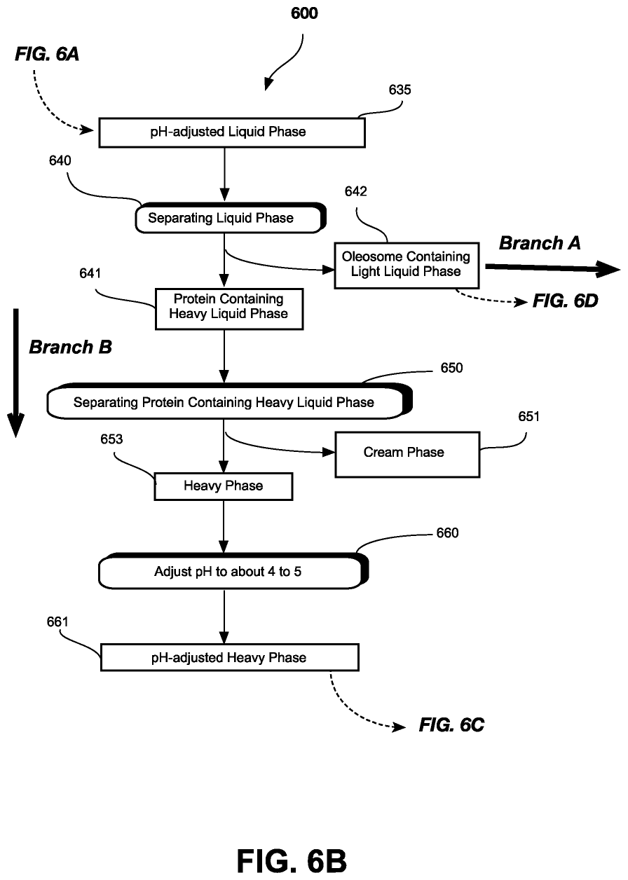

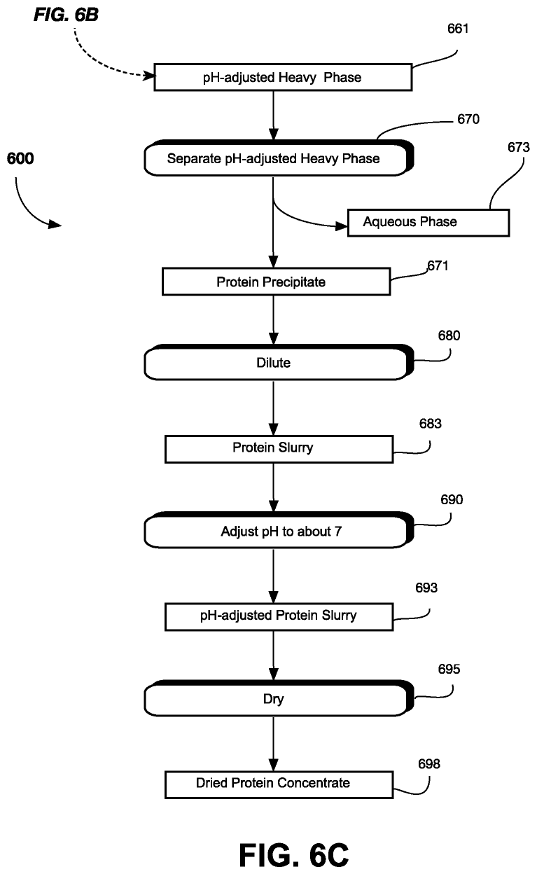

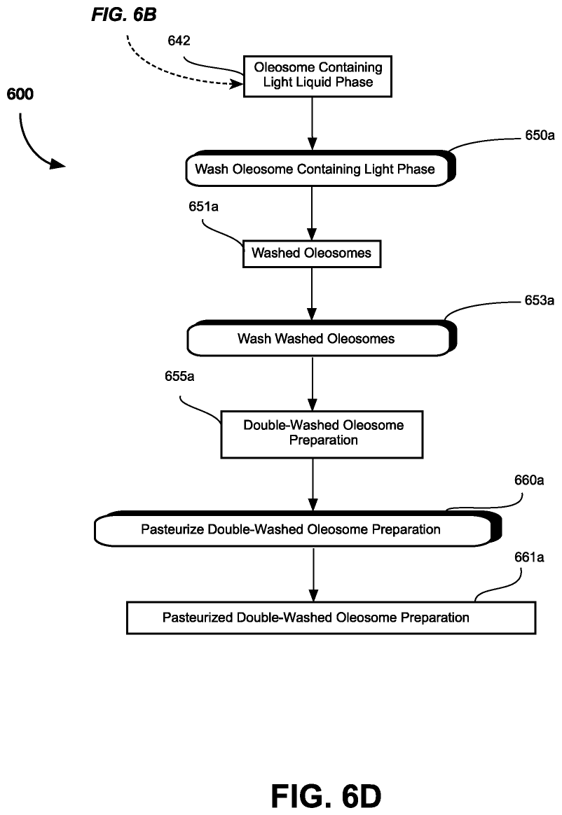

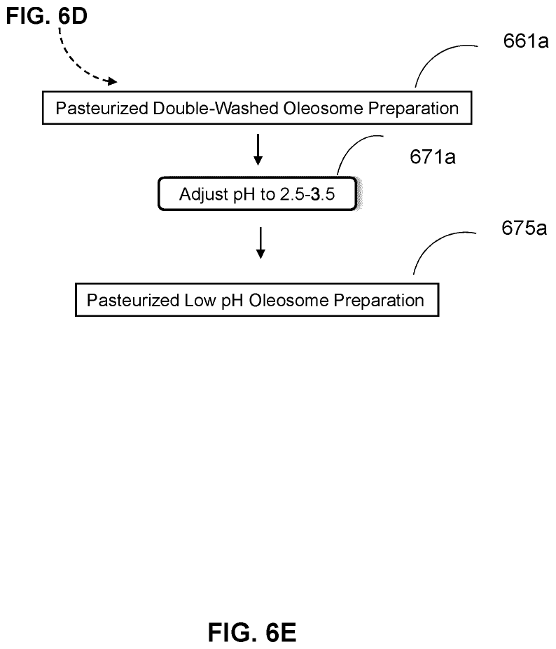

Referring to FIGS. 6A-6E, Example process 600 starts with providing a quantity of sunflower seeds, notably dehulled sunflower seeds 611. Sunflower seeds may be obtained, for example, by agriculturally producing and harvesting seed, and/or by purchasing of sunflower seed from a commercial seed supplier, and subsequently dehulled. Dehulling results in removal of the typically white colored, or black colored, or black and white colored seed hull which may also be referred to as the shell, and allows one to obtain dehulled sunflower seeds 611, also referred to in the art as kernels. Dehulling equipment for sunflower seed is known to those of skill in the art. Prior to dehulling the sunflower seeds may optionally be screened and cleaned, if necessary or so desired, to remove extraneous materials such as debris or non-intact seed material. Furthermore, prior to dehulling, the sunflower seeds may also optionally be washed or surface-sterilized using for example, a chemical agent such as bleach or heating including, infrared heating, to reduce contaminating biological agents such as bacteria or fungi that may be present on the seed hulls or on the seed surface. Furthermore, sunflower seeds, preferably dehulled sunflower seeds 611, may be soaked in water or in an aqueous solution.

Continuing to refer to FIGS. 6A-6E example process 600 further comprises comminuting step 620 wherein dehulled sunflower seeds 611 are comminuted whereby is produced a comminuted mixture of seed particles 621, preferably having mean particle sizes D[4,3] in a range of between about 5 μm and about 200 μm. Comminuting step 620 generally reduces the seed volume as well as the particle size of the comminuted seed. Step 620 may be carried out by conveying of dehulled sunflower seeds 611 into comminuting equipment such as a seed mill, a colloid mill, a hammer mill, a blade mill, a roller mill, and the like. In other embodiments, a homogenizer such as a high-pressure homogenizer, may be used to comminute of dehulled sunflower seed 611. In yet other embodiments, a sequential combination of a mill and a homogenizer or other such equipment may be used to comminute the seed 611.

It should be further noted that the selection of the specific comminuting equipment and the operating conditions of the equipment may depend on the size of the selected of sunflower seed 611. However, regardless of the comminuting equipment that is selected, upon completion of step 620, the comminuted seed particle mixture 621 will have mean particle sizes D[4,3] in a range of from about 5 μm to about 200 μm or from about 5 μm to about 100 μm, or mean particle sizes in a range of about 10 μm, about 25 μm, about 50 μm, about 100 μm, about 125 μm, about 150 μm, about 175 μm, about 200 μm, and therebetween. Preferably, the comminution equipment and conditions are selected so that the comminuted sunflower seed particles are homogenously sized, i.e., the particles can have tightly-centered mean particle size, e.g., at least 90% of the particles can have a size not exceeding ±20% of the particle size, or not exceeding ±10% of the particle size, or not exceeding ±5% of the mean particle size. Furthermore, it should be noted that high temperatures i.e., temperatures in excess of 60° C. are avoided in the performance of comminuting step 620. Thus, comminuting step 620 may be conducted at ambient temperatures although it is understood that during operation of mechanical comminution equipment, the temperature of the seed mixture may increase above the ambient temperatures.

Comminuting step 620 may be carried out with the dehulled sunflower seed 611 suspended in an aqueous solution. Examples of suitable aqueous solutions include water and dilute solutions comprising, for example, a sodium salt solution, such as NaCl, Na₂SO₄, or sodium hexametaphosphate, for example. The aqueous solution may be added to the sunflower seed 611 prior to conveyance into the comminuting equipment, or alternatively, while the sunflower seed 611 is being discharged from a seed bin or other seed storage containers into the comminuting equipment. As hereinbefore noted, the use of organic solvents during performance of the comminuting step 621 is avoided.

Continuing to refer to FIGS. 6A-6B, example process 600 may further comprise a separation step 630 during which the comminuted seed particle mixture is separated into a solid phase 631 and a liquid phase 632. Thus, separation step 630 yields two seed fractions. The separation step 630 may be carried out by changing the pH 623 of comminuted seed particle mixture 621 to a pH of from about 7 to about 7.5 and conveying the comminuted seed particle mixture 621 into equipment suitable for separating the comminuted seed particle mixture 621 based on density differentials. Suitable separation equipment includes for example, a centrifuge such as a two-phase decanter operated at modest gravitational forces to separate a light liquid phase 632 and a heavy solid phase 631 containing seed particle solids. The liquid phase 632 recovered after separation therefrom of the solid phase 631, contains the majority of the seed oil, and the separated solid phase 631 contains solid seed particulate material including for example, seed hull particles.

The recovered solid phase 631 may have a moisture content of about 83% (w/w), plant oil of about 5.0% (w/w), about 4.0% (w/w) protein, and about 0.9% (w/w) ash.

Continuing to refer to FIGS. 6A-6B, example process 600 may further comprise step 640 during which liquid phase 632 is separated into a light liquid phase 642 containing sunflower oleosomes and a heavy protein containing liquid phase 641. Step 640 may be achieved by detecting the pH of liquid phase 632 and changing the pH 633 of the liquid phase 632 to from about 7 to about 7.5, in the event the pH has drifted below about 7 or above about 7.5, which may occur in the performance of separation step 630. The pH adjusted liquid phase 635 may then be conveyed into separation equipment capable of further separating the pH adjusted liquid phase 635 based on density differential, for example, a centrifuge. The oleosome containing light liquid phase 642 recovered in in the performance of separation step 640 may have a moisture content of about 75% (w/w), about 19% (w/w) plant oil, about 3% (w/w) protein, and about 0.3% (w/w) ash. The recovered protein containing heavy liquid phase 641 may have moisture content of about 96% (w/w), about 0.5% (w/w) plant oil, about 3% (w/w) protein, and about 0.4% (w/w) ash.

Referring to FIG. 6B, it is noted that following the performance of step 640, process 600 proceeds along two separate branches, branches A and B. Branch A of process 600 starts with the oleosome containing light liquid phase 642, and is set forth in FIG. 6D. Branch B of process 600 starts with protein containing heavy liquid phase 641 and proceeds through FIG. 6B and FIG. 6C. Branch A of process 600 yields pasteurized double washed oleosome preparation 661a, while branch B yields dried protein extract 698. In what follows initially branch A of process 600 will be discussed, and thereafter branch B of process 600 will be discussed.

Referring next to FIG. 6D, example process 600 may further comprise step 650a comprising washing oleosomes to yield washed oleosomes 651a. This may be achieved by suspending the oleosome containing light liquid phase 642 in a suitable aqueous solution and conveying the resulting liquid phase into separation equipment capable of further separating the liquid phase based on density differential, for example, a centrifuge.

Example process 600 may further comprise step 655a comprising washing 653a washed oleosomes 651a to yield a double-washed oleosome preparation 655a. This may be achieved by suspending the washed oleosome phase 651a in a suitable aqueous solution and conveying the resulting liquid phase into separation equipment capable of further separating the liquid phase based on density differential, for example, a centrifuge. The recovered double-washed oleosome preparation may further optionally be pasteurized 660a to obtain pasteurized double-washed oleosome preparation 661a. Pasteurized double-washed oleosome preparation 661a may (i) contain from about 2% (w/w) to about 5% (w/w) protein on dry basis (db); (ii) have a dry weight of from 40% (w/w) or about 40% (w/w) to 70% (w/w) or about 70% (w/w), or from 55% (w/w) or about 55% (w/w) to 70% (w/w) or about 70%, or from 59% (w/w) or about 59% (w/w) to 70% (w/w) or about 70%; (iii) a lipid to protein ratio of from 10 or about 10 to 50 or about 50, or from 10 or about 10 to 30 or about 30, or from 10 to about 10 to 25 or about 25, or from 11.8 to about 11.8 to 23.6 or about 23.6 on a dry basis (db); and (iv) containing particles having a mean particle size D[4,3] of 2 μm or about 2 μm to 10 μm or about 10 μm, or 2.5 μm or about 2.5 μm to 10 μm or about 10 μm, or of 2.8 μm or about 2.8 μm to 10 μm or about 10 μm, or of 3 μm or about 3 μm to 9 μm or about 9 μm, or of 3.5 μm or about 3.5 μm to 8.5 μm or about 8.5 μm.

Furthermore, pasteurized double washed oleosome preparation 661a may have a dry weight of about 65% (w/w), a protein concentration of about 5% (w/w) on a dry basis, a lipid to protein ratio of about 18, and a mean particle size D[4,3] of 3.2 μm.

Referring to FIG. 6E, and still branch B of process 600, example process 600 may further comprise a step of adjusting 671a the pH of the pasteurized double-washed oleosome to a pH of from 2.5 or about 2.5 to 3.5 or about 3.5 to obtain a pasteurized low-pH oleosome preparation 675a.

Referring again now to FIG. 6B, and branch B of process 600, example process 600 may further comprise step 650 comprising separating protein containing heavy phase 641 to obtain cream phase 651 and heavy phase 653, using for example a disc centrifuge. Cream phase 651 may have the following composition: about 1% oil, 2.7 (w/w) protein, 0.4 (w/w) ash, and 95% (w/w) moisture.

Example process 600 may further comprise step 660 comprising adjusting the pH of remaining heavy phase 653 phase to from about pH 4 to about 4.5 using an acid such as H₃PO₄, for example, to obtain pH adjusted heavy phase 661. The pH adjusted heavy phase 661 may then be further separated, for example by passing it through a clarifier centrifuge, such as, for example, a Westfalia, SA7-06 under a force of 11,800×g, to thereby separate 670 protein precipitate 671 from aqueous phase 673. The composition of corresponding protein precipitate 671 may be about 0.8% (w/w) oil, about 20% (w/w) protein, about 1.25% (w/w) ash, and about 76% (w/w) moisture. The corresponding aqueous phase 673 may have a composition of about 0.05% (w/w) oil, 1% (w/w) (w/w) protein, 0.4 (w/w) ash, and 98% (w/w) moisture.

Continuing to refer to FIG. 6C example process 600 may further comprise step 680 comprising diluting protein precipitate 671 with water, for example with 0.25 volume, 0.5 volume, 1 volume, or 2 volumes of RO water to obtain protein slurry 683. The pH of protein slurry 683 may then be adjusted 690 to a pH of approximately 7.0 using 50% NaOH to provide pH-adjusted protein slurry 693. Example process 600 further includes a step, comprising drying 695 pH-adjusted protein slurry 693 to provide dried protein concentrate 698. Dried protein concentrate 698 can have less than about 10% moisture, for example, about 10%, about 9%, about 8%, about 7%, about 6%, about 5%, about 4%, or about 3% moisture. Drying may be achieved using drying equipment such as, for example, a spray drier. Dried protein concentrate 698 may have the following composition on dry basis: about 49% (w/w) to about 90% (w/w) protein, from about 1% (w/w) to about 32% (w/w) oil, and from about 0% (w/w) to about 8% (w/w) ash. Furthermore, the dried protein concentrate 698 may have the following composition on dry basis: about 87% (w/w) protein, 1% (w/w) oil, and 7.2% (w/w) ash. Furthermore, the dried protein concentrate 698 may have the following composition on dry basis: from about 70% (w/w) to about 90% (w/w) protein, from about 0.5% (w/w) to about 2% (w/w) oil, and from about 0% (w/w) to about 10% (w/w) ash, having a moisture content of less than about 10% (w/w). Furthermore, the dried protein concentrate 698 may have the following composition on dry basis: about 83% (w/w) protein, about 1% (w/w) oil, and about 7% (w/w) ash, having a moisture content of less than about 6% (w/w).

To briefly recap, the example processes 100, and 400 may each provide selectable sunflower oleosome preparations. The oleosome preparation of example process 100 includes a protein content of no more than 3% db. The oleosome preparation of example process 400 includes a protein content of at least 4% db. Furthermore, example processes 200 and 300 may performed to obtain further selectable oleosome preparations with a protein content of no more than 3% db. Example process 200 yields an oleosome preparation exhibiting a low pH, and example process 300 yields an oleosome preparation exhibiting an improved flavor profile. Example processes 500 and 600 may be performed to yield a sunflower protein concentrate and an oleosome containing fraction, and in the case of process 600, in particular, an oleosome preparation containing a protein content of from about 2% (w/w) to about 5% (w/w) on dry basis (db).

The sunflower oleosome preparations of the present disclosure may be prepared without exposing the starting selected sunflower plant materials to high temperatures or to solvents. Thus, the oleosomes remain intact, and retain their natural three-dimensional configurations. Furthermore, the sunflower oleosome preparations disclosed herein may be light colored, relatively odorless, and bland in taste.

According to one aspect, the present disclosure provides a sunflower oleosome preparation having a protein concentration of from about 2% (w/w) to about 5% (w/w) on a dry basis (db) and having a dry weight of from about 40% (w/w) to about 70% (w/w), a lipid to protein ratio of from about 10 to about 50 on a dry basis (db), and containing particles having a mean particle size D[4,3] of from about 2 μm to about 10 μm

According to one aspect, the present disclosure provides a low-protein sunflower oleosome preparation having a protein concentration of less than about 3% (w/w) on a dry basis (db), a dry weight of from about 20% (w/w) to about 80% (w/w), a lipid to protein ratio in excess of about 30 on a dry basis (db), and contain particles having a mean particle size D[4,3] of about 3 μm to about 20 μm.

According to one aspect, the present disclosure provides a high-protein sunflower oleosome preparation having a protein concentration of at least about 4% (w/w) on a dry basis (db), a dry weight of from about 40% (w/w) to about 70% (w/w), a lipid to protein ratio of from about 10 to about 30 on a dry basis (db), and contain particles having a mean particle size D[4,3] of about 3 μm to about 10 μm.

According to one aspect the oleosome preparations herein may each have a phenolics content of from about 0.1 mg to about 0.4 mg GAE/gram dry weight of sample.

According to some embodiments of the present disclosure, sunflower oleosome preparations produced by the processes described herein may be used as ingredients in nutritional formulations. In order to prepare the nutritional formulations, one or more of the sunflower oleosome preparations disclosed herein may be contacted with or blended with or mixed together with at least one other formulary ingredient suitable for use to prepare a nutritional product composition. Furthermore, at least one other formulary ingredient may be provided in any suitable form such as for example, a solution, a suspension, a gel, a liquid, a solid, a powder, a crystal, and the like. The quantity of the at least one other formulary ingredient may vary and may depend on the type of nutritional formulation that is being prepared. Furthermore, a plurality of additional formulary ingredients may be provided, for example 2, 3, 4, 5, 6, 7, 8, 9, 10 or more formulary ingredients to prepare the nutritional formulation.

According to some embodiments, a formulation suitable for inclusion in a nutritional product comprising a mixture of formulary ingredients may be pre-formed, and the oleosome preparation may be separately provided and incorporated into the pre-formed formulary ingredient mixture.

According to some embodiments, the sunflower oleosome preparation may be incorporated during preparation of the nutritional formulation. In such embodiments, the sunflower oleosome preparation may be added separately or alternatively, the sunflower oleosome preparation may be incorporated together with one or more other formulary compounds.

The final concentration of the sunflower oleosome preparation in the nutritional product may vary. In some embodiments, the sunflower oleosome preparation may comprise at least about 2% of the nutritional formulation, at least about 5% of the nutritional formulation, or at least about 10% (w/w) of the nutritional formulation. In other embodiments, the sunflower oleosome preparation may comprise at least about 20% (w/w), at least about 30% (w/w), at least about 40% (w/w), at least about 50% (w/w), at least about 60% (w/w), at least about 70% (w/w), at least about 80% (w/w), or at least about 90% (w/w) of the nutritional formulation. The concentration of the sunflower oleosome preparation may be optimized or adjusted by preparing a plurality of sample nutritional formulations, wherein each formulation comprises a different concentration of the sunflower oleosome preparation, then evaluating each of the formulations with reference to one or more nutritional effects, then selecting one or more of the formulations to provide a selected desirable effect.

According to some embodiments, the additional formulary ingredient may be a preservative agent, notably a preservative agent suitable for inclusion in nutritional formulations, such as for example sugars and sugar alcohols such as sorbitol, food-grade acids such as benzoic acid, nisin and sodium dehydroacetate. In general preservative agents are included in nutritional formulations in small quantities, for example less than about 5% (w/w), 4% (w/w), 3% (w/w), 2% (w/w), or 1% (w/w).

According to some embodiments, the additional formulary ingredient incorporated in the nutritional formulations of the present disclosure may be a natural ingredient. Since the sunflower oleosome preparations disclosed herein are natural compositions, in some embodiments, the nutritional formulations may be formulated using additional natural formulary ingredients thereby providing one or more natural nutritional formulations.

According to some embodiments, the formulary ingredient may be a protein concentrate prepared in accordance herewith.

According to some embodiments, the additional formulary ingredient may be synthetic ingredients for example stabilizing agents, such as xanthan and gellan gums, for example; coagulating agents, such as calcium sulfate and magnesium chloride, for example; cross-linking enzymes; and agglomerating agents, such as hydrolyzed lecithin, for example.

According to some embodiments, the sunflower oleosome preparations disclosed herein may be suitable for human consumption, and hence may be included in human nutritional formulations.

According to some embodiments, the nutritional formulations may be a plant based milk, for example a barista milk, or a hemp nut milk; a plant-based cheese, for example, a paneer cheese or a vegan cheese; a plant-based alternative meat product; a yoghurt; an egg replacement product, a salad dressing; a baking product, for example a cup cake; an ice-cream; or a frozen desert.

According to some embodiments, the nutritional formulation can be prepared by extrusion using a food forming extruder. Sunflower oleosome preparations of the present disclosure are blended with at least one formulary ingredient. Blending of the selected oleosome preparation with the at least one formulary ingredient may be performed prior to extrusion to prepare a feedstock blend of the oleosome preparation and the at least one formulary ingredient. The feedstock blend can then be fed to a feedstock receptacle of a feedstock extruder. Alternatively, the at least one formulary ingredient and the oleosome formulation may be more or less simultaneously, and as separate feedstocks be conveyed to the feedstock receptacle of a food forming extruder.

According to one aspect, the extruded nutritional formulation can be a plant-based alternative meat product prepared by extrusion. An example method for preparing an extruded alternative meat product is hereinafter described in Example 24.

It will be understood by those of skill in the art that the formulation techniques may vary widely depending on the nutritional formulation which is prepared using the sunflower oleosome or protein preparations of the present disclosure. In particular, for example, the selected additional formulation ingredients, the formulation conditions, such as temperature, the ingredient mixing conditions, formulation time, and so forth may vary substantially. In order to provide further guidance to those of skill in the art, the instant patent specification includes in the Examples section included herein detailed examples for the preparation of multiple nutritional formulations.

In accordance with the foregoing, the present disclosure provides another embodiment relating to methods for preparing nutritional formulations comprising the oleosome preparations disclosed herein, wherein the methods comprise:
(i) providing a sunflower oleosome preparation of the present disclosure;
(ii) providing a formulary ingredient suitable for inclusion in a nutritional formulation; and
(iii) blending together the sunflower oleosome preparation with the formulary ingredient to form a nutritional formulation comprising the sunflower oleosome preparation.

According to some embodiments, the present disclosure relates to use of one or more oleosome preparations disclosed herein as an ingredient for preparing a nutritional formulation.

According to some embodiments, the present disclosure relates to a nutritional formulation comprising one or more oleosome preparations as disclosed herein, and a formulary ingredient suitable for inclusion in a nutritional formulation.

In yet another aspect, the embodiments of the present disclosure generally relate to methods of making coated oleosome preparations.

One embodiment disclosed herein relates to methods of preparing a coated oleosome preparation, the methods comprising:
(i) providing a sunflower oleosome preparation as disclosed herein;
(ii) providing a phospholipid or a polysaccharide; and
(iii) treating the oleosome preparation to obtain a coated oleosome preparation wherein the exterior surface of the oleosome is substantially coated with the phospholipid or the polysaccharide to obtain a coated oleosome preparation.

According to one aspect, the phospholipid is a lecithin.

According to one aspect, the polysaccharide is a gum.

According to one aspect, the gum is xanthan gum or gellan gum.

Hereinafter are provided examples of further specific embodiments for performing the methods of the present disclosure, as well as embodiments representing the compositions of the present disclosure.

### EXAMPLES

### Example 1.a.—Making a Low-Protein Oleosome Preparation from Sunflower Seeds

Referring to FIGS. 1A-1B, and example process 100 illustrated therein, a total of 80.04 kg of dehulled sunflower seed (Helianthus annuus) 111 was poured through the hopper of a hammer mill (Fitzpatrick Hammer mill with 0.125″ screen) using a coil auger at an average rate of 65 rpm together with 544.3 L of reverse osmosis (RO) water supplied through an externally connected hose prior to milling to comminute 120 the dehulled sunflower seed 111. The resulting slurry was pumped to serial mills in the following order: colloid mill (MZ-130, Fryma, Romaco Inc., Pompton Plains, NJ, USA), a second colloid mill with smallest gap setting (MZ-130, Fryma, Romaco Inc., Pompton Plains, NJ, USA), and a third colloid mill with smallest gap setting (IKA MK 2000/10, IKA Works Inc., Wilmington, NC, USA). Thereafter, the slurry was passed through an in-line homogenizer operating at 4,200 rpm (IKA DISPAX-Reactor DR 2000/10, IKA Works Inc., Wilmington, NC, USA), yielding comminuted seed mixture 121. After milling, comminuted seed mixture 121 was collected in a tank while maintaining constant mixing. The pH of comminuted seed mixture 121 was adjusted 123 and decreased to 5.0 using 85% (w/w) H₃PO₄, and then the pH-adjusted comminuted seed mixture 125 was conveyed to a decanter (Alfa Laval NX-912) operating at 3,000×g with a flow rate of 10 L/min to separate 130 liquid phase 132 from solid phase 131. The liquid phase 132 was collected in a tank and, using 50% NaOH, its pH was adjusted 133 and increased to pH 8.2 to yield pH-adjusted liquid phase 135, and pumped to a disc-stack centrifuge (SA20-01-076, Westfalia, Oelde, Germany) with a feed rate of 9-9.5 L/min to separate 140 pH-adjusted liquid phase 135 into three fractions. The resulting three fractions were: oleosome containing light liquid phase 142, protein containing heavy liquid phase 141, and precipitated solids (not shown in FIG. 1B). The light liquid phase 142 was collected in a tank and washed 150 by mixing the light liquid phase 142 with 1 part RO water, and passing the obtained mixture through a second disc-stack centrifuge at 7,800 rpm (SA20-01-076, GEA Westfalia, Oelde, Germany) to yield a separated light phase (washed oleosomes 151) flow of 0.8-1.3 L/min. The washed oleosomes 151 were collected in a tank and washed again 153 by mixing washed oleosomes 151 with 1 part RO water and passing the obtained mixture through a third disc centrifuge at 7,800 rpm (SA20-01-076, Westfalia, Oelde, Germany) with a light phase flow of 1.6-1.9 L/min to obtain 17.9 kg of double-washed oleosome preparation 155 (also referred to as LP3 fraction). The bioburden from the LP3 fraction 155 was addressed by heating 160 at 85° C. for 20 s (using a heat exchanger, M3-FG, Alfa Laval) to yield pasteurized double-washed oleosome preparation 161. Double-washed oleosome preparation 155 and pasteurized double-washed oleosome preparation 161 are each low-protein oleosome preparations (1.1% db) (see: Table 1a). The compositional analysis of pasteurized double-washed oleosome preparation 161 was performed using accredited testing methodologies, whereas the average particle size D[4,3] was measured on a Mastersizer 2000 (Malvern Panalytical) according to the following internal standard operating procedure. In duplicate, 50 μL of pasteurized double-washed oleosome preparation 161 was dispersed in 4 mL of a 25 mM aqueous solution of NaHCO₃. The dispersion was added to the Mastersizer sampling chamber containing a 25 mM aqueous solution of NaHCO₃ until the obscuration measured between 9% and 13%. The particle size was acquired using a refractive index of 1.59, whereas the dispersant's refractive index (water) was set at 1.33. The particle size measurements were acquired, in duplicate, with stirring at 3,500 rpm using 15,000 measurement snaps over the course of 15 seconds and the result was expressed relative to the background measurement which was similarly acquired using 15,000 background snaps over the course of 15 seconds.

TABLE 1a
Compositional data of low-protein oleosomes.

| | | | | | | Average |
|---|---|---|---|---|---|---|
| | Dry weight | | Protein | Oil | Ash | particle size |
| Sample | (%) | Lipid/Protein | (%, db) | (%, db) | (%, db) | D[4, 3] (μm) |
| 161 | 74.3 | 86.2 | 1.1 | 96.3 | 0.05 | 4.964 |

### Example 1.b.—Making Another Low-Protein Oleosome Preparation from Sunflower Seeds

Referring to FIGS. 1A-1B, and example process 100 illustrated therein, a total of 90.7 kg of dehulled sunflower seed (Helianthus annuus) 111 was poured through the hopper of a hammer mill (Fitzpatrick Hammer mill with 0.125″ screen) using a coil auger at an average rate of 65 rpm together with 616.9 L of reverse osmosis (RO) water supplied through an externally connected hose prior to milling to comminute 120 the dehulled sunflower seed 111. The resulting slurry was pumped to serial mills in the following order: colloid mill (MZ-130, Fryma, Romaco Inc., Pompton Plains, NJ, USA), a second colloid mill with smallest gap setting (MZ-130, Fryma, Romaco Inc., Pompton Plains, NJ, USA), and a third colloid mill with smallest gap setting (IKA MK 2000/10, IKA Works Inc., Wilmington, NC, USA). Thereafter, the slurry was passed through an in-line homogenizer operating at 4,200 rpm (IKA DISPAX-Reactor DR 2000/10, IKA Works Inc., Wilmington, NC, USA), yielding comminuted seed mixture 121. After milling, comminuted seed mixture 121 was collected in a tank while maintaining constant mixing. The pH of comminuted seed mixture 121 was adjusted 123 and decreased to 5.0 using 85% (w/w) H₃PO₄, and then the pH-adjusted comminuted seed mixture 125 was conveyed to a decanter (Alfa Laval NX-912) operating at 3,000×g with a flow rate of 10 L/min to separate 130 liquid phase 132 from solid phase 131. The liquid phase 132 was collected in a tank and, using 50% NaOH, its pH was adjusted 133 to pH 8.2 to yield pH-adjusted liquid phase 135, and pumped to a disc-stack centrifuge (SA20-01-076, Westfalia, Oelde, Germany) with a feed rate of 9-9.5 L/min to separate 140 pH-adjusted liquid phase 135 into three fractions. The resulting three fractions were: oleosome containing light liquid phase 142, protein containing heavy liquid phase 141, and precipitated solids (not shown in FIG. 1B). The light liquid phase 142 was then washed 150 by passing it through a static inline mixer and diluted with RO water (3 L/min) into a second disc-stack centrifuge at 7,800 rpm (SA20-01-076, GEA Westfalia, Oelde, Germany) to yield a separated light phase (washed oleosomes 151) flow of 1.5-2.4 L/min. The washed oleosomes 151 were collected in a tank and washed again 153 by mixing washed oleosomes 151 with 1 part RO water and passing the obtained mixture through a third disc centrifuge at 7,800 rpm (SA20-01-076, Westfalia, Oelde, Germany) with a light phase flow of 1.6-1.9 L/min to obtain 28.9 kg of double-washed low-protein oleosome composition 155 (also referred to as LP3 fraction). The bioburden from the LP3 fraction 155 was addressed by heating 160 at 85° C. for 20 seconds (using a heat exchanger, M3-FG, Alfa Laval) to yield pasteurized double-washed low-protein oleosome preparation 161. Double-washed low-protein oleosome composition 155 and pasteurized double-washed oleosome composition 161 are each low-protein oleosome preparations (2.96% db) (see: Table 1b). The CIELAB color values of double-washed low-protein oleosome composition 155 were determined as L*=56.87, a*=−0.18, b*=2.49. The phenolic content (gallic acid equivalents (GAE)) of double-washed low protein oleosome samples was determined at 750 nm after the extraction of phenolic compounds. The phenolic compounds were extracted from sunflower oleosome samples using liquid extraction methods as mentioned by Pedrosa et al. (2000) and Tasioula-Margari & Tsabolatidou (2015) with slight modifications. Briefly, 1 g of the sample was placed in a glass tube, followed by 5 mL of 80% (v/v) ethanol and 5 mL of hexane. After vortexing for 1 min and centrifuging at 4000 rpm for 5 min, the hexane phase was discarded. The remaining phase was collected, and the extraction process was repeated with 5 mL of 80% (v/v) ethanol. Following the second centrifuge step, the collected ethanolic phase was filtered using Whatman 4 filter paper. The resulting ethanolic extract was then concentrated under a nitrogen flow at 40° C. The volume of phenolic extracts was adjusted to 5 ml using 80% (v/v) ethanol. The total phenolic content of the phenolic extracts was analysed using the method of Velioglu et al. (1998) at 750 nm. Briefly, 100 μL of the phenolic extract was added to a glass tube. Subsequently, 0.75 mL of Folin Ciocalteu reagent (1:10 v/v diluted with distilled water) was added to the tube. After a waiting period of 5 minutes, 0.75 mL of sodium bicarbonate solution (6% w/w) was added to the tube and incubated for 60 minutes at room temperature. The absorptions of the samples were measured at 750 nm using UV/Visible Spectrophotometer (VWR UV-1600PC, VWR International, San Francisco, CA) against a blank sample. The blank sample included 100 μL of 80% (v/v) ethanol instead of phenolic extract. The calibration curve was prepared using gallic acid as a standard at different concentrations (0.01-0.4 mg/mL). The total phenolic content results were given as gallic acid equivalents (GAE).

References: (1) Pedrosa M. M., Muzquiz, M., García-Vallejo, C., Burbano, C., Cuadrado, C., Ayet, G., & Robredo, L. M. (2000). Determination of caffeic and chlorogenic acids and their derivatives in different sunflower seeds. Journal of the Science of Food and Agriculture, 80(4), 459-464; (2) Tasioula-Margari, M., & Tsabolatidou, E. (2015). Extraction, separation, and identification of phenolic compounds in virgin olive oil by HPLC-DAD and HPLC-MS. Antioxidants, 4(3), 548-562; and (3) Velioglu, Y., Mazza, G., Gao, L., & Oomah, B. D. (1998). Antioxidant activity and total phenolics in selected fruits, vegetables, and grain products. Journal of agricultural and food chemistry, 46(10), 4113-4117.

TABLE 1b
Compositional data of low-protein oleosomes.

| | | | | | | Total phenolic | Average |
|---|---|---|---|---|---|---|---|
| | | | | | | (mg GAE/gram | particle |
| | Dry weight | Protein/ | Protein | Oil | Ash | dry weight of | size |
| Sample | (%) | Lipid | (%, db) | (%, db) | (%, db) | sample) | D[4, 3](μm) |
| 161 | 68.8 | 30.5 | 2.96 | 90.58 | 1.01 | 0.22 | 8.818 |

### Example 1.c.—Making a Low-pH Low-Protein Oleosome Preparation from Sunflower Seeds

Referring to FIGS. 2A-2C, and example process 200 illustrated therein, a total of 90.7 kg of dehulled sunflower seed (Helianthus annuus) (211) was poured through the hopper of a hammer mill (Fitzpatrick Hammer mill with 0.125″ screen) using a coil auger at an average rate of 65 rpm together with 616.9 L of reverse osmosis (RO) water supplied through an externally connected hose prior to milling to comminute the dehulled seed 220. The resulting slurry was pumped to the serial mills in the following order: colloid mill (MZ-130, Fryma, Romaco Inc., Pompton Plains, NJ, USA), a second colloid mill with smallest gap setting (MZ-130, Fryma, Romaco Inc., Pompton Plains, NJ, USA), and a third colloid mill with smallest gap setting (IKA MK 2000/10, IKA Works Inc., Wilmington, NC, USA). Thereafter, the slurry was passed through an in-line homogenizer operating at 4,200 rpm (IKA DISPAX-Reactor DR 2000/10, IKA Works Inc., Wilmington, NC, USA), yielding comminuted seed mixture 221. After milling, comminuted seed mixture 221 was collected in a tank while maintaining constant mixing. The pH of the slurry was adjusted 223 and decreased to pH 5.0 using 85% (w/w) H₃PO₄, and then the pH-adjusted comminuted slurry 225 was conveyed to a decanter (Alfa Laval NX-912) operating at 3,000×g with a flow rate of 10 L/min to separate 230 liquid phase 232 from solid phase 231. The liquid phase 232 was collected in a tank and its pH was adjusted 233, using 50% NaOH, to pH 8.2 to yield pH-adjusted liquid phase 235 and separated 240 by conveying it to a disc-stack centrifuge (SA20-01-076, Westfalia, Oelde, Germany) with a feed rate of 9-9.5 L/min. The resulting three fractions were oleosome containing light liquid phase 242, protein containing heavy liquid phase 241, and precipitated solids (not shown in FIG. 2B). The light liquid phase 242 was then washed 250 by passing it through a static inline mixer and diluted with RO water (3 L/min) into a second disc-stack centrifuge at 7,800 rpm (SA20-01-076, GEA Westfalia, Oelde, Germany) to yield a separated light phase (washed oleosomes 251) flow of 1.5-2.4 L/min. The washed oleosomes 251 were collected in a tank and washed again 253) by mixing washed oleosomes 251 with 1 part RO water and passing the obtained mixture through a third disc centrifuge at 7,800 rpm (SA20-01-076, Westfalia, Oelde, Germany) with a light phase flow of 1.6-1.9 L/min, resulting in 28.9 kg of double-washed low-protein oleosome preparation 255 (also referred to as LP3 fraction). In order to increase the microbial stability of oleosomes low-protein oleosomes were acidified to pH 3.0. Double-washed low-protein oleosome preparation 255 was diluted 261 to approximately 50% dry weight using RO water in a tank to yield diluted double-washed low-protein oleosome preparation 263, and then its pH was adjusted 271 to decrease rapidly from 8.2 to pH 3.0 using 85% H₃PO₄ while maintaining constant mixing. The resulting low-pH low-protein oleosome preparation 275 was further pasteurized at 85° C. 281 for 20 s to yield pasteurized low-pH low-protein oleosome preparation 285. Various constituents of pasteurized low-pH low-protein oleosome preparation 285 were assayed (see: Table 7). The microbial stability of pasteurized low-pH low-protein oleosome preparation 285 was further investigated at room temperature (25° C.) and at 40° C. in an incubation chamber (Table 3). Pasteurized low-pH low-protein oleosome preparation 285 was physically stable over 28 days at two different storage temperatures (25° C. and 40° C.), as determined by particle size.

TABLE 2
Compositional data of pasteurized low-pH
low-protein oleosome preparation 285.

| | | | | | | Average |
|---|---|---|---|---|---|---|
| | Dry | | | | | particle size |
| | weight | Lipid/ | Protein | Oil | Ash | D[4,3] |
| Sample | (%) | Protein | (%, db) | (%, db) | (%, db) | μm |
| Acidic | 52.93 | 50.4 | 1.86 | 94.20 | 0.46 | 10.651 |
| oleosome | | | | | | |
| 285 | | | | | | |

TABLE 3
Microbial stability of pasteurized low-pH low-protein oleosome
preparation 285 at 25° C. and 40° C.

| Time | Storage | | | | | | | |
|---|---|---|---|---|---|---|---|---|
| (Day) | Temperature | ph | TSA-A | TSA-B | MRSA-A | MRSA-B | SDA-A | SDA-A |
| T = Day 0 | — | 3.00 | 0 | 0 | 0 | 0 | 1 | 0 |
| T = Day 7 | 25° C. | 2.86 | 0 | 0 | 0 | 0 | 8 | 0 |
| | 40° C. | 2.94 | 0 | 1 | 0 | 0 | 2 | 0 |
| T = Day 14 | 25° C. | 3.3 | 0 | 0 | 0 | 0 | 0 | 0 |
| | 40° C. | 3.31 | 0 | 0 | 0 | 0 | 0 | 0 |
| T = Day 28 | 25° C. | 3.26 | 0 | 0 | 0 | 0 | 0 | 0 |
| | 40° C. | 3.29 | 0 | 0 | 0 | 0 | 0 | 2 |

TSA = tryptic soy agar; MRSA = methicillin-resistant Streptococcus aureus; SDA = sabourad dextrose agar.

### Example 1.d. —Making a Low-Protein Oleosome Preparation with Improved Colour from Sunflower Seeds

Referring to FIGS. 1A-1B, and to example process 100 illustrated therein, a total of 68.04 kg of dehulled sunflower seed (Helianthus annuus) (111) was conveyed to the hopper of a hammer mill (Fitzpatrick Hammer mill with 0.125″ screen) using a coil auger at an average rate of 65 rpm together with 462.7 L of reverse osmosis (RO) water supplied through an externally connected hose prior to milling to comminute 120 dehulled seed 111. The resulting slurry was pumped into serial mills in the following order: colloid mill (MZ-130, Fryma, Romaco Inc., Pompton Plains, NJ, USA), a second colloid mill with smallest gap setting (MZ-130, Fryma, Romaco Inc., Pompton Plains, NJ, USA), and a third colloid mill with smallest gap setting (IKA MK 2000/10, IKA Works Inc., Wilmington, NC, USA). Finally, the slurry passed through the in-line homogenizer operating at 4,200 rpm (IKA DISPAX-Reactor DR 2000/10, IKA Works Inc., Wilmington, NC, USA) to yield comminuted seed mixture 121. After milling, comminuted seed mixture 121 was collected in a tank while maintaining constant mixing. The pH of the slurry was adjusted 123 and decreased to 5.0 using 595 g of ascorbic acid and 486 ml of 75% (w/w) H₃PO₄ to yield pH-adjusted comminuted seed mixture 125 and then pH-adjusted comminuted seed mixture 125 was conveyed to a decanter (Alfa Laval NX-912) operating at 3,000×g with a flow rate of 10 L/min to separate 130 liquid phase 132 from solid phase 131. The light liquid phase 132 was collected in a tank and its pH was adjusted 133 to pH 8.2 using 50% (w/w) NaOH and yield pH-adjusted liquid phase 135, which was conveyed to a disc-stack centrifuge (SA20-01-076, Westfalia, Oelde, Germany) with a feed rate of 9-9.5 L/min to separate 140 into three fractions. The resulting three fractions were oleosome containing light liquid phase 142, protein containing heavy liquid phase 141, and precipitated solids (not shown in FIG. 1B). Light phase 142 was then washed 150 by passing it through a static inline mixer and diluted with RO water (3 L/min) into a second disc-stack centrifuge at 7,800 rpm (SA20-01-076, GEA Westfalia, Oelde, Germany) to yield a separated light phase (washed oleosomes 151) flow of 1.0-2.4 L/min. The washed oleosomes 151 were collected in a tank and mixed with 1 part RO water to wash 153 washed oleosomes 151. The water-oleosome mixture was passed through a third disc-stack centrifuge 7,800 rpm (SA20-01-076, Westfalia, Oelde, Germany) with a light phase flow of 0.8-1.4 L/min 21.2 kg to yield double-washed low-protein oleosome preparation 155 (also referred to as LP3). LP3 was further pasteurized 160 at 85° C. for 20 s to provide pasteurized double-washed oleosome preparation 161. Various constituents of pasteurized double-washed low-protein oleosome preparation 161 were assayed (see: Table 4). CIELAB color values were determined in 161 as L*=55.28, a*=0.05, b*=3.17. A value of a*>0 signifies the substantial absence of the color green in the preparation.

TABLE 4
Compositional data of oleosomes with improved color.

| | | | | | | Total phenolic | Average |
|---|---|---|---|---|---|---|---|
| | Dry | | | | | (mg GAE/gram | particle size |
| | weight | Lipid/ | Protein | Oil | Ash | dry weight | D[4,3] |
| Sample | (%) | Protein | (%, db) | (%, db) | (%, db) | of sample) | (μm) |
| 161 | 73.4 | 77.3 | 1.28 | 99 | <0.01 | 0.18 | 14.182 |

### Example 1.e.—Making a Low-Protein Clean-Tasting Oleosome Preparation from Sunflower Seeds

Referring to FIGS. 3A-3B, and to example process 300 illustrated therein, a total of 90.7 kg of dehulled sunflower seed (Helianthus annuus) 311, which had 7.9% neutral detergent fiber, 6.3% acid detergent fiber, 3.7% lignin and 0.15 mg/g chlorogenic acid, was washed 315 with 181.4 L of RO water in a tank while mixing at 50° C. for 10 min. The seed was pumped to a round separator (SWECO, Florence, KY, USA) to discard excess water and obtain washed dehulled seed 317, which had 6.9% neutral detergent fiber, 4.9% acid detergent fiber, 2.6% lignin and 0.10 mg/g chlorogenic acid. Washed dehulled seed 317 was conveyed to the hopper of a hammer mill (Fitzpatrick Hammer mill with 0.125″ screen) using a coil auger at an average rate of 65 rpm together with 435.36 L of RO water supplied through an externally connected hose prior to milling to comminute 320 washed dehulled seeds 317. The resulting slurry was pumped through sequential colloid mills wherein the first one was Fryma MZ-130 (Romaco Inc., Pompton Plains, NJ, USA) and the second one was IKA MK 2000/10 with smallest gap setting (IKA Works Inc., Wilmington, NC, USA). Then, the slurry was passed through an in-line homogenizer operating at 4200 rpm (IKA DISPAX-Reactor DR 2000/10, IKA Works Inc., Wilmington, NC, USA), to yield comminuted seed mixture 321. After milling, comminuted seed mixture 321 was collected in a tank while maintaining constant mixing. The pH of comminuted seed mixture 321 was adjusted 323 and decreased to 5.0 using 226.75 g of ascorbic acid and 850 mL of 75% H₃PO₄ to provide pH-adjusted comminuted seed mixture 325 and then the pH-adjusted comminuted seed mixture 325 was conveyed to a decanter (Alfa Laval NX-912) operating at 3,000×g with a flow rate of 10 L/min to separate 330 liquid phase 332 from solid phase 331. The liquid phase 332 was collected in a tank and its pH was adjusted 333 to pH 8.2 using 50% NaOH to yield pH-adjusted liquid phase 335 and thereafter pumped to a disc-stack centrifuge (SA20-01-076, Westfalia, Oelde, Germany) with a feed rate of 9-9.5 L/min to separate 340 into three fractions. The resulting three fractions were oleosome containing light liquid phase 342, protein containing heavy liquid phase 341, and precipitated solids (not shown in FIG. 3B). Light phase 342 was then washed 350 by passing it through a static inline mixer and diluted with 1:1 RO water (3 L/min) into a second disc-stack centrifuge at 7,800 rpm (SA20-01-076, GEA Westfalia, Oelde, Germany) to yield a separated light phase (washed oleosomes 351) flow of 1.2-2.3 L/min. The washed oleosomes 351 were collected in a tank and mixed with 1 part RO water to wash 353 washed oleosomes 351. The water-oleosome mixture was passed through a third disc-stack centrifuge at 7,800 rpm (SA20-01-076, Westfalia, Oelde, Germany) with a light phase flow of 0.4-1.6 L/min and resulted in 18.5 kg of double-washed oleosomes 355. The resulting double-washed low-protein oleosomes 355 were further pasteurized 360 at 85° C. for 20 s to provide pasteurized double-washed low-protein oleosome preparation 361. Various constituents of pasteurized double-washed low-protein oleosome preparation 361 were assayed (see: Table 5). CIELAB color values were determined in 361 as L*=55.27, a*=0.12, b*=2.93. Individual phenolic acids were not determined in pasteurized double-washed low-protein oleosome preparation 361, when analyzed by HPLC.

TABLE 5
Compositional data of clean tasting oleosome preparation 361.

| | | | | | | Average |
|---|---|---|---|---|---|---|
| | Dry | | | | | particle size |
| | weight | Lipid/ | Protein | Oil | Ash | D[4,3] |
| Sample | (%) | Protein | (%, db) | (%, db) | (%, db) | (μm) |
| 361 | 67.72 | 41.5 | 2.31 | 96.24 | 0.07 | 3.478 |

The sensory profile of low-protein oleosome preparation 161 (example process 100; Example 1.a) and clean taste low-protein oleosome preparation 361 from this Example 1.d (example process 300) was compared based on the following attributes creaminess, nuttiness, aftertaste, bitterness, and rancidity. The attributes were identified as follows; creaminess: the way food feels in the mouth in relation to its viscosity, nuttiness: the nut-like aromatic associated with different nuts, aftertaste: the taste perceived at the back of the throat after swallowing, bitterness: the taste simulated by substances such as quinine, caffeine, and hop bitters, rancidity: a stale, unpleasant aroma or flavour, often produced by oxidized oils. And the attributes were evaluated by semi-trained panelists according to the hedonic scale from 0 to 10 with increasing attribute properties. The results are shown in Table 6.

TABLE 6
Sensory profile data of low-protein (LPO) preparation 161 and clean
tasting (CT) oleosome preparation 361 according to 6 panelists.

| Attributes | LPO 161 | CT 361 |
|---|---|---|
| Creaminess | 7.6 | 8.0 |
| Nuttiness | 3.0 | 1.9 |
| Aftertaste | 4.2 | 2.2 |
| Bitterness | 1.2 | 0.5 |
| Rancidity | 0.2 | 0.0 |

### Example 1.f.—Making a First Sunflower Protein Concentrate and a Sunflower Oleosome Containing Fraction

Referring to FIGS. 5A-5C, and example process 500 illustrated therein, a total of 90.7 kg of dehulled sunflower seed (Helianthus annuus) 511 was poured through the hopper of a hammer mill (Fitzpatrick Hammer mill with 0.125″ screen) using a coil auger at an average rate of 65 rpm together with 616.9 L of reverse osmosis (RO) water supplied through an externally connected hose prior to milling to comminute 520 the dehulled seed 511. The resulting slurry was pumped to the serial mills in the following order: colloid mill (MZ-130, Fryma, Romaco Inc., Pompton Plains, NJ, USA), a second colloid mill with smallest gap setting (MZ-130, Fryma, Romaco Inc., Pompton Plains, NJ, USA), and a third colloid mill with smallest gap setting (IKA MK 2000/10, IKA Works Inc., Wilmington, NC, USA). Later, the slurry passed through the in-line homogenizer operating at 4,200 rpm (IKA DISPAX-Reactor DR 2000/10, IKA Works Inc., Wilmington, NC, USA), yielding comminuted seed mixture 521. After milling, comminuted seed mixture 521 was collected in a tank while maintaining constant mixing. The pH of the slurry was adjusted 523 and decreased to 5.0 using 85% (w/w) H₃PO₄, and then the pH-adjusted comminuted slurry 525 was conveyed to a decanter (Alfa Laval NX-912) operating at 3,000×g with a flow rate of 10 L/min to separate 530 liquid phase 532 from solid phase 531. The liquid phase 532 was collected in a tank and, using 50% NaOH, its pH was adjusted 533 to pH 8.2 to yield pH-adjusted liquid phase 535 and conveyed to a disc-stack centrifuge (SA20-01-076, Westfalia, Oelde, Germany) with a feed rate of 9-9.5 L/min to separate 540 into three fractions. The resulting three fractions were: oleosome containing light liquid phase 542 (oleosome containing fraction), protein containing heavy liquid phase 541, and precipitated solids (not shown in FIG. 5B). Protein containing heavy liquid phase 541 had the following composition: 0.6% (w/w) oil, 1.82% (w/w) protein, 0.6% (w/w) ash, and 96.4% (w/w) moisture. Protein containing heavy liquid phase 541 was further processed to obtain sunflower protein concentrate 598 as follows. Protein containing heavy liquid phase 541 was passed through a disc centrifuge (SA20-01-076, Westfalia, Oelde, Germany) at 7,800 rpm with a feed rate of 6-7.5 L/min to separate 550 a cream phase 551 with the following composition: 3.8% (w/w) oil, 1.6% (w/w) protein, 0.4% (w/w) ash, and 93.8% (w/w) moisture, from a heavy phase 553. The pH of remaining heavy phase 553 phase was adjusted 560 to pH 4.5 using H₃PO₄ to obtain pH-adjusted heavy phase 561 and passed through a clarifier centrifuge (Westfalia, SA7-06) under a force of 11,800×g to separate 570 protein precipitate 571 from aqueous phase 573. The composition of corresponding protein precipitate 571 was 4.3% (w/w) oil, 18.3% (w/w) protein, 0.9% (w/w) ash, and 73.1% (w/w) moisture. The corresponding aqueous phase 573 had 0.2% (w/w) oil, 0.6% (w/w) protein, 0.8% (w/w) ash, and 97.6% (w/w) moisture. Protein precipitate 571 was diluted with 1 part RO water to obtain protein slurry 583. The pH of protein slurry 583 was adjusted 590 to pH 7.0 using 50% NaOH to provide pH-adjusted protein slurry 593. Then pH-adjusted protein slurry 593 was spray dried 595 using a Niro Atomizer (GEA, Denmark) spray drier to provide spray dried protein concentrate 598 with the following composition on dry basis: 68.4% (w/w) protein, 19.4% (w/w) fat, 5.8% (w/w) ash. The phenolic content of spray dried protein concentrate 598 was determined to be 0.6 mg GAE/gram dry weight of sample.

### Example 1.g.—Making a Second Sunflower Protein Concentrate and a Sunflower Oleosome Preparation

Referring to FIGS. 6A-6E, and to example process 600 illustrated therein, a total of 68.04 kg of dehulled sunflower seed (Helianthus annuus) (611) was conveyed to the hopper of a hammer mill (Fitzpatrick Hammer mill with 0.125″ screen) using a coil auger at an average rate of 65 rpm together with 462.7 L of a 2.5 mM aqueous solution of sodium hexametaphosphate at pH 7.0 supplied through an externally connected hose prior to milling to comminute 620 dehulled seed 611. The resulting slurry was pumped into serial mills in the following order: colloid mill (MZ-130, Fryma, Romaco Inc., Pompton Plains, NJ, USA), a second colloid mill with smallest gap setting (MZ-130, Fryma, Romaco Inc., Pompton Plains, NJ, USA), and a third colloid mill with smallest gap setting (IKA MK 2000/10, IKA Works Inc., Wilmington, NC, USA). Finally, the slurry passed through an in-line homogenizer operating at 4,200 rpm (IKA DISPAX-Reactor DR 2000/10, IKA Works Inc., Wilmington, NC, USA) to yield comminuted seed mixture 621. After milling, comminuted seed mixture 621 was collected in a tank while maintaining constant mixing. The pH of the slurry was adjusted 623 to 7.2 using 85 mL of 50% NaOH to yield pH-adjusted comminuted seed mixture 625 and then pH-adjusted comminuted seed mixture 625 was conveyed to a decanter (Alfa Laval NX-912) operating at 3,000×g with a flow rate of 10 L/min to separate 630 liquid phase 632 from solid phase 631. The solid phase had the following composition: 5.52% (w/w) oil, 4.18% (w/w) protein, 0.91% (w/w) ash, and 82.70% (w/w) moisture. The liquid phase 632 was collected in a tank and, after ensuring 633 a pH of 7.2, was conveyed to a disc-stack centrifuge (SA20-01-076, Westfalia, Oelde, Germany) with a feed rate of 9-9.5 L/min to separate 640 liquid phase 632 into three fractions. The resulting three fractions were oleosome containing light liquid phase 642, protein containing heavy liquid phase 641, and precipitated solids (not shown in FIG. 6B). The oleosome containing light liquid phase 642 had the following composition: 19.50% (w/w) oil, 3.14% (w/w) protein, 0.33% (w/w) ash, and 75.50% (w/w) moisture. The oleosome containing light liquid phase 642 was further collected in a tank and mixed with 1 part RO water to wash 650a oleosome containing light liquid phase 642. The water-oleosome containing light liquid phase mixture was passed through a second disc-stack centrifuge at 7,800 rpm (SA20-01-076, GEA Westfalia, Oelde, Germany) with a feed rate 8-8.5 L/min to yield 57.8 kg of a separated light phase (washed oleosomes 651a). The washed oleosomes 651a were collected in a tank and mixed with 1 part RO water to wash 653a washed oleosomes 651a. The water-washed oleosomes mixture was passed through a third disc-stack centrifuge 7,800 rpm (SA20-01-076, Westfalia, Oelde, Germany) to yield 30.7 kg of double-washed oleosome preparation 655a, which was further pasteurized 660a at 85° C. for 20 s to provide pasteurized double-washed oleosome preparation 661a, which had the following composition: 58.70% (w/w) oil, 3.15% (w/w) protein, 0.00% (w/w) ash, 35.04% (w/w) moisture. The average particle size (D[4,3]) of pasteurized double-washed oleosome preparation 661 was found to be 2.70 μm. Thus, the pasteurized double-washed oleosome preparation 661a had a dry weight of about 64.95%, a protein concentration of about 4.84% (w/w) on a dry basis (db), a lipid to protein ratio of about 18.6% on a dry basis (db), and particles having a mean particle size D[4,3] of about 2.70 μm. The method in this example has been repeated a number of times and has consistently yielded a pasteurized double-washed oleosome preparation having a dry weight of from about 60% to about 70%, a protein concentration of from about 2% (w/w) to about 5% (w/w) on a dry basis (db), a lipid to protein ratio of from about 15% to about 45% on a dry basis (db), and particles having a mean particle size D[4,3] of from about 2 μm to about 5 μm (data not shown). The pH of 4.9 kg of pasteurized double-washed high protein oleosome preparation 661a was adjusted 671a from 7.14 to 3.29 using 4 ml of 85% H₃PO₄ while maintaining constant mixing at 500 rpm using an overhead stirrer to yield pasteurized low-pH oleosome preparation 675a. The average particle size of pasteurized low-pH oleosome preparation 675a was found to be 2.96 μm in terms of D[4,3].

Protein containing heavy liquid phase 641 had the following composition: 0.53% (w/w) oil, 2.80% (w/w) protein, 0.35% (w/w) ash, and 95.6% (w/w) moisture. Protein containing heavy liquid phase 641 was further processed to obtain sunflower protein concentrate 698 as follows. Protein containing heavy liquid phase 641 was passed through a disc centrifuge (SA20-01-076, Westfalia, Oelde, Germany) at 7,800 rpm with a feed rate of 6.9-7.2 L/min to separate 650 a cream phase 651 with the following composition: 1.0% (w/w) oil, 2.65% (w/w) protein, 0.37% (w/w) ash, and 95.6% (w/w) moisture, from a heavy phase 653. The pH of remaining heavy phase 653 phase was adjusted 660 to pH 4.5 using H₃PO₄ to obtain pH-adjusted heavy phase 661 and passed through a clarifier centrifuge (Westfalia, SA7-06) under a force of 11,800×g to separate 670 protein precipitate 671 from aqueous phase 673. The composition of corresponding protein precipitate 671 was 0.83% (w/w) oil, 20.36% (w/w) protein, 1.26% (w/w) ash, and 76.5% (w/w) moisture. The corresponding aqueous phase 673 had 0.05% (w/w) oil, 0.9% (w/w) protein, 0.44% (w/w) ash, and 98.4% (w/w) moisture. Protein precipitate 671 was diluted with 1 part RO water to obtain protein slurry 683. The pH of protein slurry 683 was adjusted 690 to pH 7.0 using 50% NaOH to provide pH-adjusted protein slurry 693. Then pH-adjusted protein slurry 693 was spray dried 695 using a Niro Atomizer (GEA, Denmark) spray drier to provide spray dried protein concentrate 698 with the following composition on dry basis: 87.19% (w/w) protein, 1.08% (w/w) oil, 7.15% (w/w) ash.

### Example 2.a.—Making a High-Protein Oleosome Preparation from Sunflower Seeds

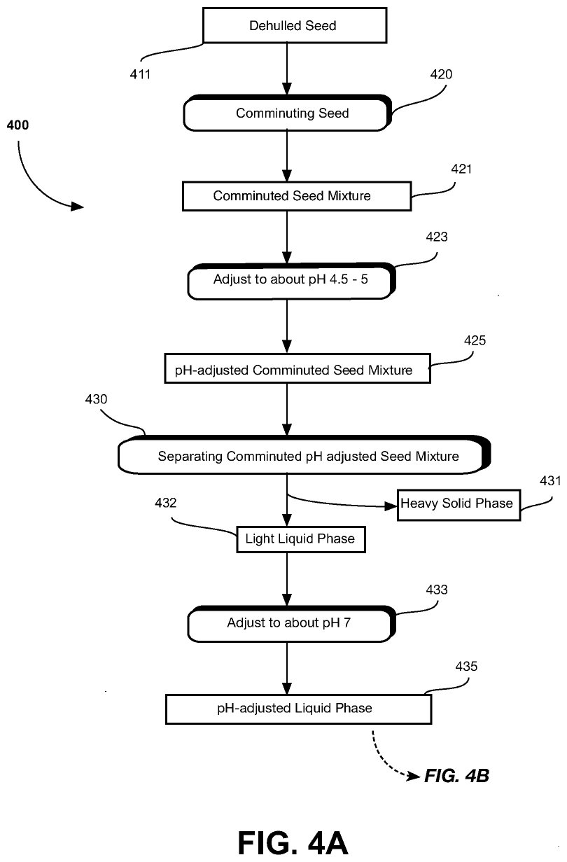

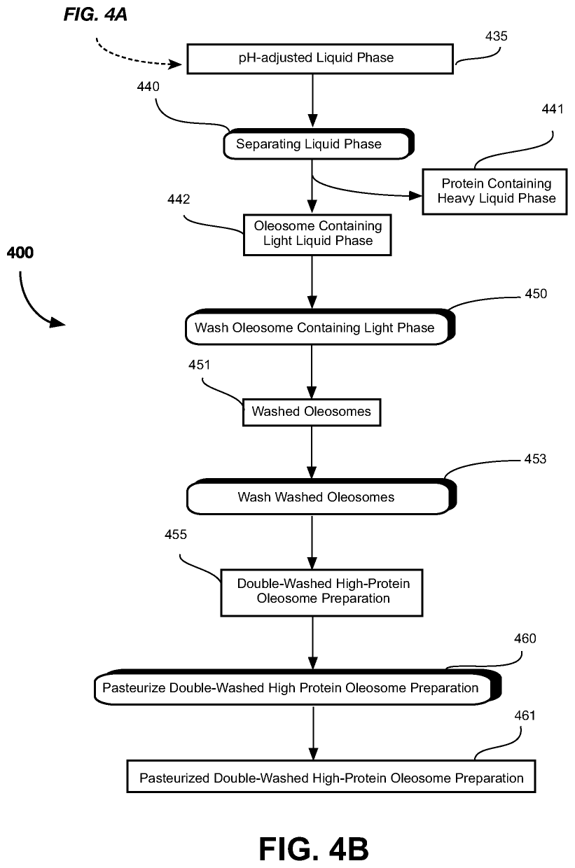

Referring to FIGS. 4A-4B, and example process 400 illustrated therein, a total of 113.4 kg of dehulled sunflower seed (Helianthus annuus) 411 was conveyed through the hopper of a hammer mill (Fitzpatrick Hammer mill with 0.125″ screen) using a coil auger at an average rate of 65 rpm together with 770.95 L of reverse osmosis (RO) water supplied through an externally connected hose prior to milling to comminute 420 the dehulled seed 411. The resulting slurry was conveyed to serial mills in the following order: colloid mill (MZ-130, Fryma, Romaco Inc., Pompton Plains, NJ, USA), a second colloid mill with smallest gap setting (MZ-130, Fryma, Romaco Inc., Pompton Plains, NJ, USA), and a third colloid mill with smallest gap setting (IKA MK 2000/10, IKA Works Inc., Wilmington, NC, USA). Finally, the slurry was passed through an in-line homogenizer operating at 4,200 rpm (IKA DISPAX-Reactor DR 2000/10, IKA Works Inc., Wilmington, NC, USA) to provide comminuted seed mixture 421. After milling, comminuted seed mixture 421 was collected in a tank while maintaining constant mixing. The pH of the slurry was adjusted 423 and decreased to 4.6 using 75% H₃PO₄ and then the obtained p-adjusted comminuted seed mixture 425 was conveyed to a decanter (Alfa Laval NX-912) operating at 3,000×g with flow rate of 10 L/min to separate 425 light liquid phase 432 from heavy solid phase 431. The liquid phase 432 was collected in a tank and, using 50% NaOH, its pH was adjusted 433 to pH 7.2 and obtain pH-adjusted liquid phase 435, which was thereafter conveyed to a disc-stack centrifuge (SA20-01-076, Westfalia, Oelde, Germany) with a feed rate of 9.5-10 L/min to be separated 440 into three fractions. The resulting three fractions were oleosome containing light liquid phase 442, protein containing heavy liquid phase 441, and precipitated solids (not shown in FIG. 4B). To wash 450 oleosome containing light liquid phase 442, it was passed through a static inline mixer and diluted with RO water (3 L/min) into a second disc centrifuge at 7,800 rpm (SA20-01-076, GEA Westfalia, Oelde, Germany) to provide a separated light phase (washed oleosomes 451) flow of 1.0-2.0 L/min. The washed oleosomes 451 were collected in a tank and mixed with 1 part RO water. The mixture was washed 453 by passing it through a third disc-stack centrifuge at 7,800 rpm (SA20-01-076, Westfalia, Oelde, Germany) with a light phase flow of 1.6-1.9 L/min to result in 40.9 kg of double-washed high-protein oleosome preparation 455. Double-washed high-protein oleosome preparation 455 was further pasteurized 460 at 85° C. for 2 seconds to yield pasteurized high-protein oleosome preparation 461. Various constituents of composition of pasteurized high-protein oleosome preparation 461 were assayed as shown in Table 7. Pasteurized high-protein oleosome preparation 461 was physically stable against creaming over 28 days 4° C.

TABLE 7
Compositional data of a high-protein oleosome preparation.

| | | | | | | Total | |
|---|---|---|---|---|---|---|---|
| | | | | | | phenolic | Average |
| | Dry | | | | | (mg GAE/gram | particle size |
| | weight | Lipid/ | Protein | Oil | Ash | dry weight | D[4,3] |
| Sample | (%) | Protein | (%, db) | (%, db) | (%, db) | of sample) | μm |
| 461 | 59 | 11.8 | 7.65 | 90.17 | 0.24 | 0.34 | 4.788 |

### Example 2.b.—Making a High-Protein Oleosome Preparation from Sunflower Seeds in Accordance with the Prior Art

In accordance with the teachings of PCT Patent Application PCT/CA98/00623, a total of 68 kg of dehulled sunflower seed (Helianthus annuus) was poured through the hopper of a colloid mill with 1R gap setting (MZ-130, Fryma, Romaco Inc., Pompton Plains, NJ, USA) together with 340 L of Calgary City water (tap water) supplied through an externally connected hose prior to milling. Following the grinding of the seeds, a further 68 L of Calgary City water was added to the seed slurry to a final volume of 408 L water and mixed well. The resulting slurry was conveyed to a decanter (Alfa Laval NX-912) operating at 3500 rpm with a flow rate of 10 L/min to separate liquid phase from solid phase. The liquid phase was collected in a tank and pumped to a disc-stack centrifuge (SA20-01-076, Westfalia, Oelde, Germany). The resulting three fractions were an oleosome containing light liquid phase, a protein containing heavy liquid phase, and precipitated solids. The light liquid phase (unwashed oleosomes) was then mixed with 5 parts water and then passed through the centrifuge. This procedure was repeated a total of three more times. The resulting triple washed oleosome (22.6 kg) was further pasteurized at 85° C. for 20 s to yield pasteurized oleosome preparation. The composition of the obtained oleosome preparation was analyzed, and the results are shown in Table 8. It is noted that the oleosome preparation contains particles having a mean particle size substantially larger than the oleosome preparation prepared as described in Example 2.a (D[4.3] of 11.2 mm vs D[4.3] of 4.8 mm), and the oleosome preparation exhibits an extremely low dry weight less than 40%. The smaller size oleosomes and higher dry weight oleosomes can be physically more stable and the oleosome preparation can therefore be less susceptible to creaming.

TABLE 8
Compositional data of a prior art high-protein oleosome preparation.

| | | | | | | | Total |
|---|---|---|---|---|---|---|---|
| | | | | | | Average | phenolic |
| | Dry | | | | | particle size | (mg GAE/gram |
| | weight | Protein/ | Protein | Oil | Ash | D[4,3] | dry weight |
| Sample | (%) | Lipid | (%, db) | (%, db) | (%, db) | (μm) | of sample ) |
| Prior Art | 38.2 | 13.9 | 6.3 | 87.8 | 0.52 | 11.176 | 0.58 |
| pasteurized | | | | | | | |
| double washed | | | | | | | |
| high protein | | | | | | | |
| oleosome | | | | | | | |
| preparation | | | | | | | |

### Example 3—Preparation of a Barista Milk

Barista milk formulations were produced using pasteurized double-washed oleosome preparations 161 and 461 produced according to example process 100 as described herein and example process 400 as described herein in Examples 1.a and 2.a, respectively, to evaluate their effect on product characteristics.

Barista milk formulations were formulated to assess the effect of low-protein pasteurized double-washed oleosome preparation 161 (example process 100) at various levels and high-protein pasteurized double-washed oleosome preparation 461 (example process 400) as a replacement for oil in barista milks containing pea protein (shelf stable) and to assess the effect of low-protein pasteurized double-washed oleosome preparation 161 (example process 100) as a replacement for oil in refrigerated barista milks containing soy and canola protein.

Barista milk formulations made with pea protein were formulated with low-protein pasteurized double-washed oleosome preparation 161 (example process 100) at various inclusion levels as listed in Table 9.

TABLE 9
Shelf stable pea protein barista milks (no flavour)
formulated with 0% to 4% low-protein oleosomes.

| | | 1% | 2% | 3% | 4% |
|---|---|---|---|---|---|
| | Control | Oleosome | Oleosome | Oleosome | Oleosome |
| Ingredient | % | % | % | % | % |
| Water, RO | 92.2 | 93.2 | 92.2 | 91.2 | 90.2 |
| Pea protein - Peazazz ® | 3.0 | 3.0 | 3.0 | 3.0 | 3.0 |
| Canola oil | 2.0 | 0 | 0 | 0 | 0 |
| Low-protein oleosome | 0 | 1.0 | 2.0 | 3.0 | 4.0 |
| Sugar | 1.75 | 1.75 | 1.75 | 1.75 | 1.75 |
| Ticaloid ® PRO 181AG (gum | 0.5 | 0.5 | 0.5 | 0.5 | 0.5 |
| acacia, gellan gum) | | | | | |
| Dipotassium phosphate | 0.3 | 0.3 | 0.3 | 0.3 | 0.3 |
| Trisodium citrate dihydrate | 0.25 | 0.25 | 0.25 | 0.25 | 0.25 |

(Peazazz ® is a registered trademark of Burcon NutraScience Corporation, Vancouver, BC, Canada; Ticaloid ® is a registered trademark of Corn Products Development, Inc. of Westchester, Illinois, USA)

Refrigerated barista milk formulations made with soy and canola protein were formulated with low-protein pasteurized double-washed oleosome preparation 161 (example process 100) at various labels as listed in Table 10.

TABLE 10
Refrigerated soy and canola protein barista milk (no flavour).

| | Soy | Soy | Canola | Canola |
|---|---|---|---|---|
| | protein | protein | protein | protein |
| | control | Oleosome | control | oleosome |
| Ingredient | % | % | % | % |
| Water, RO | 92.35 | 91.48 | 92.35 | 91.48 |
| Soy protein - Clarisoy ® 170 | 2.5 | 2.5 | 0 | 0 |
| Canola protein - Puratein ® | 0 | 0 | 2.5 | 2.5 |
| HS | | | | |
| Sunflower oil (high oleic) | 1.3 | 0 | 1.3 | 0 |
| Low-protein oleosome 161 | 0 | 2.17 | 0 | 2.17 |
| Sugar | 2.8 | 2.8 | 2.8 | 2.8 |
| Ticaloid ® PRO 181AG (gum | 0.5 | 0.5 | 0.5 | 0.5 |
| acacia, gellan gum) | | | | |
| Dipotassium phosphate | 0.3 | 0.3 | 0.3 | 0.3 |
| Trisodium citrate dihydrate | 0.25 | 0.25 | 0.25 | 0.25 |

(Clarisoy ® and Puratein ® are registered trademarks of Burcon NutraScience Corporation in Vancouver, BC, Canada)

Shelf stable pea protein barista milk formulations with flavour were formulated with pasteurized double-washed low-protein oleosome preparation 161 (example process 100) and pasteurized double-washed high-protein oleosome preparation 461 (example process 400) as shown in Table 11.

TABLE 11
Shelf stable pea protein barista milk (with flavour) formulations
containing low-protein and high-protein oleosomes.

| | | Low-protein | High-protein |
|---|---|---|---|
| | | Oleosome | Oleosome |
| | Control | 161 | 461 |
| Ingredient | % | % | % |
| Water, RO | 91.15 | 80.28 | 90.28 |
| Pea protein - Peazazz ® | 2.5 | 2.5 | 2.5 |
| Sunflower oil (high oleic) | 1.3 | 0 | 0 |
| Low-protein oleosome 161 | 0 | 2.17 | 0 |
| High-protein oleosome 461 | 0 | 0 | 2.17 |
| Sugar | 2.8 | 2.8 | 2.8 |
| Ticaloid ® PRO 181AG (gum | 0.5 | 0.5 | 0.5 |
| acacia, gellan gum) | | | |
| Dipotassium phosphate | 0.3 | 0.3 | 0.3 |
| Trisodium citrate dihydrate | 0.25 | 0.25 | 0.25 |
| Sunflower masker | 0.8 | 0.8 | 0.8 |
| MET0004146 | | | |
| Milk flavour 2399A | 0.4 | 0.4 | 0.4 |

The barista milk formulations were prepared by weighing the protein, gum, sugar, dipotassium phosphate, and sodium citrate before whisking these dry ingredients together until homogeneously blended. The blended dry ingredients were slowly added into 82° C. reverse osmosis water while constantly whisking to completely dissolve the dry ingredients. The mixture was hydrated for 10 minutes while whisking every minute for 5 seconds. The hydrated protein mixture was slowly added into the oil/oleosome by whisking for 2 minutes to completely combine. When flavour was used, the flavour was added while whisking with the oil/oleosome for 2 minutes to completely combine. The formulation was homogenized using a 2-stage homogenizer (Panda 2K GEA Niro Soavi homogenizer with 2^{nd} stage set at 40 bar and 1^{st} stage set at 140 bar), pasteurizing with either UHT pasteurization (ultra-high temperature) at 138° C. for 6 seconds using a MicroThermics UHT (set for preheat at 114° C. and pasteurize at 138° C. for 6 seconds) or HTST pasteurization (high temperature short time) at 75° C. for 30 seconds (no preheat required then packaged into bottles).

### Example 4—Use of Oleosomes to Enhance the Foaming Capacity and Creaminess of a Barista Milk Formulation

The current Example 4 refers to barista milk formulations made in Example 3. The viscosity of the individual barista milk formulations was measured using a Brookfield DV-II+Pro Viscometer. Samples were weighed (500 g) into 600 mL beakers and viscosity readings were measured at 6° C. using spindle #2 and the viscosity was recorded in centipoise (cP). As shown in Table 14, the viscosity of barista milk increases as the amount of oleosome increases. For the shelf stable pea protein (no flavour) barista milk formulations, the 1% oleosome formulation had a lower viscosity than the control while the 2%, 3% and 4% oleosome formulations had a higher viscosity than the control which increased as oleosome percentage increased. The viscosity of the soy and canola protein barista milk formulations with oleosomes were higher than the controls. For the shelf stable pea protein barista milk formulations (with flavour) made with pasteurized double-washed low-protein oleosome preparation 161, and pasteurized double-washed high-protein oleosome preparation 461 respectively, both of these formulations had higher viscosities compared to the controls with the pasteurized double-washed high-protein oleosome preparation 461 showing the highest viscosity. This increase in viscosity created by the oleosomes also correlates with the higher sensory scores for mouthfeel (full body) as determined by sensory evaluation panellists (see: Table 13).

To measure foaming capacity, foam was produced by weighing 10 g of the barista milk at room temperature into a 50 mL centrifuge tube. The barista milk was foamed using a stick homogenizer (IKA T18 digital Ultra Turrax lab homogenizer) with the wells just under the surface level and run for 1 minute at 20,000 rpm. The foam capacity (volume) was immediately measured in ml using the graduated scale on the side of the centrifuge tube. For the shelf stable pea protein barista milk (no flavour) formulations, all oleosome barista milk formulations had a tight micro-foam that was stable for at least 30 minutes, similar to the control. The foam volume for all oleosome formulations was higher than the control with the best foam volume and foam capacity at 2% oleosome inclusion as outlined in Table 12. All formulations were stable on coffee and demonstrated a minimal foam volume decrease after a 30-minute hold. For the refrigerated soy and canola protein barista milk (no flavour) formulations, both soy and canola protein/oleosome formulations had a higher initial foam capacity compared to their respective control formulations. After 30 minutes, the soy protein/oleosome formulation had more foam volume than the soy control. This was not observed with the canola protein/oleosome formulations, suggesting oleosomes may provide functional synergies with some proteins. For the shelf stable pea protein barista milk (with flavour) formulations, both barista milk prepared with the pasteurized double-washed low-protein oleosome preparation 161, and pasteurized double-washed high-protein oleosome preparation 461, respectively, had a higher initial foam capacity compared to the control barista milk, with the barista milk prepared with the high-protein pasteurized double-washed oleosome preparation 461 having the largest initial foam volume. These results demonstrate that oleosomes can be used to increase foam volume in barista milk formulations and higher levels of proteins can increase the foam volume even further.

TABLE 12
Barista milk viscosity and foam volume for shelf stable pea protein
barista milk (no flavour) formulations, refrigerated soy and
canola protein barista milk formulations (no flavour) and shelf
stable pea protein barista milk (with flavour) formulations.

| | |
|---|---|
| Viscosity | Foaming Volume |
| (cP) | (ml) |

Shelf stable pea protein barista milk (no flavour)

| | | |
|---|---|---|
| Control | 48.4 | 17 |
| 1% Low-protein oleosome 161 | 44.4 | 20 |
| 2% Low-protein oleosome 161 | 48.8 | 25 |
| 3% Low-protein oleosome 161 | 49.2 | 24 |
| 4% Low-protein oleosome 161 | 52.0 | 23.5 |

Refrigerated soy and canola protein barista milk (no flavour)

| | | |
|---|---|---|
| Soy - Control | 33.2 | 16 |
| Soy - Oleosome 161 | 38.4 | 25 |
| Canola - Control | 49.6 | 17 |
| Canola - Oleosome 161 | 51.6 | 24 |

Shelf stable pea protein barista milk (with flavour)

| | | |
|---|---|---|
| Control | 38.6 | 26 |
| Low-protein oleosome 161 | 44.4 | 27 |
| High-protein oleosome 461 | 63.2 | 33 |

A trained sensory panel reviewed the barista milk formulations. Panellists were trained using commercial products to understand the flavour profile and consistency of the barista milk products. Panellists evaluated four product attributes: aroma intensity, flavour intensity, mouthfeel and creaminess using a 5-point scale. Attributes were ranked as follows; aroma and flavour intensity (1=none, 2=slightly strong, 3=moderately strong, 4=very strong, 5=extremely strong); mouthfeel (1=watery, 2=slightly thick body, 3=moderately thick body, 4=very thick body, 5=extremely thick body); creaminess (1=not creamy, 2=slightly creamy, 3=moderately creamy, 4=very creamy, 5=extremely creamy). The barista milk formulations were portioned into 4 oz plastic cups and evaluated at 10° C. Panellists cleansed the palate between samples using room temperature water and unsalted crackers. For the barista milk formulations from the package at 10° C., all of the oleosome formulations had a pleasant sunflower flavour present at the 2%, 3%, and 4% oleosome formulations. The shelf stable pea protein barista milk (no flavour) formulations were creamier and fuller-bodied compared to the control and this became more pronounced as the oleosome concentration increased. For the shelf stable pea protein barista milk (with flavour) formulations, both the low-protein and high-protein oleosome formulations were described as having a more full-bodied and creamier mouthfeel than the control formulations. Barista milk formulations were also evaluated in coffee prepared using Nescafe medium roast instant coffee (2 g instant coffee per 200 ml hot water). Cold barista milk formulations were added directly to the coffee (30 mL per 180 mL cup of coffee). The barista milk formulations were added cold into hot coffee (not foamed). The coffee flavour was evaluated in the coffee. All oleosome formulations result in a more mellow and smoother coffee flavour with less bitterness and acidity. When the shelf stable pea protein barista milk (with flavour) evaluated in coffee, panelists commented that the high protein oleosome 461 and low-protein oleosome 161 including formulations had a mellowed coffee flavour and a sweet creamy flavour compared to the control product (Table 13).

TABLE 13
Average sensory scores for shelf stable pea protein barista milk (no
flavour) and shelf stable pea protein barista milk (with flavour).

| | | |
|---|---|---|
| Flavour | | |
| Intensity | Mouthfeel | Creaminess |

Shelf stable pea protein barista milk (no flavour)

| | | | |
|---|---|---|---|
| Control | 3.0 | 2.0 | 2.0 |
| 1% Low-protein | 3.0 | 2.3 | 2.3 |
| Oleosome 161 | | | |
| 2% Low-protein | 2.9 | 3.2 | 2.8 |
| Oleosome 161 | | | |
| 3% Low-protein | 3.3 | 3.0 | 3.2 |
| Oleosome 161 | | | |
| 4% Low-protein | 3.3 | 3.4 | 3.6 |
| Oleosome 161 | | | |

Shelf stable pea protein barista milk (with flavour)

| | | | |
|---|---|---|---|
| Control | 2.8 | 2.0 | 2.3 |
| Low-protein Oleosome | 2.8 | 2.8 | 2.8 |
| 161 | | | |
| High-protein Oleosome | 3.0 | 2.8 | 2.8 |
| 461 | | | |

Both pasteurized double-washed low-protein oleosome preparation 161 (example process 100) and pasteurized double-washed high-protein oleosome preparation 461 (example process 400) were successful in replacing vegetable oil in plant-based barista milks containing different protein types (pea, soy, canola) and processed using UHT and HTST. In general, as compared to the controls, oleosomes provide increased viscosity, a fuller bodied, creamier mouthfeel, and an increased foaming capacity. Compared to pasteurized double-washed low-protein oleosome preparation 161 (example process 100), pasteurized double-washed high-protein oleosome preparation 461 (example process 400) conveys higher viscosity and a slightly higher initial foam capacity to the barista milk formulations.

### Example 5—Preparation of a Hemp Nut Milk Formulation

Hemp nut milk formulations were produced using pasteurized double-washed low-protein oleosome preparation 161 from example process 100, to look at the effect of replacing lecithin or vegetable oil with sunflower oleosomes Table 14 and the effect of oleosomes at different concentrations from 0.5% to 2.5% in the absence of both lecithin and oil Table 15.

TABLE 14
Hemp milk formulations: control A and with pasteurized double-
washed oleosome preparation 161 replacing lecithin or oil.

| | Control | Oleosomes 161 | Oleosomes 161 |
|---|---|---|---|
| | A | replacing lecithin | replacing oil |
| Ingredient | % | % | % |
| Hemp base (hemp hearts, | 96.32 | 96.32 | 96.32 |
| water) | | | |
| Canola oil | 1.0 | 1.0 | 0.0 |
| Sunflower lecithin | 0.5 | 0.0 | 0.5 |
| Low-protein oleosome 161 | 0.0 | 0.5 | 1.0 |
| Sugar | 2.0 | 2.0 | 2.0 |
| Gellan Gum | 0.03 | 0.03 | 0.03 |
| Locust Bean Gum | 0.15 | 0.15 | 0.15 |
| Total | 100 | 100 | 100 |

TABLE 15
Hemp milk formulations (no lecithin and oil) with pasteurized double-
washed oleosome preparation 161 at 0% to 2.5% of the formula.

| | 0% | | | | | |
|---|---|---|---|---|---|---|
| | Oleosome | 0.5% | 1.0% | 1.5% | 2.0% | 2.5% |
| | (Control B) | Oleosome | Oleosome | Oleosome | Oleosome | Oleosome |
| Ingredient | % | % | % | % | % | % |
| Hemp base | 97.82 | 97.32 | 96.82 | 96.32 | 95.82 | 95.32 |
| (hemp hearts, | | | | | | |
| water) | | | | | | |
| Canola oil | 0 | 0.0 | 0.0 | 0.0 | 0.0 | 0.0 |
| Sunflower | 0 | 0.0 | 0.0 | 0.0 | 0.0 | 0.0 |
| lecithin | | | | | | |
| Low-protein | 0 | 0.5 | 1.0 | 1.5 | 2.0 | 2.5 |
| oleosome | | | | | | |
| 161 | | | | | | |
| Sugar | 2.0 | 2.0 | 2.0 | 2.0 | 2.0 | 2.0 |
| Gellan Gum | 0.03 | 0.03 | 0.03 | 0.03 | 0.03 | 0.03 |
| Locust Bean | 0.15 | 0.15 | 0.15 | 0.15 | 0.15 | 0.15 |
| Gum | | | | | | |
| Total | 100 | 100 | 100 | 100 | 100 | 100 |

To prepare the hemp nut milk formulations, hulled hemp nuts were ground with water (1:5 hemp to water) and the hemp milk was extracted at room temperature for 20 minutes. The mixture was coarse filtered using a basket centrifuge (25 microns) at 1,800 rpm and fine filtered using a 37-micron (400 mesh) screen. The filtered hemp milk base was combined with the sugar and gums and allowed to hydrate for 20 minutes. After hydration, canola oil, sunflower lecithin and/or oleosomes were added to the hydrated hemp milk base and mixed for an additional 5 minutes. The hemp nut milk beverage was pasteurized using a Microthermics ultra high temperature (UHT) processor at 138° C. for 6 seconds and homogenized using a Panda 2K Homogenizer (2^{nd} stage 40 bar, 1^{st} stage 150 bar). The hemp milk beverage was stored under refrigerated temperatures.

### Example 6—Use of Oleosomes to Enhance the Brightness of a Hemp Nut Milk Formulation

The colour of hemp nut milk formulations produced in Example 5 were assessed using a Minolta® Colorimeter. The difference in color between two samples may be obtained by measuring “how far away” one color is from another. The color difference may be determined by comparing the ΔE of two samples. As used herein, the term “ΔE” refers to a measure of change in visual perception of two colors that allows for quantified determination of the differences between two colors within a color space. The formula for ΔE is Eq. 1:

$$Δ E = \sqrt{Δ {L°}^{2} + Δ {a°}^{2} + Δ {b°}^{2}} \qquad Eq . 1$$

$$Δ L° = {L°}_{Probe} - {L°}_{Ref}$$

$$Δ a° = {a°}_{Probe} - {a°}_{Ref}$$

$$Δ b° = {b°}_{Probe} - {b°}_{Ref}$$

L* is normalized to the values 0 to 100, corresponding to a percentage scale which describes the lightness of a sample. L*=100% means 100% light and L*=0 means no light (black). Positive a* values represent reddish tones and negative values greenish tones. The more positive a* the more reddish and the more negative a* the more greenish. Positive b* values represent yellowish tones and negative values blueish tones. The more positive b* the more yellowish and the more negative b* the more blueish. The color measurements of each sample were captured by a Minolta® colorimeter (by pointing the device at a container containing a sample and then recording the color of the target sample). The captured and recoded data were compared to the color of the control and ΔE values were calculated from the comparisons. The color measurements are shown in Table 16.

TABLE 16
Hemp milk colorimeter measurements (L*a*b*) and
ΔE* as compared to the control formulation.

| | | | |
|---|---|---|---|
| L* avg | a* avg | b* avg | ΔE* |

Control and Oleosome Replacement Formulations

| | | | | |
|---|---|---|---|---|
| Control A | 75.57 | −1.13 | 5.50 | — |
| Oleosomes 161 replace lecithin | 76.07 | −1.29 | 4.09 | 1.50 |
| Oleosomes 161 replace oil | 74.16 | −1.25 | 6.14 | 1.55 |

Oleosome Formulations (no oil or lecithin)

| | | | | |
|---|---|---|---|---|
| 0% Oleosome (Control B) | 72.6 | −1.4 | 3.4 | — |
| 0.5% Oleosomes 161 | 73.70 | −1.33 | 2.74 | 1.3 |
| 1.0% Oleosomes 161 | 76.23 | −1.35 | 3.90 | 3.6 |
| 1.5% Oleosomes 161 | 75.67 | −1.42 | 4.22 | 3.2 |
| 2.0% Oleosomes 161 | 76.74 | −1.30 | 4.77 | 4.3 |
| 2.5% Oleosomes 161 | 74.15 | −1.15 | 4.06 | 1.8 |

For the formulation where the oleosomes replaced lecithin, there was a slight increase in lightness (L*) with more green color (a*) and less yellow colour (b*) as compared to the Control A. For the formulation where the oleosomes replaced the canola oil, there was a slight decrease in lightness (L*) with more green color (a*) and less yellow colour (b*) as compared to the Control A. For the formulations where the oleosome concentration was increased, the lightness (L*) value for all of the formulations was higher than the Control B indicating that the presence of oleosomes lightens the hemp milk formulation.

### Example 7—Use of Oleosomes to Enhance the Creaminess of a Hemp Nut Milk Formulation

The viscosity of hemp nut milk formulations produced in Example 5 were assessed using a Brookfield Programmable DV-II+ Viscometer with a #2 spindle at 6° C. Results are shown in Table 17.

TABLE 17
Average viscosity and sensory scores
of hemp nut milk formulations.

| | | | |
|---|---|---|---|
| Viscosity | Flavour | | |
| (cP) | Intensity | Mouthfeel | Creaminess |

Control and Oleosome Replacement Formulations

| | | | | |
|---|---|---|---|---|
| Control A | 51.2 | 3.0 | 2.7 | 2.5 |
| Oleosomes 161 | 44.4 | 3.3 | 1.8 | 1.6 |
| replacing lecithin | | | | |
| Oleosomes 161 | 50.8 | 3.2 | 2.2 | 2.0 |
| replacing oil | | | | |

Oleosome Formulations (no oil or lecithin)

| | | | | |
|---|---|---|---|---|
| 0% Oleosome | 40.0 | 2.8 | 1.8 | 2.0 |
| (Control B) | | | | |
| 0.5% Oleosomes 161 | 40.0 | 3.2 | 2.3 | 2.6 |
| 1.0% Oleosomes 161 | 45.6 | 3.0 | 3.0 | 3.0 |
| 1.5% Oleosomes 161 | 44.8 | 3.0 | 3.0 | 2.9 |
| 2.0% Oleosomes 161 | 52.8 | 3.0 | 3.0 | 3.0 |
| 2.5% Oleosomes 161 | 52.4 | 3.1 | 3.4 | 3.1 |

The replacement of lecithin or oil with pasteurized double-washed low-protein oleosome preparation 161 reduced the viscosity when compared with the control formulations. In general, as the concentration of oleosomes increases the viscosity increases with concentrations greater than 2.0% oleosomes having increased viscosity when compared to the control.

Sensory evaluation of hemp milk formulations was conducted by a panel of 5-6 trained panelists. Panelists were trained using commercial products to understand the flavour profile and texture of plant based milk beverages. Panelists evaluated three product attributes; flavour intensity, mouthfeel and creaminess using a 5 point scale. Attributes were ranked as follows; Flavour intensity (1=none, 2=slightly strong, 3=moderately strong, 4=very strong, 5=extremely strong); Mouthfeel (1=watery, 2=slightly thick body, 3=moderately thick body, 4=very thick body, 5=extremely thick body); Creaminess (1=not creamy, 2=slightly creamy, 3=moderately creamy, 4=very creamy, 5=extremely creamy). The results are shown in Table 17. In general, hemp milk formulations with higher oleosome concentrations were preferred over the control. As the concentration of oleosomes increased, the flavour intensity of the hemp milk formulation increased, the flavour balance had more sweet nutty notes and less hemp flavour and the oleosome formulations had enhanced mouthfeel with a creamier and fuller-bodied consistency.

### Example 8—Preparation of a Paneer Cheese Formulation

Paneer cheese was prepared using pasteurized double-washed low-protein oleosome preparation 161 prepared by example process 100 using 2 different methods. To prepare a first paneer cheese, 0.67 kg oleosomes were mixed with 12 kg reconstituted skim milk powder (Medalion) using a stick blender. The mixture was heated to 60° C. and homogenized using two-stage homogenization (total pressure was 3,000 psi, second stage 600 psi). The homogenized mixture was refrigerated for 2 hours and added to a cheese vat. In the cheese vat, the homogenized mixture was heated to 90° C. for 5 minutes and then cooled to 80° C. A 10% solution of citric acid was added to allow for 2 grams of citric acid per litre of milk. Coagulation occurred immediately with curd dipping, draining, and hooping being satisfactory. The paneer cheese was pressed using a 10 kg weight for a period of 1 hour and then refrigerated overnight. Dehooping and packaging was satisfactory with the curd knitting properly with a tight texture. The flavour of the paneer cheese was clean with a mild dairy favour and a hint of sunflower. Yield of the cheese was good (16.7%) with no fat being lost in the whey. The fat content of the paneer cheese was 10.5% with a moisture content of 57%.

A second paneer cheese was made with the same procedure as above with the exception that the homogenized mixture of oleosomes and reconstituted skim milk powder was held under refrigerated conditions for one week prior to being added to the cheese vat. As with the first paneer cheese, coagulation occurred immediately, curd dipping, draining, and hooping was satisfactory. Dehooping and packaging was satisfactory with the curd knitting properly with a tight texture. The flavour of the first paneer cheese was clean with a mild dairy flavour and a hint of sunflower. The yield of the cheese was good (20.8%) with no fat being lost in the ‘whey’. The fat content of the paneer cheese was 15.5% with a moisture content of 59.2%.

The oleosomes in both paneer cheeses performed well when used as a butter fat replacer in direct style cheese (paneer) when homogenized with reconstituted skim milk. The results were satisfactory in freshly mixed milk and also after holding the homogenized mixture for 7 days after refrigeration. The cheese texture was acceptable, and the flavour was fresh dairy with a hint of sunflower. The measured yield recoveries were above average.

### Example 9—Preparation of a Vegan Cheese Slice

Vegan cheese slices were prepared using pasteurized double-washed low-protein oleosome preparation 161 produced from example process 100 to evaluate the effect of different levels of fat provided by the oleosomes in different vegan cheese slices. The formulas are shown in Table 18.

TABLE 18
Vegan cheese formulations.

| | | Cheese slice | Cheese slice | Cheese slice |
|---|---|---|---|---|
| | Cheese slice | including | including | including |
| | including | 21% | 25.7% | 30% |
| | sunflower oil | oleosome | oleosome | oleosome |
| | (14.5% oil | (14.5% oil | (18% oil | (21% oil |
| | contribution) | contribution) | contribution) | contribution) |
| Pea Protein Isolate | 18% | 18% | 18% | 18% |
| Waxy Starch | 12% | 12% | 12% | 12% |
| Sunflower oil | 14.5% | — | — | — |
| Low-protein oleosome 161 | — | 21% | 25.7% | 30% |
| (70% dry weight) | | | | |
| Water | 55.5% | 49% | 44.3% | 40% |
| Citric acid | Final pH <5.5 | Final pH <5.5 | Final pH <5.5 | Final pH <5.5 |

The vegan cheese slices were prepared by first adding the total volume of water to a large beaker followed by the appropriate amount of dry pea protein isolate to make a 5% (w/v) protein solution. The solution was mixed on a stir plate at 400 rpm until combined. The oleosome was added to the protein-water solution and homogenized at 20,000 rpm using a Polytron handheld homogenizer for 1 minute to form an emulsion. The emulsion was added to a Thermomix TM6 and mixed at a speed of 2-2.5. During this time, half of the remaining dry pea protein isolate, and half of the dry starch were added to the thermomixer and mixed until fully combined. Enough 1M citric acid was added for a final pH <5.5 and it was allowed to mix for 30 seconds before the addition of the remaining dry pea protein isolate and starch. Mixing continued until a consistent smooth texture was achieved. The sides of the beaker were scraped when necessary to ensure thorough mixing.

Once the vegan cheese slice mixture was completely smooth the heating method was started. The heating method had 2 stages, the temperature ramp, and the speed ramp. For the temperature ramp, the Thermomix TM6 was set to a speed of 2.0 with the temperature set to 40° C. Upon reaching 40° C., the temperature was increased to 50° C., upon reaching 50° C., the temperature was increased to 60° C., upon reaching 60° C., the temperature was increased to 70° C. Upon reaching 70° C., the Thermomix TM6 was stopped, and the bottom was scraped. After scraping the bottom, the speed was set to 0.5 and the temperature was set to 80° C. Upon reaching 80° C., the Thermomix TM6 was stopped, and the bottom was scraped. After scraping the bottom, the speed was set to 0.5 and the temperature to 80° C., and mixing was run for 30 seconds and subsequently stopped, and the bottom was scraped. After scraping the bottom, the speed was set to 3.5 with the temperature set to 80° C. The Thermomix TM6 was run for another 30 seconds then stopped and the bottom of the beaker was scraped. After scraping the bottom of the beaker, the speed was set to 0.5 and temperature set to 80° C. and the Thermomix TM6 was run for 1.5 minutes. Once run from 1.5 minutes, the Thermomix TM6 was stopped, the bottom of the beaker was scraped and once again, the speed was set to 0.5, temperature to 80° C. and Thermomix TM6 was run for 1.5 minutes. After completion of the temperature ramp, the speed ramp was initiated. For the speed ramp, the temperature of the Thermomix TM6 was set to 80° C. The speed was initially set to 0.5 for 30 seconds then progressively increased as follows: speed was set at 2.0 for 30 seconds, to 3.5 for 30 seconds, to 2.5 for 30 seconds and then to 1.5 for 1 minute. The Thermomix TM6 was stopped, and the beaker scraped (note this is approximately 14 minutes). The vegan cheese slices of Table 18 were heated for a total of 42 minutes (speed 0.5 minutes, temperature 80° C. for 2-minute intervals with the beaker being scraped every 2 minutes until the total time of the heating method was 42 minutes).

### Example 10—Use of Oleosomes to Prevent Oil Loss and Enhance the Meltability and Stretchability in Vegan Cheese Slices

The vegan cheese slices prepared as described in Example 8 were evaluated for oil loss, meltability and stretch (axial pull).

Oil loss for the samples was measured based on the saturation of a Schreiber disk paper during the melting of the cheese. A numerical value from 0-7 was allotted based on the number of rings on the paper that were saturated with oil. Oil loss data are shown in Table 19. Both the commercial Kraft® single cheese slice and the oleosome-containing vegan cheese slice had 0% oil loss, whereas a liquid oil-containing cheese slice with the equivalent amount of oil (14.5%) exhibited a significantly greater oil loss (3% oil loss) when compared to the oleosome-containing vegan cheese slice.

TABLE 19
Oil loss of cheese slices.

Oil Loss

Commercial Dairy Cheese Slice

| | |
|---|---|
| Kraft ® single (registered trademark of Kraft | 0% |
| Food Group Brands LLC of Chicago, IL) | |

Liquid Oil-containing Cheese Slices

| | |
|---|---|
| Sunflower oil (14.5% oil w/w) | 3% |

Oleosome-containing Vegan Cheese Slices

| | |
|---|---|
| 21% Low-protein oleosome 161 (14.5% oil | 0% |
| contribution) | |

Meltability was tested using a disk melt test (modified Schreiber test). Samples were cut into a 20 mm diameter circle and stacked at 10 mm in height. Samples were kept at 5° C. A paper template 100 mm in diameter was used with increasing concentric circles as well as lines at 45° angles were placed at the bottom a petri dish with the markings facing up. The sample was then placed on top of the template, covered with a glass top, and refrigerated at 5° C. for 5 minutes. The samples were then transferred to a pre-heated (232° C./450° F.) oven for 5 minutes. The samples were removed and allowed to cool before the diameter was used to calculate the meltability by determining the % increase in diameter from the initial 20 mm. Total stretch was measured by the following equation (Eq. 2).

$$\% Melt = ( Avg melted diameter - Original Diameter ) Original Diameter \qquad Eq . 2$$

Results are shown in Table 20. Vegan cheeses comprising oleosomes at levels of 21%, 25.7%, and 30% with 14.5%, 18% and 21% oil contributions, respectively, were compared to commercial vegan cheese products Daiya mild cheddar cheese slice, Earth Island® cheddar cheese slice, Sheese® Cheddar cheese slice, VioLife cheese slices and a commercial dairy Kraft® single for their meltability. The Kraft® single has a meltability of 151% and the meltability of the commercial vegan cheese slices ranged from 1%-21%. The vegan cheese slices made with oleosomes showed 84% [meltability in the 21% and 25.7% oleosome cheese slices, and 71% in 30% oleosome cheese slices. The meltability of the oleosome containing cheese slices was found to be significantly higher than the commercial vegan cheese slices.

TABLE 20
Meltability of commercial dairy cheese slices, commercial vegan
cheese slices and oleosome-containing vegan cheese slices.

Meltability

Commercial Dairy Cheese Slice

| | |
|---|---|
| Kraft ® single | 151% |

Commercial Vegan Cheese Slices

| | |
|---|---|
| Daiya - Mild Cheddar | 1% |
| Earth Island ® - Cheddar | 3% |
| Sheese ® - Cheddar | 21% |
| Violife | 14% |

Oleosome-containing Vegan Cheese Slices

| | |
|---|---|
| Cheese made with 21% oleosome- (14.5% oil | 84% |
| contribution) | |
| Cheese made with 25.7% oleosome - (18% oil | 84% |
| contribution) | |
| Cheese made with 30% oleosome (21% oil | 71% |
| contribution) | |

(Earth Island ® is a registered trademark of Earth Island in Canoga Park, CA, USA; Sheese ® is a registered trademark of Bute Island Foods Ltd of Rothesay, Isle of Bute, Scotland)

Axial pull (extensibility/stretch) of the cheese slices were measured using a rotational rheometer (MRC 302, Anton Paar, Fraz, Austria) with Peltier plates and a forced air hood used for temperature control. The rheometer was fitted with a 20 mm parallel plate geometry (PP20/S) and pre-heated to 80° C. To avoid slip, the top and bottom plates were affixed with 40 and 600 grit sandpaper respectively and a small amount of super glue was used to adhere the sample. 5 mm samples were used and compressed between the plates with an axial force not exceeding 5 N. The normal force was then reduced to 0.25 N. The samples were held for a total of 6 minutes at 80° C. with a constant 0.1% strain and applied normal force of 0.25 N. The applied force ensured constant contact with the sample during melting with the gap decrease limited to a height of 3 mm. After heating, an axial pull was performed where the top parallel plate geometry moved upwards at a speed of 1500 μm/s. The Normal force (N) and Gap (mm) was recorded during the pull using RheoCompass Software. The gap size of the instrument was recorded in the same frame as sample stretch and the gap at which the sample broke was used as the break point. Total stretch was measured by the following equation (Eq.3):

$$Stretch ( mm ) = Breakpoint ( mm ) - Starting gap after heating ( mm ) \qquad Eq . 3$$

Results are shown in Table 21. Vegan cheeses comprising oleosomes at levels of 21%, 25.7%, and 30% with 14.5%, 18% and 21% oil contributions, respectively, were compared to commercial vegan cheese products Daiya mild cheddar cheese slice, VioLife cheese slices and a commercial dairy Kraft® single for their axial pull or stretch. The Kraft® single has stretch of 36 mm and the stretch of the commercial vegan cheese slices of Daiya mild cheddar cheese slice and VioLife cheese slice respectively are 8 mm and 11 mm. The vegan cheese slices made with 21% oleosomes (14.5% oil contribution) have a stretch of 40 mm and 25.7% oleosomes (18% oil contribution) have a stretch of 29 mm. The stretch of the oleosome containing cheese slices is significantly higher than the vegan commercial cheese slices and slightly higher than a commercial Kraft® cheese slice.

TABLE 21
Stretch of commercial diary cheese slices, commercial vegan
cheese slices and oleosome-containing vegan cheese slices.

Stretch

Commercial Dairy Cheese Slice

| | |
|---|---|
| Kraft ® single | 36 mm |

Commercial Vegan Cheese Slices

| | |
|---|---|
| Daiya - Mild Cheddar | 8 mm |
| Violife | 11 mm |

Oleosome-containing Vegan Cheese Slices

| | |
|---|---|
| Cheese made with 21% Oleosome 161(14.5% | 40 mm |
| oil contribution) | |
| Cheese made with 25.7% Oleosome 161 (18% | 29 mm |
| oil contribution) | |

### Example 11—Preparation of an Alt-Burger Formulation

Pasteurized double-washed low-protein oleosome preparation 161 used to make the alt-burger formulations (i.e., formulations based on plant proteins instead of animal proteins) in the example were made using example process 100. The purpose of the experimental work described in this Example 10 was to evaluate the performance of alt-burgers prepared using oleosomes relative to alt-burgers prepared using coconut oil and canola oil. Ingredients for the alt-burger formulations are listed in Table 22. In formula 1, pasteurized double-washed low-protein oleosome preparation 161 replaced all the fat sources in the fat block (canola oil) and in the fat add-in (coconut oil) sections of control formulation in terms of fat content. In formula 2, pasteurized double-washed low-protein oleosome preparation 161 replaced only the fat from coconut oil in the fat add-in section of control formulation. In formula 3, the fats in the fat block (canola oil) and fat add-in (coconut oil) sections were replaced by the pasteurized double-washed oleosome preparation 161 on the basis of weight.

TABLE 22
Alt-burger formulations to evaluate the performance of
alt-burgers prepared using oleosomes relative to alt-
burgers prepared using coconut oil and canola oil.

| | Formula | Formula | Formula |
|---|---|---|---|
| Control | 1 | 2 | 3 |

Fat block

| | | | | |
|---|---|---|---|---|
| Maltodextrin (N-Zorbit M) | 1.04 | 1.04 | 1.04 | 1.04 |
| Low-protein oleosome 161 | 0 | 8.67 | 0.00 | 5.20 |
| Canola oil | 5.2 | 0 | 5.2 | 0.00 |

TVP Hydration

| | | | | |
|---|---|---|---|---|
| Water A | 25.1 | 25.1 | 25.1 | 25.10 |
| Pomegranate extract | 1.41 | 1.41 | 1.41 | 1.41 |
| Beet root powder | 0.06 | 0.06 | 0.06 | 0.06 |
| Yeast (Springer ® 6001/0- | 0.52 | 0.52 | 0.52 | 0.52 |
| MG-XD) | | | | |
| Yeast (Springer ® 2012/ | 0.52 | 0.52 | 0.52 | 0.52 |
| 10-MG-L) | | | | |
| TVP-63 (Lovingly Made) | 5.2 | 5.2 | 5.2 | 5.2 |
| TVP-70 (Lovingly Made) | 7.8 | 7.8 | 7.8 | 7.8 |
| TVP-78 (Lovingly Made) | 7.8 | 7.8 | 7.8 | 7.8 |

Dry Ingredients

| | | | | |
|---|---|---|---|---|
| Water B | 29.24 | 18.12 | 21.64 | 29.24 |
| Methylcellulose (Ticacel ® | 1.56 | 1.56 | 1.56 | 1.56 |
| LV powder) | | | | |
| Pea protein (Merit | 1.1 | 1.1 | 1.1 | 1.10 |
| Functional Foods ®) | | | | |
| Salt | 0.64 | 0.64 | 0.64 | 0.64 |
| Pepper | 0.22 | 0.22 | 0.22 | 0.22 |
| Paprika | 0.22 | 0.22 | 0.22 | 0.22 |
| Garlic powder | 0.42 | 0.42 | 0.42 | 0.42 |
| Onion powder | 0.42 | 0.42 | 0.42 | 0.42 |

Fat Add in

| | | | | |
|---|---|---|---|---|
| Coconut oil | 11.48 | 0 | 0 | 0.00 |
| Low-protein oleosome 161 | 0 | 19.13 | 19.08 | 11.48 |

Springer ® is a registered trademark of BioSpringer une societe anonyme of Maosons Alfort, France; Triacel ® is a registered trademark of Sanofi Pasteur Inc. of Swiftwater, PA, USA; Merit Functional Foods is a registered trademark of Merit Functional Foods Corporation of Winnipeg, Manitoba, Canada)

In order to formulate the alt-burgers, the fat block was prepared by combining the maltodextrin with either canola oil or oleosomes in a stand mixer for 1 minute. Water A, pomegranate extract, beetroot powder and yeast extract were combined and stirred to dissolve. The water A mixture with extracts were poured over textured vegetable protein (TVP), stirred and the TVP was allowed to hydrate for 10 minutes at room temperature. The dry ingredients (protein powder, salt, pepper, paprika, onion powder, garlic powder, apple cider vinegar and methyl cellulose) were combined and the dry ingredients and water B were added to the fat block and stirred to combine on low speed for 1 minute. The hydrated TVP was added to the fat block/dry ingredient mixture and mixed on low for 30 seconds. Coconut oil or oleosomes were added to the TVP/fat block/dry ingredient mixture and mixed on low for 30 seconds. Patties (113 g) were portioned, shared, and frozen.

### Example 12—Use of Oleosomes to Enhance the Juiciness, Flavour, and Colour of Plant-Based Meats

The alt-burger patties prepared as described in Example 10 were evaluated by trained panelists for aroma intensity, flavour intensity, firmness, tenderness, and moistness. Aroma and flavour intensity were ranked on the following scale: 1—none, 2—slightly strong, 3—moderately strong, 4—very strong, 5—extremely strong. Tenderness was ranked on the following scale: 1—tough, 2—slightly tender, 3—moderately tender, 4—very tender, 5—extremely tender. Moistness was ranked on the following scale: 1—dry, 2—slightly moist, 3—moderately moist, 4—very moist, 5—extremely moist. Sensory evaluation results are shown in Table 23.

TABLE 23
Sensory evaluation results with oleosomes
replacing coconut oil and canola oil.

| | Aroma | Flavour | | | |
|---|---|---|---|---|---|
| | intensity | intensity | Firmness | Tenderness | Moistness |
| Control | 3.0 | 2.0 | 2.4 | 2.7 | 2.3 |
| Formula 1 | 3.2 | 3.0 | 2.8 | 2.8 | 2.5 |
| Formula 2 | 2.8 | 2.9 | 2.6 | 2.5 | 1.9 |
| Formula 3 | 2.8 | 2.8 | 3.0 | 2.8 | 2.0 |

All panelists noted the patties containing oleosomes had a more intense overall flavour compared to the control. Patties with formula 1 were moister (juicier) then the control patty formulation. It can be concluded that oleosomes can be used in the formulation of alt-meat patties to enhance the flavour and juiciness of the patty.

Colour measurements were taken as described in Example 6. The objective colour measurements of the patties are in Table 24.

TABLE 24
Objective colour measurements of raw and cooked
patties for alt-meat hamburger formulations with
oleosomes replacing coconut oil and canola oil.

| | | |
|---|---|---|
| L* | a* | b* |

Raw

| | | | |
|---|---|---|---|
| Control | 44.37 | 15.44 | 17.75 |
| Formula 1 | 40.94 | 15.24 | 16.63 |
| Formula 2 | 38.07 | 14.82 | 16.11 |
| Formula 3 | 39.12 | 15.93 | 17.81 |

Cooked

| | | | |
|---|---|---|---|
| Control | 37.07 | 13.36 | 17.59 |
| Formula 1 | 34.84 | 14.12 | 16.79 |
| Formula 2 | 32.59 | 14.27 | 15.14 |
| Formula 3 | 31.99 | 15.45 | 15.41 |

All of the oleosome containing alt-meat patties had a darker colour as shown with the decrease in L* values as compared to the control patties under both raw and cooked conditions. Oleosomes can be used to enhance the colour of the alt-meat patties.

### Example 13—Preparation of a High Moisture Meat Analogue Formulation

High moisture meat analogue (HMMA) formulations were made using pasteurized double-washed oleosome preparation 161 produced using example process 100. The ingredients for each of the formulations are shown in Table 25.

TABLE 25
Ingredients for the individual high moisture meat analogue (HMMA) formulations.

| | | | | Oleosome 5% | Oleosome 7.5% | Oleosome 10% | | Oleosome 15% |
|---|---|---|---|---|---|---|---|---|
| | | | Sunflower | (4.33% oil | (5.0% oil | (6.7% oil | Sunflower | (10% oil |
| | | Control | oil 5% | contribution) | contribution) | contribution) | oil 9.0% | contribution) |
| Ingredient | Source | % | % | % | % | % | % | % |
| Arcon ® S | ADM | 47.0 | 43.0 | 44.0 | 43.0 | 41.5 | 41.0 | 39.0 |
| Soy Protein | | | | | | | | |
| Concentrate | | | | | | | | |
| Vital wheat | ADM | 46.0 | 43.0 | 44.0 | 43.0 | 41.5 | 41.0 | 39.0 |
| gluten | | | | | | | | |
| Pea starch | Cosucra ® | 3.5 | 3.5 | 3.5 | 3.5 | 3.5 | 3.5 | 3.5 |
| Pea fibre | Cosucra ® | 3.5 | 3.5 | 3.5 | 3.5 | 3.5 | 3.5 | 3.5 |
| Oleosome | Botaneco | — | — | 5.0 | 7.5 | 10.0 | — | 15.0 |
| 161 (67% | | | | | | | | |
| oil content) | | | | | | | | |
| Sunflower | Simply | — | 5.0 | — | — | — | 9.0 | — |
| Oil | Simple | | | | | | | |

(Arcon ® is a registered trademark of Archer Daniels Midland Company Corporation of Delaware, Illinois, Cosucra ® is a registered trademark of Cosucra Groupe Warcoing SA of Warcoing Belgium)

Processing trials were performed using a Clextral EV 32 twin screw extruder equipped with die for HMEC—4*50*600 mm that includes a post barrel colling section. The processing parameters of each trial is shown in Table 26.

TABLE 26
Processing parameters for the HMMA trials.

| | | Sunflower | Oleosome | Oleosome | Oleosome | Sunflower | Oleosome |
|---|---|---|---|---|---|---|---|
| Parameters | Control | oil 5% | 5% | 7.5% | 10% | oil 9.0% | 15% |
| Feed Rate | 10.20 | 10.60 | 10.50 | 10.40 | 10.60 | 11.60 | 12.00 |
| (kg/hr) | | | | | | | |
| Water Flow | 15.60 | 8.40 | 15.60 | 12.20 | 9.40 | 8.00 | 8.70 |
| (kg/hr) | | | | | | | |
| Total | 63.00 | 47.80 | 62.40 | 57.80 | 50.10 | 44.70 | 45.80 |
| Moisture | | | | | | | |
| (%) | | | | | | | |
| Barrel | 30 | 30 | 30 | 30 | 30 | 30 | 30 |
| Zone 1 | | | | | | | |
| (° C.) | | | | | | | |
| Barrel | 90 | 90 | 90 | 90 | 90 | 90 | 90 |
| Zone 2 | | | | | | | |
| (° C.) | | | | | | | |
| Barrel | 121 | 125 | 121 | 125 | 125 | 125 | 125 |
| Zone 3 | | | | | | | |
| (° C.) | | | | | | | |
| Barrel | 167 | 167 | 167 | 167 | 167 | 167 | 167 |
| Zone 4 | | | | | | | |
| (° C.) | | | | | | | |
| Barrel | 167 | 167 | 167 | 167 | 167 | 167 | 167 |
| Zone 5 | | | | | | | |
| (° C.) | | | | | | | |
| Barrel | 167 | 167 | 167 | 167 | 167 | 167 | 167 |
| Zone 6 | | | | | | | |
| (° C.) | | | | | | | |
| Die | 155 | 151 | 155 | 155 | 152 | 150 | 150 |
| Temperature | | | | | | | |
| (° C.) | | | | | | | |
| SME(Watt*h/ | 38.8 | 52.5 | 38.4 | 42.8 | 46.3 | 44.20 | 48.3 |
| kg) | | | | | | | |
| Screw | 396 | 396 | 396 | 396 | 396 | 396 | 396 |
| Speed (rpm) | | | | | | | |
| Cooling | 130 | 135 | 130 | 130 | 130 | 135 | 135 |
| temp (° F.) | | | | | | | |

### Example 14—Use of Oleosomes to Reduce the Degree of Fibration and Hardness in High-Moisture Meat Analogs (Plus Reduced Oily Mouthfeel)

The HMMA fibers obtained as described in Example 13 were analyzed. The addition of oleosomes helped reduce the amount of water needed to texturize the extrusion mixture (63% total moisture with no oleosomes compared to 45.8% total moisture with 15% oleosomes). The processing data showed that by increasing oleosome content, less water is needed, and a higher dry-mix feed rate can be achieved to produce ribbons with homogeneous oil incorporation. The presence of oleosomes helped lubricate the feed which allowed for a lower water requirement for texturization.

Texture analysis of the individual fibers was done by cutting square pieces of the HMMA with and against the flow of the extrudates. If the product has good fiber formation, the blade will receive less resistance cutting past the fibers when cutting with the flow as opposed to the firmness received when cutting through all the fibers across the flow. In all of the extrudates, the firmness across the flow was greater than those with the flow. As shown in Table 27, the increase of oleosomes caused an overall decrease in firmness which is desirable for fish-like analogues. Samples containing oleosomes in the extrudate exhibited reduced texture firmness throughout the flow compared to those containing sunflower oil. However, it is possible to assert that incorporating oleosomes at levels exceeding 7.5% resulted in fish-meat like analogue products.

TABLE 27
Texture of individual HMMA fibers.

| | Texture Firmness (N) | Texture Firmness (N) |
|---|---|---|
| Sample | Across the Flow | With the Flow |
| Control | 116.22 ± 8.05 | 58.07 ± 6.31 |
| Sunflower oil 5% | 102.33 ± 10.88 | 30.08 ± 4.57 |
| Oleosome 5% | 101.77 ± 3.55 | 42.1 ± 2.83 |
| Oleosome 7.5% | 96.69 ± 5.16 | 37.62 ± 4.08 |
| Oleosome 10% | 91.06 ± 6.06 | 38.09 ± 6.91 |
| Sunflower oil 9.0% | 100.2 ± 4.75 | 29.63 ± 2.23 |
| Oleosome 15% | 84.55 ± 6.10 | 21.71 ± 1.83 |

A trained panel evaluated the HMMA fibers for mouthfeel, colour, fibration length and fibration quality. The results are shown in Table 28. In summary, HMMA formulated with oleosomes were whiter in colour than the HMMA formulated with oil with the colour of the HMMA changing from white to a greyer colour in the 15% oleosome fibre. In general, the more oleosomes in the HMMA, the softer the texture and the shorter the fibration. HMMA fibers made with less than 7.5% oleosomes are most suitable for formulating vegan chicken products and HMMA fibers made with 10% or more oleosomes are suitable for formulating vegan seafoods.

TABLE 28
Evaluation of HMMA fibers for mouthfeel, colour, fibration length and fibration quality.

| | Sunflower | Oleosome | Oleosome | Oleosome | Sunflower | Oleosome |
|---|---|---|---|---|---|---|
| Control | oil 5% | 5% | 7.5% | 10% | oil 9.0% | 15% |
| Chewy | Soft | Softer | Softer than | Very smooth | Oily | Clean taste |
| | | | control | surface | mouthfeel | compared |
| | | | and 5% | | | to HMMA |
| | | | oleosome | | | with 9% |
| | | | | | | safflower |
| | | | | | | oil |
| White | Light grey | White | Whiter | Whiter/creamier | Light grey | Light grey |
| | | | than | than HMMA | | |
| | | | control | made with 9% | | |
| | | | | sunflower oil | | |
| Long | Shorter | Long | Long | Shorter fibration | Shorter | Shorter |
| fibration | fibration than | fibration | fibration | than control | fibration | fibration |
| | control | similar to | but shorter | | than | than 10% |
| | | control | than 5% | | control | oleosome |
| | | | oleosome | | | |
| | | | and 5% | | | |
| | | | sunflower | | | |
| | | | oil | | | |
| — | Soft, more | Chew | Narrower | Soft | Soft | Soft |
| | teeth packing | texture | HMMA | Seafood | | Seafood |
| | compared to | compared | ribbons | | | |
| | HMMA with | to HMMA | Chicken | | | |
| | 5% oleosome | with 5% oil | | | | |
| | Chicken | Chicken | | | | |

### Example 15—Preparation of Yoghurt Formulations

The current Example refers to pasteurized double-washed low-protein oleosome preparation 161 made by example process 100. Four yoghurt products were formulated with either skim milk or reconstituted skim milk. For each of the milk bases, a final fat concentration of either 2% or 6% oleosomes were formulated with the milk bases. The compositions of the formulations are shown in Table 29.

TABLE 29
Yoghurt formulations.

| | Yoghurt | Yoghurt | Yoghurt | Yoghurt |
|---|---|---|---|---|
| | formula 1 | formula 2 | formula 3 | formula 4 |
| Ingredients | (3% fat) | (6% fat) | (3% fat) | (6% fat) |
| Sunflower | 3.32% | 9.68% | 3.23% | 9.68% |
| oleosomes 161 | | | | |
| Skim milk | 96.76% | 90.32% | — | — |
| Reconstituted | — | — | 96.76% | 90.32% |
| skim milk | | | | |
| Standard | 0.01% | 0.01% | 0.01% | 0.01% |
| bacterial culture | | | | |

Using a clean mixing vessel, the milk base and oleosomes were combined. The mixture was combined well and heated to 65° C. using a normal mixing procedure. The temperature of the mixture was held at 65° C. and homogenized using a 2-stage homogenizer set to 3,000 psi, second stage set to 600 psi. The homogenized mixture was transferred to a steam kettle and heated between 85° C. and 90° C. for 5 minutes. The mixture was cooled to a temperature between 39° C. and 42° C. and the bacterial culture was added aseptically and mixed with the homogenized mixture for 3-5 minutes. The oleosome/milk base/bacteria culture mixture was placed into clean containers and incubated at 39° C. to 42° C. for about 5 hours or until a pH of 4.5 is obtained. The containers of yoghurt were removed from the incubator and refrigerated.

### Example 16—Use of Oleosomes to Reduce the Degree of Syneresis in Yoghurts

The yoghurt formulations prepared as described in Example 15 made using reconstituted skim milk were both white in colour, smooth and creamy with a clean, acidic flavour and a hint of sunflower. Both formulations had a low amount of syneresis, but slightly more than the samples made with fresh skim milk. The reconstituted skim milk yoghurt with 6% fat had a creamier mouthfeel and had less visible syneresis. Thus, it can be concluded that oleosomes when included in yoghurt formulations help to reduce the degree of syneresis and increase the creaminess in yoghurt.

### Example 17—Preparation of a Clean-Label Salad Dressing

Pasteurized double-washed low-protein oleosome preparation 161 made according to example process 100 were used to produce salad dressings to test the use of oleosomes as an emulsifier and oil replacement. Salad dressings were made with the ingredients shown in Table 30.

TABLE 30
Salad dressing formulations with oleosomes
as an emulsifier and partial oil replacer.

| | | 5% | 10% | 15% |
|---|---|---|---|---|
| | Control | Oleosome | Oleosome | Oleosome |
| Ingredients | % | % | % | % |
| Canola oil | 33.45 | 32.02 | 27.02 | 22.02 |
| Soy lecithin | 3.57 | 0 | 0 | 0 |
| Oleosome 161 | 0 | 5.00 | 10.00 | 15.00 |
| (65% fat) | | | | |
| Xanthan gum | 0.34 | 0.34 | 0.34 | 0.34 |
| Citric acid | 0.25 | 0.25 | 0.25 | 0.25 |
| Salt | 0.83 | 0.83 | 0.83 | 0.83 |
| Onion powder | 0.07 | 0.07 | 0.07 | 0.07 |
| Garlic powder | 0.07 | 0.07 | 0.07 | 0.07 |
| Mustard powder | 0.28 | 0.28 | 0.28 | 0.28 |
| Dill popcorn | 1.54 | 1.54 | 1.54 | 1.54 |
| seasoning | | | | |
| Dill weed | 0.07 | 0.07 | 0.07 | 0.07 |
| Water | 55.4 | 55.4 | 55.4 | 55.4 |
| High fructose | 4.13 | 4.13 | 4.13 | 4.13 |
| corn syrup | | | | |

The salad dressing formulations with pasteurized double-washed oleosome preparation 161 to replace soy lecithin and partially replace canola oil were evaluated for colour, thickness, mouthfeel, taste, and separation as shown in Table 31.

TABLE 31
Salad dressing sensory evaluation with oleosomes to replace
soy lecithin and partially replace canola oil.

| | Sensory Evaluation |
|---|---|
| Control | Off white, slightly yellow colour |
| | Initially very thin but thickens with refrigeration |
| | creamy mouth feel |
| | no separation |
| 5% oleosome | Off white colour |
| | Initially thin but thickens after refrigeration, |
| | slightly thinner than control |
| | Creamy mouth feel |
| | No separation |
| 10% oleosome | Off-white colour |
| | Initially thin but thickens after refrigeration, |
| | slightly thinner than control |
| | Cream mouthfeel |
| | No separation |
| 15% oleosome | Off white colour |
| | Initially thin but thickens after refrigeration, |
| | slightly thinner than control |
| | Cream mouthfeel |
| | No separation |

All of the oleosome salad dressing formulations had a creamy mouthfeel and were only slightly thinner than the control. No separation was found in any of the oleosome salad dressing formulations. Thus, it may be concluded that oleosomes are able to replace soy lecithin as an emulsifier and lower the oil content of salad dressings.

### Example 18—Use of Oleosomes to Produce an Egg-Free Cupcake Formulation

Pasteurized double-washed oleosome preparation 161 used in this current Example is made according to example process 100. The ingredients for the cupcakes are shown in Table 32 to determine the use of oleosomes as an egg replacer in a baking application.

TABLE 32
Cupcakes make with and without the addition
of oleosomes as an egg replacer.

| | | Control | | |
|---|---|---|---|---|
| | Control | with egg | Oleosomes | Oleosomes |
| | with egg | replacer | (5%) | (10%) |
| Ingredients | % | % | % | % |
| Egg | 3.33 | — | — | — |
| Egg replacer, | — | 0.42 | — | — |
| PaneRiso ® | | | | |
| Oleosomes 161 | — | — | 5.00 | 10.00 |
| Lukewarm water | — | 2.91 | — | — |
| 2% Milk | 32.74 | 32.74 | 31.08 | 26.08 |
| Water | 3.78 | 3.78 | 3.78 | 3.78 |
| Butter, melted | 6.49 | 6.49 | 6.49 | 6.49 |
| Granulated | 19.88 | 19.88 | 19.88 | 19.88 |
| sugar | | | | |
| Vanilla extract | 0.36 | 0.36 | 0.36 | 0.36 |
| All purpose flour | 29.08 | 29.08 | 29.08 | 29.08 |
| Baking powder | 0.83 | 0.83 | 0.83 | 0.83 |
| Salt | 0.51 | 0.51 | 0.51 | 0.51 |
| Total | 100 | 100 | 100 | 100 |

PaneRiso ® Egg Replacer ingredients: Corn Starch, Potato Starch, Guar Gum, Baking Powder, Sodium Bicarbonate. (PaneRiso ® is a registered trademark of Canbrand Specialty Foods Inc, of Oakville, Ontario)

To make cupcakes, the dry ingredients and wet ingredients are placed in separate bowls and mixed separately. The dry ingredients are slowly added to the wet ingredients in a stand mixer and the mixture is mixed until the dry ingredients are just combined into the wet ingredients. Line muffin tins with cupcake liners. Fill cupcake liners % with the cupcake batter. The pans are put in a pre-heated 180° C. oven and baked until slightly golden on top (approximately 25 minutes) and a toothpick inserted into the middle comes out clean.

The cupcake formulations from Table 32 were evaluated by a trained panelist with respect to colour, density, cell structure, moistness of the cupcake and flavour as shown in Table 33.

TABLE 33
Sensory evaluation of cupcakes.

| | Sensory Evaluation |
|---|---|
| Control with egg | White color |
| | Fluffy, airy cell structure |
| | Sticky, moist |
| Control with egg | Very white color |
| replacer | Dense, compact cell structure |
| | Dry |
| | Pasty top and gritty |
| Oleosome usage | White color |
| level 5% | Soft, fluffy, airy texture |
| | Even cell structure similar to control with egg |
| | Moist |
| | Vanilla flavour, no off flavours |
| Oleosome usage | White color |
| level 10% | Soft, fluffy, airy texture |
| | Even cell structure similar to control with egg |
| | Moist |
| | Vanilla flavour, slight nutty flavours |

Cupcakes formulated with oleosomes had a similar taste, colour, and texture to egg-based cupcakes. As the oleosome usage increased, the cupcakes had a moister and a crumblier texture. All of the cupcakes with oleosomes showed increased height compared to the cupcake made with egg replacer. The cell structure of the cupcakes make with oleosomes were similar to that of a cupcake made with egg. Oleosomes were shown to be an effective egg replacer in baking applications.

### Example 19—Preparation of Frozen Dessert Formulations (10% Fat) Using Oleosomes

The current Example uses pasteurized double-washed low-protein oleosome preparation 161 produced from example process 100 to incorporate 10% fat in the formulations. In a clean mixing vessel, skim milk, non-fat dry milk, sugar, oleosomes, emulsifier (Polysorbate 80) and stabilizer (Avacream®, Avacream® is a registered trademark of Avalon Chemicals, Inc. of Houston Texas) were combined in Formula 1 and Formula 2. The emulsifier (Polysorbate 80) was eliminated in Formula 3 and Formula 4 and stabilizer Avacream was replaced with Coyote Brand LGC-0613. The frozen dessert mixture was mixed well and heated to 75° C. The mixture was cooled to 65° C. For the mixtures that were homogenized (Formula 1 & Formula 3), a 2-stage homogenizer was set to 3,000 psi, with a second stage set to 600 psi. Non-homogenized mixtures (Formula 2 & Formula 4) were cooled to room temperature without homogenization. The mixture was transferred to clean storage vessels and held overnight in the refrigerated for a minimum of 8 hours for aging. The overnight aged mixture was poured into an ice cream machine and frozen according to the manufacturer's recommendation. After freezing, the frozen dessert was packaged into clean containers and frozen at −30° C. Ingredients for each of the frozen desserts are listed in Table 34.

TABLE 34
Ingredients for frozen desserts.

| | Formula 1 | Formula 2 | Formula 3 | Formula 4 |
|---|---|---|---|---|
| Sugar | 11.00% | 11.00% | 11.00% | 11.00% |
| Sunflower | 16.15% | 16.15% | 16.15% | 16.15% |
| oleosomes 161 | | | | |
| Milk (skim) | 66.56% | 66.56% | 66.71% | 66.71% |
| Non-fat dry | 1.89% | 1.89% | 1.89% | 1.89% |
| milk | | | | |
| CSS (Glucose) | 4.00% | 4.00% | 4.00% | 4.00% |
| Polysorbate 80 | 0.15% | 0.15% | — | — |
| Avacream ® | 0.25% | 0.25% | — | — |
| Coyote Brand | — | — | 0.25% | 0.25% |
| LGC-0613 | | | | |

The frozen dessert formulations from Table 34 were analyzed by a three-person trained panel for flavour, body/texture, appearance/color, melting quality and an overall score was compiled along with an overrun score as shown in Table 35. Overrun is the percentage of expansion of ice cream achieved from the amount of air incorporated into the product during the freezing process. An overrun of 50% means that it has expanded 50% (for example one litre of mix will make 1.5 liters of the finished product. Overrun is calculated using the formula in equation 4 (Eq. 4).

$$Overrun = \frac{\begin{matrix}Weight of the mix - \\ Weight of the same value of frozen dessert\end{matrix}}{Weight of the same volume of ice cream} \times 100 \% \qquad Eq . 4$$

TABLE 35
Average of sensory evaluation and overrun
of frozen dessert formulations.

| | | | Appear- | | | |
|---|---|---|---|---|---|---|
| | | Body/ | ance & | Melting | Overall | |
| | Flavour | texture | colour | quality | score | Over- |
| | (max 10) | (max 5) | (max 5) | (max 5) | (max 25) | run |
| Formula 1 | 8 | 3.7 | 4 | 4 | 19.7 | 53% |
| Formula 2 | 8 | 4 | 4.3 | 4 | 20.3 | 51% |
| Formula 3 | 8.3 | 3.3 | 5 | 4 | 20.6 | 52% |
| Formula 4 | 7.5 | 3 | 4.7 | 4 | 19.2 | 54% |

When sunflower oleosomes were used in a standard dairy-based ice cream milk, the product performance was about the same with and without emulsifiers, for both homogenized and non-homogenized mixes. This indicates that the use of added emulsifiers may not be necessary when using an oleosome preparation in a dairy-based formulation. Conversely, the use of homogenization may not be required when using an oleosome preparation in a dairy-based formulation.

### Example 20—Preparation of Frozen Dessert Formulations (6% Fat) Using Oleosomes

The current Example uses pasteurized double-washed low-protein oleosome preparation 161 produced from example process 100 to incorporate 6% fat (Formula 1 and Formula 2) or 3% fat (Formula 3 and Formula 4) in the formulations. In a clean mixing vessel, milk substitute (oat milk or soy milk), sugar, fat source (coconut oil and/or oleosomes), emulsifier (Polysorbate 80) and stabilizer (Avacream) were combined. The frozen dessert mixture is mixed well and heated to 75° C. The mixture is cooled to 65° C. For the mixtures that are homogenized (Formula 1, Formula 3, and Formula 5), a 2-stage homogenizer is set to 3,000 psi, with a second stage set to 600 psi. Non-homogenized mixtures (Formula 2, Formula 4, Formula 6) move to the next step without homogenization. The mixture is transferred to clean storage vessels and held overnight in the refrigerator for a minimum of 8 hours for aging. The overnight aged mixture is poured into an ice cream machine and frozen according to the manufacturer's recommendation. After freezing, the frozen dessert was packaged into clean containers and frozen at −30° C. Ingredients for each of the frozen desserts are listed in Table 36 and Table 37.

TABLE 36
Ingredients for frozen desserts containing oat milk as a base.

| | Formula 1 | Formula 2 | Formula 3 | Formula 4 |
|---|---|---|---|---|
| Oat Milk (Plain | 72.30% | 72.30% | 74.10% | 74.10% |
| Unsweetened) | | | | |
| Sunflower | 9.67% | 9.67% | 4.84% | 4.84% |
| oleosomes 161 | | | | |
| Coconut oil | — | — | 3.00% | 3.00% |
| Sugar | 12.30% | 12.30% | 12.30% | 12.30% |
| Glucose syrup | 5.10% | 5.10% | 5.10% | 5.10% |
| Polysorbate 80 | 0.15% | 0.15% | 0.15% | 0.15% |
| Avacream ® | 0.49% | 0.49% | 0.49% | 0.49% |

TABLE 37
Ingredients for frozen desserts containing soy milk as a base.

| | Formula 5 | Formula 6 |
|---|---|---|
| Soy milk (Silk ® fortified | 72.30% | 72.30% |
| soy beverage) | | |
| Sunflower oleosomes 161 | 9.67% | 9.67% |
| Sugar | 12.30% | 12.30% |
| Glucose syrup | 5.10% | 5.10% |
| Polysorbate 80 | 0.15% | 0.15% |
| Avacream ® | 0.49% | 0.49% |

(Silk ® is a registered trademark of Danone of Paris France)

The frozen dessert formulations from Table 36 and Table 37 were analyzed by a three-person trained panel for flavour (10 points), body/texture (5 points), appearance/color (5 points), melting quality (5 points) and an overall score (25 points) was compiled along with an overrun score as shown in Table 38.

TABLE 38
Sensory evaluation and overrun of frozen dessert formulations.

| | | | Appear- | | | |
|---|---|---|---|---|---|---|
| | | Body/ | ance/ | Melting | Overall | |
| | Flavour | texture | colour | quality | score | Over- |
| | (max 10) | (max 5) | (max 5) | (max 5) | (max 25) | run |
| Formula 1 | 7.5 | 3.7 | 4.7 | 4 | 19.9 | 60% |
| Formula 2 | 7.5 | 4 | 4 | 4 | 19.5 | 67% |
| Formula 3 | 8 | 3.7 | 4.4 | 4 | 20.1 | 55% |
| Formula 4 | 7.2 | 3 | 5 | 4 | 19.2 | 58% |
| Formula 5 | 7 | 3.3 | 4.3 | 4 | 18.6 | 59% |
| Formula 6 | 7.5 | 3.3 | 4.7 | 4 | 19.5 | 69% |

The sunflower oleosomes performed quite well when used to replace 50% of the coconut oil at a 6% fat level. The non-homogenized mixes outperformed the homogenized mixes for both the oat milk and soy milk trials as determined by the overrun.

### Example 21—the Use of Oleosomes to Replace Egg and Partially Replace Cream in an Ice Cream Formulation

The current Example uses pasteurized double-washed oleosome preparation 161 produced from example process 100. In a clean Cuisinart ICE-100 ice cream maker using the ice cream padded, the ingredients in Table 39 were churned for 45 minutes. Once churned, the ice cream was frozen for 1 hour to harden.

TABLE 39
Ice cream formulations using oleosomes as
an egg and partial cream replacement.

| | | 2% fat from | 4% fat from | 6% fat from |
|---|---|---|---|---|
| | Control | Oleosomes | Oleosomes | Oleosomes |
| Whipping cream | 43.88% | 43.88% | 40.88% | 37.88% |
| (33% M.F.) | | | | |
| Milk (3.25% M.F.) | 32.89% | 32.89% | 32.89% | 32.89% |
| Sugar | 19.24% | 19.24% | 19.24% | 19.24% |
| Natural Vanilla | 0.90% | 0.90% | 0.90% | 0.09% |
| Flavour | | | | |
| Pasteurized Liquid | 3.00% | — | — | — |
| Whole Egg | | | | |
| Salt | 0.09% | 0.09% | 0.09% | 0.09% |
| Oleosomes 161 | — | 3.00% | 6.00% | 9.00% |
| (67% oil) | | | | |

The oleosome formulations from Table 39 were evaluated for sensory properties in Table 40 below.

TABLE 40
Sensory evaluation of ice creams using oleosomes
as an egg and partial cream replacement.

| | Sensory evaluation |
|---|---|
| Control | Off white, slightly yellow colour |
| | Vanilla flavour |
| | Creamy mouthfeel |
| | Very little ice crystals |
| | Easy to scoop |
| | Fluffy |
| 2% fat from Oleosomes | Off white colour |
| (no egg) | Vanilla flavour, slightly nutty |
| | Cream mouth feel |
| | Slight ice crystals, less than control |
| | Denser than control |
| | More difficult to scope then control |
| 4% fat from Oleosomes | Off white colour |
| (no egg, partial | Nutty taste |
| cream replacement) | Very creamy mouth feel |
| | Smooth |
| | Easy to scoop |
| | Denser than control |
| 6% fat from oleosomes | Off white colour |
| (no egg, partial | Nutty taste |
| cream replacement) | Very cream, oily mouth feel |
| | Smooth |
| | Very dense |
| | Easy to scoop |

The use of oleosomes in the ice cream formulations enhanced the creaminess and mouthfeel of the ice cream. The small amount of crystallization in the control decreased with increasing oleosomes. Additionally, the control sample was fluffy and as the oleosome level increased, so did the density. Oleosomes can be used as a replacement for eggs and a partial replacement for cream in ice cream formulations.

### Example 22—Use of Oleosomes to Reduce the Meltability of Ice Cream Formulations

The meltability of ice cream containing pasteurized double-washed low-protein oleosome preparation 161 of Example 20 was tested. The meltability over a 60-minute period at room temperature. As can be seen in Table 40, the control sample retained the least weight and therefore the most melting. Both the 3% oleosome and 6% oleosome samples had similar melting but were still significantly higher than the control, retaining about ⅓ of the original scoop weight after melting for 1 hour. The 9% oleosome sample retained almost half of its original weight after melting for 1 hour. The use of oleosomes in the ice cream formulations reduced the meltability as the concentration of oleosomes increased.

TABLE 40
Percentage of ice cream scoop weight retained
after melting at room temperature.

| | | 3% oleosomes | 6% oleosomes | 9% oleosomes |
|---|---|---|---|---|
| | | (2% fat | (4% fat | (6% fat |
| | Control | contribution) | contribution) | contribution) |
| 0 minutes | 100.00 | 100.00 | 100.00 | 100.00 |
| 15 minutes | 94.18 | 97.52 | 97.89 | 98.81 |
| 30 minutes | 60.64 | 81.14 | 81.33 | 85.54 |
| 45 minutes | 23.06 | 53.60 | 50.56 | 63.99 |
| 60 minutes | 9.56 | 33.08 | 32.17 | 46.80 |

### Example 23—Use of Oleosomes to Reduce the Purge Loss and Cook Loss of Alt-Sausages

Pasteurized double-washed low-protein oleosome preparation 161 used to make the alt-sausage formulations in the example were made from example process 100. The purpose was to assess the oleosome performance in replacing sunflower oil based on weight (Trial 1) and fat content (Trial 2) in the formulation. Ingredients for the alt-sausage formulations are listed in Table 41.

TABLE 41
Alt-sausage formulations to assess oleosome
performance in replacing sunflower oil.

| Ingredient (%) | Control | Trial 1 | Trial 2 |
|---|---|---|---|
| Water A (ice cold) | 27.7 | 27.7 | 27.7 |
| Textured pea protein | 18.0 | 18.0 | 18.0 |
| Pea protein (90% protein) | 6.0 | 6.0 | 6.0 |
| Water B (ice cold) | 30.0 | 30.0 | 23.3 |
| Methylcellulose | 2.0 | 2.0 | 2.0 |
| Sunflower oil (high oleic) | 10.0 | 0 | 0 |
| Oleosome 161 | 0 | 10.0 | 16.7 |
| Italian spice blend | 2.0 | 2.0 | 2.0 |
| Pea fibre | 2.0 | 2.0 | 2.0 |
| Salt | 0.8 | 0.8 | 0.8 |
| Yeast extract | 1.0 | 1.0 | 1.0 |
| Modified tapioca starch | 0.5 | 0.5 | 0.5 |

In order to formulate a 1 kg batch of alt-sausages, 180 g of texturized pea protein and 60 g of pea protein isolate were added to a Hobart mixing bowl, followed by 277 g of ice-cold water. The mixture was mixed on speed 1 for 30 seconds and then allowed to sit at room temperature for 15 minutes to ensure complete hydration of the proteins. The fat component (100 g sunflower oil, 100 g oleosomes or 167 g oleosomes) were combined with 300 g of ice-cold water using a high-shear immersion blender for 15 seconds and 20 g of methylcellulose was slowly incorporated into the mixture over the course of a further 30 seconds of high-shear immersion blending to create an emulsion. 20 g of Italian spice blend, 8 g of salt, 20 g of pea fiber, 10 g of yeast extract and 5 g of modified tapioca starch were combined and added to the hydrated TVP/protein in the Hobart mixing bowl. The emulsion was then added to the Hobart mixing bowl and the mixture was mixed on speed 1 for 30 seconds. The sides of the mixing bowl were scraped and then the mixture was mixed on speed 2 for a further 30 seconds. The resulting sausage mixture was transferred to a jerky gun fitted with a round nozzle and then extruded into 30 mm vegan casings. The filled casings were twisted and tied to make 13 cm sausage links and put to rest in the refrigerator for 2 hours. The sausages were then placed into packages, vacuum sealed and frozen until ready to use.

Purge (liquid remaining in package) was measured thawed sausages. Cook loss of the sausages was measured after oven heating. Sensory evaluation was conducted oven cooked sausages for attributes including aroma intensity, flavour intensity, firmness (initial bite), tenderness (average tenderness during bites 3-5) and juiciness. Aroma and flavour intensity ranging from none (1) to extremely strong (5), firmness ranging from soft (1) to extremely firm (5), tenderness ranging from tough (1) to extremely tender (5), and juiciness ranging from dry (1) to extremely juicy (5). Initial firmness.

Both oleosome sausage formulations produced a mixture similar to the Control. Control and oleosome sausage mixtures had a light brown, coarsely ground interior with visible spices. Cooked sausages had a lightly browned skin with oil droplets on skin. During cooking, juices were released from all sausages, pooling around the sausages on the cooking tray. The lab-made sausages were compared against a retail sausage from Beyond Meat®. Beyond sausages were sold frozen. After thawing, raw Beyond Meat® sausages had a coarsely ground, light pink/brown interior colour with visible TVP pieces and spices. During cooking, an oily orange coloured juice released from the Beyond Meat® sausages onto the pan. Cooked sausages had a lightly browned exterior with visible juice droplets on skin. Upon cutting or biting the product was a light brown colour and juice was released.

TABLE 42
Results for purge and cook loss.

| | | Cook loss (%) | |
|---|---|---|---|
| | Purge (%) | Fresh | Frozen-thawed |
| Control | 0.12 | 12.1 | 15.7 |
| Trial 1 (10% Oleosomes) | 0.07 | 11.6 | 12.5 |
| Trial 2 (16.7% Oleosomes) | 0.06 | 9.9 | 12.1 |
| Beyond Sausage | 0.3 | | 15.7 |

Purge of the oleosome sausages (Trials 1 and 2) was slightly less than the control and the retail product (Table 42). Cook loss (before freezing and after thawing) decreased in Trials 1 and 2 compared to the Control and the retail product, especially with higher oleosome level (Trial 2-16.7% oleosomes).

Sensory results for oven cooked Beyond Meat® sausages had slight to moderate aroma intensity, moderate strong flavour, moderate to very tender (average interior) and slight to moderate juiciness.

TABLE 43
Results of sensory evaluation.

| | Aroma | Flavour | Tender- | Juici- |
|---|---|---|---|---|
| | Intensity | Intensity | ness | ness |
| Control | 2.7 | 2.7 | 3.0 | 2.3 |
| Trial 1 (10% Oleosomes) | 2.3 | 3.0 | 2.7 | 2.3 |
| Trial 2 (16.7% Oleosomes) | 2.5 | 2.7 | 3.5 | 2.3 |
| Beyond Sausage | 3.0 | 3.5 | 4.3 | 3.8 |

Sensory scores for all lab-made sausages were similar for aroma intensity and juiciness, with Trial 1 (10% oleosomes) having slightly more flavour intensity and Trial 2 (16.7% oleosome) having a slightly more tender interior than the other sausages. Juiciness, aroma, and flavour intensities were similar to retail sausages, but less tender compared to retail sausages. Sensory panellists did not detect sunflower flavour typical of oleosome. Sensory evaluation results are shown in Table 43.

### Example 24—Increasing Colloidal Stability of Oleosomes in Wider pH Range, Coating Oleosomes with Phospholipids and Polysaccharides

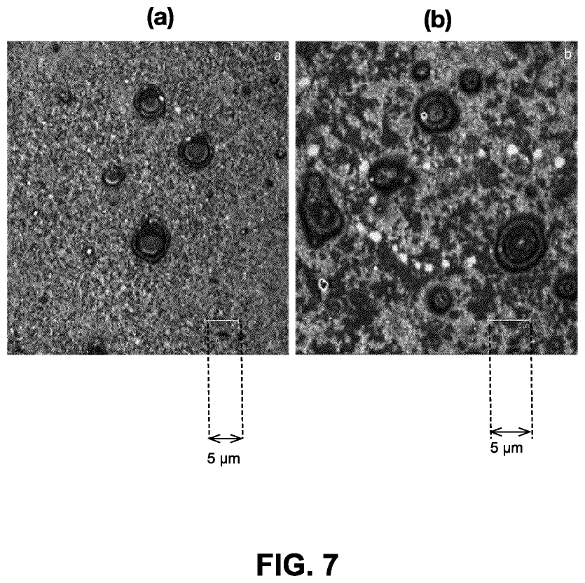

A total of 10 parts of pasteurized double-washed oleosome preparation 161 (LPO) produced using example process 100 and 90 parts of water was homogenized using vortex mixer and formed LPO solution (10%). The isoelectric point (IEP, ξ-potential=0) of LPO solution was determined as pH 6.2 using Zeta potential analyzer (Zetasizer, Malvern Instruments, Malvern, UK), indicating the pH with minimum colloidal stability. A range of deoiled sunflower lecithin (Sunlec 25, Perimondo, New York, USA) concentration (0.05-10% w/w) were mixed with diluted LPO solution. The maximum deposition on the oleosome surface was identified as 447 nm at 0.2% lecithin concentration. The isoelectric point of 0.2% lecithin coated oleosome was determined as pH 3.0, which indicates colloidal stability over a wider pH range. FIG. 7 shows the confocal laser scanning microscope (CLSM) analysis of uncoated and coated LPO solution indicating the lecithin deposition on the oleosome surface. Coating of 0.12% LPO with 0.0024% lecithin increased the surface tension from 41.81 mN/m to 45.85 mN/m indicating more hydrophilic surface.

Coating Oleosomes with Polysaccharides

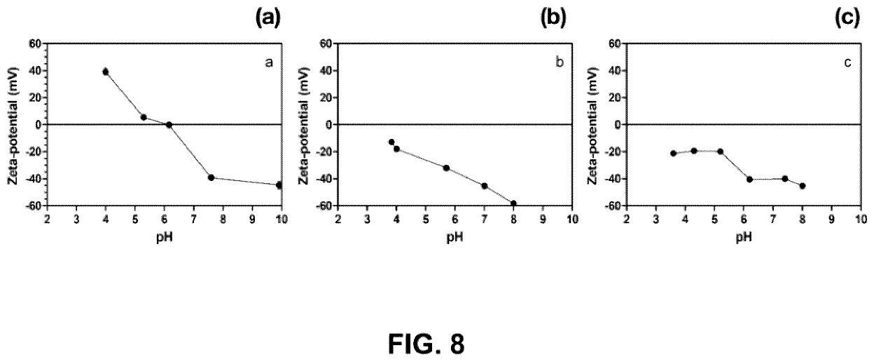

0.1% (w/w) gellan gum and xanthan gum solutions in water were prepared by mixing at room temperature and 90° C., respectively. After dissolving the gums in the water, their pHs were adjusted to pH 4.0 using 0.1M HCl. pasteurized double-washed low-protein oleosome preparation 161 (LPO) produced using example process 100 was added to the gellan gum and xanthan gum solutions to a final concentration of 10% (w/w), followed by homogenization at 15000 rpm for a minute. Additions of LPO to the pH 4.0 gellan and xanthan gum solutions increased their pH to 6.4 and 6.7, respectively, closer to the IEP of uncoated LPO (pH 6.2). The physical stabilities of coated and uncoated 10% LPO solutions close to the IEP of uncoated LPO solution were compared after storing samples at 30° C. for 24 hours and phase separation was not observed in coated samples. The coating of LPOs using anionic polysaccharides (xanthan and gellan gums) decreased IEP lower than pH 4.0 (FIG. 8). LPO coated with gellan gum showed larger negative 4-potential in magnitude in the pH range, from −60 mV at a pH of pH 8/0 to −13 mV at a pH of 3.8. Coating of LPO with xanthan gum increased the surface tension from 41.81 mN/m to 47.25 mN/m, indicating a more hydrophilic surface. Coating of LPO using anionic polysaccharides (xanthan and gellan gums) expanded the colloidal stability over a wider pH range. Negative or positive zeta potential larger than 20 mV in magnitude indicates hydrocolloidal stability of emulsions. And coated oleosomes with anionic polysaccharides had better hydrocolloidal stability in the pH range 4-7.

### Example 25—Incorporation of Oleosomes to the Extruder During High Moisture Meat Analog (HMMA) Extrusion

HMMA formulations were made using pasteurized double-washed low-protein oleosome preparation 161 (LPO) using example process 100 and pasteurized double-washed oleosome preparation 461 (HPO) using example process 400, and LPO and canola protein mixed at pH 3.5 with 8% final protein content and 50% final dry weight. Oleosomes could be incorporated into the extrusion process in two different ways; in both dry and wet methods successfully using the formulation in Table 44 and processing parameters in Table 45. In the dry method, oleosomes were added to dry mix fed through the hopper. On the other hand, in the wet method, pasteurized double-washed low-protein oleosome preparation 161 (LPO) and pasteurized double-washed oleosome preparation 461 (HPO) could be surprisingly successfully directly pumped to the feed section of extruder similar to water flow (Clextral EV 32 twin screw extruder equipped with Die for high moisture extrusion cooking (HMEC)) for the incorporation with dry mix and water and oleosomes homogeneously. Pasteurized double-washed low-protein oleosome preparation 161 (LPO) and pasteurized double-washed high-protein oleosome preparation 461 (HPO) was pumped to feed section of extruder at a rate of 0.89 kg/hr. For both methods, the die insert measurements are 4 mm*50 mm*600 mm. One thermal unit is used to control the temperature of the cooling die. HMMA ribbons could collected successfully with both dry and wet methods. Texture analyses of collected ribbons were done using a TMS-Pro texture analyzer (Table 46). HMMA ribbons were cut into 2.5 cm by 2.5 cm pieces. A single blade was used to cut these pieces in half, ten replicates were completed for both with the flow and across the flow of the extrudate. This indicates the firmness value of the HMMA ribbons. HMMA ribbons using the wet method had higher firmness compared to the dry method (Table 46). Fiber formation was successfully achieved in both dry and wet methods for all samples. The color properties (L*, a*, b*) of HMMA ribbons were evaluated using a Minolta Spectrophotometer CM2500d. Color measurement were performed at different areas of the HMMA as three replicates (Table 49). L*: indicates lightness, a*: red/green coordinate, b*: yellow/blue coordinate. ΔL*: (+) lighter and (−) darker. Δa*: (+) redder and (−) greener. Δb*: (+) yellower and (−) bluer.

TABLE 44
Ingredients for the individual High Moisture Meat Analogue (HMMA) formulations.

| | | | | | | Dry method | Wet method |
|---|---|---|---|---|---|---|---|
| | | | | | | LPO | LPO |
| | | | | | | premixed | premixed |
| | | | Dry method | Wet method | Wet method | with protein | with protein |
| Ingredients | Supplier | Lot Code | LPO (kg) | LPO (kg) | HPO (kg) | (kg) | (kg) |
| Vital | ADM | 261-OT | 5.44 | 5.68 | 5.660 | 6.54 | 5.7 |
| Wheat | | | | | | | |
| Gluten | | | | | | | |
| Pea | Puris | 21103ITL2 | 5.44 | 5.68 | 5.660 | 6.54 | 5.7 |
| Protein | | | | | | | |
| Isolate | | | | | | | |
| Pea Starch | Accu-gel | 111386C0724 | 0.186 | 0.194 | 0.193 | 0.225 | 0.194 |
| Pea Fibre | Aveena | 3522 | 0.186 | 0.194 | 0.193 | 0.225 | 0.194 |
| LPO 161 | Botaneco | HA2023-04 & | 1.14 | 1.185 | | | |
| | | HA2023-05 | | | | | |
| HPO 461 | Botaneco | HA2023-06 | | | 1.100 | | |
| LPO 161 + | Merit | C20-22MA02 | | | | 1.5 | |
| 8% Puratein ® | Functional | 100000864 | | | | | |
| | Foods | | | | | | |
| G canola | Botaneco | HA2023-04 & | | | | | |
| protein | | HA2023-05 | | | | | |
| LPO 161 + | Botaneco | HA2023-04 & | | | | | 1.4 |
| 8% Botaneco | | HA2023-05 | | | | | |
| Canola | Botaneco | BNA2022-22 | | | | | |
| protein | | | | | | | |
| Water | | | 11.6 | 11.70 | 11.60 | 11.1 | 12.7 |

(Puratein ® G is a registered trademark of Merit Functional Foods, Winnipeg, MB)

TABLE 45
Processing parameters for the HMMA trials.

| | | | | Dry | Wet |
|---|---|---|---|---|---|
| | | | | method | method |
| | | | | LPO + 8% | LPO + 8% |
| | Dry | Wet | Wet | Puratein ® | Botaneco |
| | method | method | method | G canola | Canola |
| | LPO | LPO | HPO | protein | protein |
| Feed Rate | 15.2 | 14.4 | 14.4 | 15 | 14.4 |
| (kg/hr) | | | | | |
| Water Flow | 11.6 | 11.7 | 11.6 | 11.1 | 12.7 |
| (kg/hr) | | | | | |
| Total moisture | 47.5 | 49.1 | 48.9 | 46.9 | 51 |
| (%) | | | | | |
| Barrel Zone 1 | 50/30 | 50/34 | 50/34 | 50/30 | 50/33 |
| (° C.) | | | | | |
| Barrel Zone 2 | 90 | 90 | 90 | 90 | 90 |
| (° C.) | | | | | |
| Barrel Zone 3 | 135 | 135 | 135 | 135 | 135 |
| (° C.) | | | | | |
| Barrel Zone 4 | 160 | 160 | 160 | 160 | 160 |
| (° C.) | | | | | |
| Barrel Zone 5 | 160 | 160 | 156 | 156 | 156 |
| (° C.) | | | | | |
| Barrel Zone 6 | 160 | 155 | 153 | 153 | 153 |
| (° C.) | | | | | |
| Pressure (bar) | 16 | 26 | 21 | 21 | 12 |
| Torque | 3 | 4 | 4 | 3 | 3 |
| Kilowatt (Kwatt) | 1 | 1 | 1 | 1 | 1 |
| Amps | 19 | 19 | 19 | 19 | 19 |
| Screw Speed | 395 | 396 | 396 | 396 | 396 |
| (rpm) | | | | | |
| SME (Watt*h/kg) | 41.6 | 38.90 | 38.40 | 38.1 | 36.9 |
| Cooling Temp | 155 | 145 | 150 | 150 | 150 |
| (° F.) | | | | | |

TABLE 46
Texture analysis of HMMA ribbons.

Texture-Firmness (N)

| Sample | With the flow | Across the flow |
|---|---|---|
| Dry method LPO 161 | 44.79 | 121.05 |
| Wet method LPO 161 | 92.35 | 158.71 |
| Wet method HPO 461 | 99.02 | 153.45 |
| Dry method LPO 161 + 8% | 61.40 | 142.99 |
| Puratein ® G canola protein | | |
| Wet method LPO 16 + 8% | 77.62 | 139.45 |
| Botaneco Canola protein | | |

TABLE 17
Color attributes of HMMA ribbons.

| | Color Attributes | | |
|---|---|---|---|
| Sample | L* | a* | b* |
| Dry method LPO 161 | 67.72 | 2.43 | 21.75 |
| Wet method LPO 161 | 63.46 | 3.09 | 17.29 |
| Wet method HPO 461 | 59.80 | 3.14 | 16.36 |
| Dry method LPO 161 + 8% Puratein ® G | 68.59 | 3.09 | 19.77 |
| canola protein | | | |
| Wet method LPO 161 + 8% Botaneco | 62.73 | 3.00 | 16.51 |
| Canola protein | | | |

### Example 26—HMMA Extrusion Using Oleosomes for Modification of Textural Properties

HMMA formulations (Table 48) were tested without oil addition and 6% oil inclusion from sunflower oil, pasteurized double-washed low-protein oleosome preparation 161 (LPO) produced via process 100, pasteurized double-washed high-protein oleosome preparation (461) (HPO) produced via process 400, and a combination of LPO and canola protein mixed at pH 3.5 with 8% final protein content and 50% final dry weight. Feed mixes were mixed with a dough mixer with whip attachment as a method of incorporating oil source into the dry blend using the processing parameters in Table 49. The feed mixes were fed into the feed zone through the hopper of Clextral EV32 twin screw extruder equipped with DIE for HMEC. The die insert measurements are 4 mm*50 mm*600 mm. One thermal unit was used to control the temperature of the cooling die. Using a dough mixer to incorporate the oil source into the dry mix worked well without visible oily sample clumps. During the processing of HMMA with the sunflower oil sample, clogging of the feed mix was observed on the screw in the feeding section. The feed zone needed constant attention. A vibratory assist was hooked up to the feeder to help prevent bridging in the feeder. Processing problems with sunflower oil caused the collection of a smaller amount of HMMA samples compared to LPO- or HPO-including HMMAs. The samples successfully collected from the HMMA processes were analyzed for texture firmness (Table 50) and color attributes (Table 51). Fiber structures of the extrudates are all very fine. The structure of the ribbons was composed of meat-like fibers. The ribbons including sunflower oil in the formula had the softest texture. Without any oil or oleosome inclusion the extrusion of the dry mix led to firmer ribbons. The ribbons with LPO or HPO had moderate firmness and nice fiber structures suitable for vegan chicken nugget application.

TABLE 48
Ingredients for the individual High Moisture Meat Analogue (HMMA) formulations.

| | | | | | | | HMMA |
|---|---|---|---|---|---|---|---|
| | | | | | | | with LPO |
| | | | HMMA | HMMA | HMMA | HMMA | incorporated |
| | | | without | with sunflower | with LPO | with HPO | with protein |
| | | | additional | oil (6% | (6% oil | (6% oil | (6% oil |
| | | | oil | oil content) | content) | content) | content) |
| Ingredients | Supplier | Lot Code | Mass (kg) | Mass (kg) | Mass (kg) | Mass (kg) | Mass (kg) |
| Vital | ADM | 261-OT | 7.28 | 4.45 | 4.55 | 6.83 | 6.83 |
| Wheat | | | | | | | |
| Gluten | | | | | | | |
| Pea | Puris | 220306DW2 | 7.28 | 4.45 | 4.55 | 6.83 | 6.83 |
| Protein | | | | | | | |
| Isolate S70 | | | | | | | |
| Pea Starch | Accu-gel | 111386C0724 | 0.29 | 0.15 | 0.15 | 0.23 | 0.23 |
| Pea Fibre | Aveena | 3522 | 0.28 | 0.15 | 0.15 | 0.23 | 0.23 |
| Sunflower | | | | 0.6 | | | |
| Oil | | | | | | | |
| LPO 161 | Botaneco | HA2023-04 & | | | 0.81 | | |
| | | HA2023-05 | | | | | |
| HPO 461 | Botaneco | HA2023-06 | | | | 1.46 | |
| LPO 161 + | Merit | HA2023-04 & | | | | | 2.18 |
| 8% Puratein ® | Functional | HA2023-05 | | | | | |
| | Foods | | | | | | |
| G canola | Botaneco | BNA2022-22 | | | | | |
| protein | | | | | | | |

TABLE 49
Processing parameters for the HMMA trials.

| | HMMA | | | | HMMA with LPO |
|---|---|---|---|---|---|
| | without | HMMA with | | | incorporated |
| | additional | sunflower oil | HMMA with LPO | HMMA with HPO | with protein |
| | oil | (6% oil content) | (6% oil content) | (6% oil content) | (6% oil content) |
| Feed Rate (kg/hr) | 10.2 | 10.5 | 12.2 | 11.9 | 12.662 |
| Water Flow (kg/hr) | 13.6 | 9.3 | 9.9 | 9.9 | 9.9 |
| Total moisture (%) | 58.06 | 50.34 | 48.92 | 50.01 | 50.05 |
| Barrel Zone 1 (° C.) | 30 | 30 | 30 | 30 | 30 |
| Barrel Zone 2 (° C.) | 90 | 90 | 90 | 90 | 90 |
| Barrel Zone 3 (° C.) | 135 | 135 | 130 | 130 | 135 |
| Barrel Zone 4 (° C.) | 150 | 150 | 150 | 150 | 150 |
| Barrel Zone 5 (° C.) | 150 | 150 | 150 | 150 | 150 |
| Barrel Zone 6 (° C.) | 150 | 150 | 150 | 150 | 150 |
| Pressure (bar) | 20 | 13 | 17 | 9 | 8 |
| Torque | 4 | 2 | 2 | 2 | 2 |
| Kilowatt (Kwatt) | 1 | — | 1 | 1 | 1 |
| Amps | 19 | 19 | 19 | 19 | 19 |
| Screw Speed (rpm) | 396 | 396 | 494 | 494 | 495 |
| SME (Watt*h/kg) | 42 | — | 43.3 | 43.9 | 43.3 |
| Cooling Temp (° F.) | 140 | 150 | 160 | 160 | 160 |

TABLE 50
Texture analysis of HMMA ribbons.

| | Texture-Firmness (N) | |
|---|---|---|
| Sample | With the flow | Across the flow |
| HMMA without additional oil | 87 ± 6.12 | 136.78 ± 8.16 |
| HMMA with sunflower oil (6% | 43.02 ± 4.24 | 87.11 ± 6.24 |
| oil content) | | |
| HMMA with LPO 161 (6% oil | 60.05 ± 6.64 | 116.79 ± 6.42 |
| content) | | |
| HMMA with HPO 461 (6% oil | 69.55 ± 4.73 | 153.46 ± 10.31 |
| content) | | |
| HMMA with LPO 161 incorporated | 73.93 ± 6.37 | 131.17 ± 8.91 |
| with protein (6% oil content) | | |

TABLE 51
Color attributes of HMMA ribbons.

| | Color Attributes | | |
|---|---|---|---|
| Sample | L* | a* | b* |
| HMMA without additional | 65.33 ± 0.84 | 2.58 ± 0.20 | 23.30 ± 1.93 |
| oil | | | |
| HMMA with sunflower oil | 67.84 ± 0.07 | 1.53 ± 0.28 | 25.68 ± 0.41 |
| (6% oil content) | | | |
| HMMA with LPO 161 (6% | 67.39 ± 0.71 | 1.62 ± 0.63 | 26.70 ± 1.35 |
| oil content) | | | |
| HMMA with HPO 461 (6% | 62.07 ± 0.95 | 2.00 ± 0.70 | 27.17 ± 1.29 |
| oil content) | | | |
| HMMA with LPO 161 | 63.98 ± 0.52 | 2.11 ± 0.18 | 28.61 ± 0.60 |
| incorporated with | | | |
| protein (6% oil content) | | | |

### Example 27—Use of Low-Protein Oleosomes and High-Protein Oleosomes in HMMA Processing for Nugget Application

The HMMA ribbons produced as described in the Example 25 were used a vegan chicken nugget application. The formulations for vegan chicken are shown in Table 52. The vegan nugget preparation process was as follows: First, the size of HMMA ribbons was reduced using comitrol machine with blade #3-0601507-D. HMMA pieces were seasoned with natural chicken flavour, umami flavour, salt, and white pepper. Seasoned HMMA pieces were mixed evenly and set aside. The binding paste was prepared separately by combining the vital wheat gluten, pea protein, garlic powder, and water in a food processor until the mixture turns into a thick and sticky paste. Later, pasteurized double-washed low-protein oleosome preparation 161 LPO, or pasteurized double-washed high-protein oleosome preparation 461 (HPO) was mixed into the binding paste. In a separate bowl, flavoured HMMA pieces and binding paste was mixed. The mixture was divided into 20-gram size nugget pieces and the nuggets were frozen. The frozen nuggets were coated with all-purpose flour. Then nuggets dipped into batter mixture (Table 53) then placed in the breading mix (Table 54) and coated thoroughly. Vegan nuggets were deep fried in 350° F. oil for about 1-2 minutes or until internal product temperature reaches 165° F. Among all four nugget formulations, Nugget-1 formulated with HMMA ribbons without any oil addition was the driest and the firmest nugget; Nugget-2 formulated with HMMA ribbons including sunflower oil was found the softest and mushy nugget without having a chicken like texture; Nugget-3 and Nugget-4 formulated with HMMA ribbons using LPO and HPO, respectively, had chicken like texture with juicy mouthfeel and moderate firmness. Nuggets formulated with HMMAs including oleosomes had better sensory attributes.

TABLE 52
Vegan chicken nugget formulations.

| | Nugget- | Nugget- | Nugget- | Nugget- |
|---|---|---|---|---|
| | 1 | 2 | 3 | 4 |
| Ingredients | (%) | (%) | (%) | (%) |
| HMMA without | 56.17 | — | — | — |
| additional oil | | | | |
| HMMA with sunflower oil | — | 56.17 | — | — |
| (6% oil content) | | | | |
| HMMA with LPO 161 | — | — | 56.17 | — |
| (6% oil content) | | | | |
| HMMA with HPO 461 | — | — | — | 56.17 |
| (6% oil content) | | | | |
| Natural chicken flavour | 1.88 | 1.88 | 1.88 | 1.88 |
| (Firmenish, 864998CB) | | | | |
| Umami flavour | 1.51 | 12.51 | 1.51 | 1.51 |
| (Firmanish, 869045CB) | | | | |
| Salt (Windsor) | 0.38 | 0.38 | 0.38 | 0.38 |
| Water, iced | 16.50 | 16.50 | 16.50 | 16.50 |
| Vital Wheat Gluten 80% | 6.13 | 6.13 | 6.13 | 6.13 |
| (ADM) | | | | |
| Pea protein 870 (Puris) | 1.98 | 1.98 | 1.98 | 1.98 |
| Garlic powder | 0.33 | 0.33 | 0.33 | 0.33 |
| White pepper | 0.12 | 0.12 | 0.12 | 0.12 |
| (Unipac 1-058-05) | | | | |
| Oleosome 161 | 15 | 15 | 15 | 15 |
| (Botaneco) | | | | |
| Total | 100 | 100 | 100 | 100 |

TABLE 53
Batter formula for vegan chicken nuggets.

| Ingredients | % |
|---|---|
| All-purpose flour (Robin Hood) | 14 |
| Water, tap | 86 |
| Total | 100 |

TABLE 54
Breading formula for vegan chicken nuggets.

| Ingredients | % |
|---|---|
| Breader (B34216, Newlywed) | 95.92 |
| Salt (Windsor) | 3.45 |
| Natural chicken flavour (Firmenish, 864998 CB) | 0.54 |
| White pepper (Unipac, 1-058-05) | 0.09 |
| Total | 100 |

### Example 28—Shear Cell Made HMMA Using Oleosomes for Modification of Textural Properties

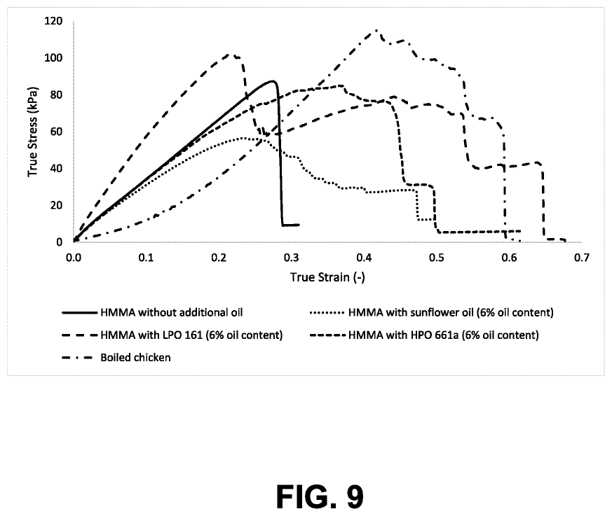

High moisture meat analogue (HMMA) formulations (Table 52) were tested without oil addition and 6% oil inclusion from sunflower oil, pasteurized double-washed low-protein oleosome preparation 161 (LPO) produced via process 100, and pasteurized double-washed high-protein oleosome preparation (661a) (HPO) produced via process 600. Feed mixes were mixed manually prior to incorporation into the shear cell. The feed mixes were fed into the conical cavity of the high-temperature conical shear cell (HTSC) (designed at Wageningen University, the Netherlands) apparatus and subjected to shear of 30 rpm for 15 minutes at 130° C. The samples successfully collected from the HMMA process were pancake structures composed of meat-like fibers. The pancakes were analyzed for tensile stress by a texture analyzer (TA.XTplusC, Stable Micro Systems, UK) with the flow (perpendicular to the center of the pancake) and across the flow (parallel to the center of the pancake) (Table 53). The pancakes containing no additional oil exhibited a fast fracture propagation with a defined fracture point during the tension incurred by the axial pull, whereas all formulas containing oil, and particularly oil in the form of oleosomes exhibited a longer fracture process with a sustained decrease in stress over a longer strain (FIG. 9), similar to that of boiled chicken. The pancakes including sunflower oil in the formula had the weakest texture, whereas the oil-free pancakes exhibited the toughest texture both with and across the flow. The pancakes with LPO 161 or HPO 661a showed thin, long and elastic fiber structures and exhibited tough texture across the flow and weak texture with the flow, as described by the increased anisotropic index (ratio between parallel and perpendicular tensile parameters). The anisotropic indices pancakes including both LPO 161 and HPO 661a most closely resembled those of boiled chicken, thus making these HMMAs suitable for vegan meat applications.

TABLE 52
Ingredients for the individual High Moisture Meat Analogue (HMMA) formulations.

| | | | HMMA | HMMA | HMMA | HMMA |
|---|---|---|---|---|---|---|
| | | | without | with sunflower | with LPO | with HPO |
| | | | additional | oil (6% oil | (6% oil | (6% oil |
| | | | oil | content) | content) | content) |
| Ingredients | Supplier | Lot Code | Mass (%) | Mass (%) | Mass (%) | Mass (%) |
| Vital | ADM | Y005J | 22.16 | 22.16 | 22.16 | 22.16 |
| Wheat | | | | | | |
| Gluten | | | | | | |
| Pea Protein | Roquette | 08323 | 22.16 | 22.16 | 22.16 | 22.16 |
| Isolate | | | | | | |
| (Nutralys ® | | | | | | |
| F85 M) | | | | | | |
| Pea Fibre | Roquette | WF63V | 0.675 | 0.675 | 0.675 | 0.675 |
| (I 50M) | | | | | | |
| Sunflower | Albert Heijn | — | | 6.00 | | |
| Oil | | | | | | |
| LPO 161 | Botaneco | HA2023-29 | | | 9.00 | |
| HPO 661a | Botaneco | HA2023-33 | | | | |
| Water | | | 55.00 | 49.00 | 46.00 | |

TABLE 53
Tensile strength analysis of HMMA pancakes.

| | Fracture stress (kPa) | | Young modulus (kPa) | |
|---|---|---|---|---|
| | Across the flow | With the flow | Across the flow | With the flow |
| Sample | (parallel) | (Perpendicular) | (parallel) | (Perpendicular) |
| HMMA without | 86.44 ± 7.88 | 59.71 ± 4.52 | 318.46 ± 23.73 | 286.76 ± 7.64 |
| additional oil | | | | |
| HMMA with | 38.97 ± 10.96 | 20.61 ± 2.90 | 271.15 ± 22.20 | 186.65 ± 31.18 |
| sunflower oil | | | | |
| (6% oil content) | | | | |
| HMMA with | 82.21 ± 13.91 | 18.42 ± 2.92 | 446.97 ± 85.88 | 171.42 ± 21.91 |
| LPO 161 (6% | | | | |
| oil content) | | | | |
| HMMA with | 67.89 ± 14.16 | 10.44 ± 1.09 | 326.16 ± 35.55 | 99.69 ± 11.60 |
| HPO 661a (6% | | | | |
| oil content) | | | | |
| Boiled chicken | 112.95 ± 3.89 | 21.74 ± 5.37 | 135.41 ± 23.96 | 60.32 ± 14.02 |

TABLE 54
Anisotropy index of HMMA pancakes.

| | Anisotropy index | |
|---|---|---|
| Sample | Fracture stress (—) | Young modulus (—) |
| HMMA without | 1.45 ± 0.05 | 1.11 ± 0.04 |
| additional oil | | |
| HMMA with sunflower | 1.89 ± 0.14 | 1.45 ± 0.08 |
| oil (6% oil content) | | |
| HMMA with LPO 161 | 4.46 ± 0.10 | 2.61 ± 0.10 |
| (6% oil content) | | |
| HMMA with HPO 661a | 6.50 ± 0.06 | 3.27 ± 0.05 |
| (6% oil content) | | |
| Boiled chicken | 5.20 ± 0.14 | 2.24 ± 0.17 |

1. A low-protein sunflower oleosome extract preparation having a protein concentration of less than about 3% (w/w) on a dry basis (db), a dry weight of from about 20% (w/w) to about 80% (w/w), a lipid to protein ratio in excess of about 30 on a dry basis (db), and containing particles having a mean particle size D[4,3] of about 3 mm to about 20 mm.

2. The low-protein sunflower oleosome extract preparation according to claim 1, wherein the dry weight is from about 30% (w/w) to about 80% (w/w), and the mean particle size D[4,3] is about 3 mm to about 10 mm.

3. The low-protein sunflower oleosome extract preparation according to claim 1, wherein the dry weight is from about 65% (w/w) to about 75% (w/w), the lipid to protein ratio is from about 30 to about 90 on a dry basis (db), and the mean particle size D[4,3] is about 3 mm to about 9 mm.

4. (canceled)

5. The low-protein sunflower oleosome extract preparation according to claim 1, wherein the dry weight is from about 50% (w/w) to about 60% (w/w), the lipid to protein ratio is about 50 on a dry basis (db), the mean particle size D[4,3] is about 10 mm to about 15 mm; and the extract preparation has a pH of about 2.5 to about 3.5.

6. (canceled)

7. The low-protein sunflower oleosome extract preparation according to claim 1, wherein the dry weight is from about 65% (w/w) to about 70% (w/w), the lipid to protein ratio is from about 35 to about 45 on a dry basis (db), and the mean particle size D[4,3] is about 3.0 mm to about 5.5 mm; wherein the extract preparation is substantially free of at least one of (i) an endocarp protein; and (ii) an endocarp phenolic.

8. The low-protein sunflower oleosome extract preparation according to claim 7, wherein the endocarp phenolic is a polyphenolic selected from a phenolic acid, a flavonoid, a tannin, a saponin, lignan, lignin, a terpene, an alkaloid, and an oxalate.

9. (canceled)

10. (canceled)

11. The low-protein sunflower oleosome extract preparation according to claim 7, wherein the endocarp protein is helianthin or albumin.

12. (canceled)

13. The low-protein sunflower oleosome extract preparation according to claim 1, wherein the dry weight is from about 70% (w/w) to about 75% (w/w), the lipid to protein ratio is from about 70 to about 80 on a dry basis (db), the mean particle size D[4,3] is about 3.5 mm to about 15 mm; and wherein the CIELAB color value of the oleosome extract preparation is a*>0.

14. The low-protein sunflower oleosome extract preparation according to claim 1, which comprises a phenolics content of from about 0.1 to about 0.4 milligram gallic acid equivalent per gram (mg GAE/gram) dry weight of sample.

15. The low-protein sunflower oleosome extract preparation according to claim 1, which is a pasteurized low-protein oleosome extract preparation.

16. (canceled)

17. The low-protein sunflower oleosome extract preparation according to claim 1, wherein the protein concentration is between about 1% (w/w) and about 3% (w/w) on a dry basis (db).

18. A high-protein sunflower oleosome extract preparation having a protein concentration of at least about 4% (w/w) on a dry basis (db), a dry weight of from about 50% (w/w) to about 70% (w/w), a lipid to protein ratio of from about 10 to about 30 on a dry basis (db), and containing particles having a mean particle size D[4,3] of about 2.5 mm to about 10 mm.

19. The high-protein sunflower oleosome extract preparation according to claim 18, wherein the dry weight of from about 60% (w/w) to about 70% (w/w).

20. The high-protein sunflower oleosome extract preparation according to claim 18, wherein the lipid to protein ratio is from about 10 to about 25 on a dry basis (db), and the mean particle size D[4,3] is about 2.5 mm to about 5 mm.

21. (canceled)

22. The high-protein sunflower oleosome extract preparation according to claim 18, wherein the protein concentration is between about 4% (w/w) and about 5% (w/w) on a dry basis (db), the mean particle size D[4,3] is about 2.5 mm to about 4 mm, and the lipid to protein ratio is from about 15 to about 20 on a dry basis (db).

23. (canceled)

24. The high-protein sunflower oleosome extract preparation according to claim 18, wherein the protein concentration is at least about 7% (w/w) on a dry basis (db), the mean particle size D[4,3] is about 4 mm to about 5 mm; and the lipid to protein ratio is from about 10 to about 12.5 on a dry basis (db).

25. (canceled)

26. The high-protein sunflower oleosome extract preparation according to claim 18, which has a phenolics content of from about 0.1 mg to about 0.4 mg GAE/gram dry weight of sample.

27. The high-protein sunflower oleosome extract preparation according to claim 18, which is a pasteurized high-protein oleosome extract preparation.

28. (canceled)

29. A sunflower oleosome extract preparation having a protein concentration of from about 2% (w/w) to about 5% (w/w) on a dry basis (db) and having a dry weight of from about 40% (w/w) to about 70% (w/w), a lipid to protein ratio of from about 10 to about 50 on a dry basis (db), and containing particles having a mean particle size D[4,3] of from about 2 mm to about 10 mm.

30. The sunflower oleosome extract preparation according to claim 29, wherein:
the dry weight is from 60% (w/w) to about 70% (w/w);
the lipid to protein ratio is from about 15 to about 40 on a dry basis (db);
the mean particle size D[4,3] is from about 2 mm to about 5 mm; and
the extract preparation has a pH of about 2.5 to about 3.5.

31.-66. (canceled)
